(19) United States
(12) Patent Application Publication
(10) Pub. No.: US 2024/0242207 A1
(43) Pub. Date: Jul. 18, 2024

(54) CROSS-CHAIN OPERATIONS TO DETERMINE ENTITY EQUIVALENCE VALUES IN A BLOCKCHAIN

(71) Applicant: Snowflake Inc., Bozeman, MT (US)

(72) Inventors: Sridhar Ramaswamy, Cupertino, CA (US); Nathan Wiegand, Austin, TX (US); Rajaram Gaunker, Mountain View, CA (US)

(21) Appl. No.: 18/154,577

(22) Filed: Jan. 13, 2023

Related U.S. Application Data
(63) Continuation of application No. 18/148,899, filed on Dec. 30, 2022.
(60) Provisional application No. 63/301,895, filed on Jan. 21, 2022.
(60) Provisional application No. 63/301,895, filed on Jan. 21, 2022.

(51) Int. Cl. G06Q 20/38; G06Q 20/40

(52) U.S. Cl. CPC G06Q 20/3823; G06Q 20/4014

(57) ABSTRACT

An example apparatus includes a blockchain group data component structured to interpret a plurality of blockchain description values each corresponding to at least one of a plurality of blockchains, a blockchain group index component structured to provide a blockchain group index data structure in response to the plurality of blockchain description values, the blockchain group index data structure comprising an attribute association description. The attribute association description includes an identified attribute value, a first association of the identified attribute value to a first entity associated with a first blockchain of the plurality of blockchains, and a second association of the identified attribute value to a second entity associated with a second blockchain of the plurality of blockchains. The apparatus includes a cross-chain interaction component structured to perform a cross-chain interaction operation in response to the blockchain group index data structure.

### CROSS-REFERENCE TO RELATED APPLICATIONS

This application is a continuation of U.S. patent application Ser. No. 18/148,899, filed 30 Dec. 2022, and entitled “BLOCKCHAIN SEARCH ENGINE” (NEVA-0001-U01).

U.S. patent application Ser. No. 18/148,899 claims the benefit of U.S. Provisional Patent Application No. 63/301,895, filed 21 Jan. 2022, and entitled “BLOCKCHAIN SEARCH ENGINE” (NEVA-0001-P01).

This application claims the benefit of U.S. Provisional Patent Application No. 63/301,895, filed 21 Jan. 2022, and entitled “BLOCKCHAIN SEARCH ENGINE” (NEVA-0001-P01).

Each of the foregoing applications is incorporated herein by reference in its entirety for all purposes.

### BACKGROUND

Applications based on blockchain technologies, and similar or related developments, such as Web3 (or Web 3.0), provide a number of benefits for users. These applications and technologies support increased user privacy, control of personal data, and support decentralization of content creation and access, execution of transactions, and the like. The utilization of blockchains and similar technologies, as well as the development of and progression toward networks utilizing Web3 or similar organizing concepts, are increasing. However, previously known systems for implementing networked interactions and transactions utilizing blockchains and similar concepts, such as Web3, suffer from a number of drawbacks and challenges.

For example, the control of personal information makes it difficult for a content consumer, purchaser, or one offering content or assets for sale, to determine whether the interacting parties are trustworthy, or a good fit for the transaction—for example if the interacting party will appreciate the content, if they are accessing, purchasing, or selling the content for a compatible purpose (e.g., if their purpose is aligned with the purpose of a target user, such as a creator, seller, or buyer of the content). Additionally, a wallet or other account related information is typically used for identification of a user of the blockchain, resulting in the identification of the user having account information simultaneously available (e.g., including account balances, prior transactions, etc.), without an ability to identify that user on other blockchains, or with other accounts on a same blockchain. Further, the decentralized nature of such networking arrangements makes it more difficult, relative to prior centralized networking arrangements, to find interested consumers or creators, to find content that is of interest to a consumer seeking to purchase or access content of a particular type, to determine whether an interacting party is the same party on various platforms (e.g., a user having a cryptocurrency account and an NFT platform account may not have an apparent relationship between those accounts to other users), and/or to determine whether a particular asset is legitimate, original, or the like.

### SUMMARY

In some aspects, the techniques described herein relate to an apparatus, including: a blockchain group data circuit structured to interpret a plurality of blockchain description values each corresponding to at least one of a plurality of blockchains; a blockchain group index circuit structured to provide a blockchain group index data structure in response to the plurality of blockchain description values, the blockchain group index data structure including an attribute association description, the attribute association description including: an identified attribute value; a first association of the identified attribute value to a first entity associated with a first blockchain of the plurality of blockchains; and a second association of the identified attribute value to a second entity associated with a second blockchain of the plurality of blockchains; and a cross-chain interaction circuit structured to perform a cross-chain interaction operation in response to the blockchain group index data structure.

In some aspects, the techniques described herein relate to an apparatus, wherein the first entity and the second entity each include at least one of: an account, a wallet, a user identifier, an asset, a token, or a contract.

In some aspects, the techniques described herein relate to an apparatus, wherein the cross-chain interaction circuit is further structured to perform the cross-chain interaction operation by providing a search description to a user interface in response to a user search value and the blockchain group index data structure.

In some aspects, the techniques described herein relate to an apparatus, wherein the cross-chain interaction circuit is further structured to perform the cross-chain interaction operation by determining an entity equivalence value between the first entity and the second entity in response to the blockchain group index data structure.

In some aspects, the techniques described herein relate to an apparatus, wherein the cross-chain interaction circuit is further structured to perform the cross-chain interaction operation by determining a cross-chain attribute ranking.

In some aspects, the techniques described herein relate to an apparatus, wherein the cross-chain attribute ranking includes a cross-chain rarity for an attribute.

In some aspects, the techniques described herein relate to an apparatus, wherein the cross-chain attribute ranking includes a cross-chain value for an attribute.

In some aspects, the techniques described herein relate to an apparatus, wherein the cross-chain attribute ranking includes a cross-chain trust value.

In some aspects, the techniques described herein relate to an apparatus, wherein the cross-chain interaction circuit is further structured to perform the cross-chain interaction operation by determining a cross-chain buyer target.

In some aspects, the techniques described herein relate to an apparatus, wherein the cross-chain interaction circuit is further structured to perform the cross-chain interaction operation by determining a cross-chain seller target.

In some aspects, the techniques described herein relate to a method, including: interpreting a plurality of blockchain description values each corresponding to at least one of a plurality of blockchains; providing a blockchain group index data structure in response to the plurality of blockchain description values, the blockchain group index data structure including an attribute association description, the attribute association description including: an identified attribute value; a first association of the identified attribute value to a first entity associated with a first blockchain of the plurality of blockchains; and a second association of the identified attribute value to a second entity associated with a second blockchain of the plurality of blockchains; and performing a cross-chain interaction operation in response to the blockchain group index data structure.

In some aspects, the techniques described herein relate to a method, further including performing the cross-chain interaction operation by providing a search description to a user interface in response to a user search value and the blockchain group index data structure.

In some aspects, the techniques described herein relate to a method, further including performing the cross-chain interaction operation by determining an entity equivalence value between the first entity and the second entity in response to the blockchain group index data structure.

In some aspects, the techniques described herein relate to a method, further including performing the cross-chain interaction operation by determining a cross-chain attribute ranking.

In some aspects, the techniques described herein relate to a method, further including performing the cross-chain interaction operation by determining a cross-chain buyer target.

In some aspects, the techniques described herein relate to a method, further including performing the cross-chain interaction operation by determining a cross-chain seller target.

In some aspects, the techniques described herein relate to a method, wherein the cross-chain attribute ranking includes a cross-chain rarity for an attribute.

In some aspects, the techniques described herein relate to a method, wherein the cross-chain attribute ranking includes a cross-chain value for an attribute.

In some aspects, the techniques described herein relate to a method, wherein the cross-chain attribute ranking includes a cross-chain trust value.

In some aspects, the techniques described herein relate to a method, wherein the first entity and the second entity each include at least one of: an account, a wallet, a user identifier, an asset, a token, or a contract.

### BRIEF DESCRIPTION OF THE FIGURES

FIG. 1 depicts an example supporting blockchain searching and other features as set forth throughout the present disclosure.

FIG. 2 depicts an example controller configured to support a user interface.

FIG. 3 depicts an example controller configured to support a user interface.

FIG. 4 depicts an example procedure to provide a search description to a user interface.

FIG. 5 depicts an example procedure to store a blockchain index structure.

FIG. 6 depicts an example controller configured to support a user interface.

FIG. 7 depicts an example controller configured to support a user interface.

FIG. 8 depicts an example procedure to provide a trust communication.

FIG. 9 depicts an example controller configured to support a user interface.

FIG. 10 depicts an example controller configured to support a user interface.

FIG. 11 depicts an example procedure configured to provide an asset valuation communication.

FIG. 12 depicts example additional or alternative operations for determining an asset similarity value between assets.

FIG. 13 depicts example additional or alternative operations for determining an asset similarity value between assets.

FIG. 14 depicts an example controller configured to support a user interface.

FIG. 15 depicts an example controller configured to support a user interface.

FIG. 16 depicts an example procedure to provide an asset ranking communication.

FIG. 17 depicts example additional or alternative operations for determining an asset similarity value between assets.

FIG. 18 depicts an example controller configured to support a user interface.

FIG. 19 depicts an example controller configured to support a user interface.

FIG. 20 depicts an example procedure to provide a trust communication.

FIG. 21 depicts an example controller configured to support a user interface.

FIG. 22 depicts an example controller configured to perform a buyer identification operation.

FIG. 23 depicts example buyer identification operations.

FIG. 24 depicts example identifying information.

FIG. 25 depicts example asset attribute values.

FIG. 26 depicts an example procedure to perform a buyer identification operation.

FIG. 27-29 depict example additional or alternative operations for a buyer identification operation.

FIG. 30 depicts an example procedure for determining a buyer ranking description.

FIG. 31 depicts an example controller configured to perform a seller identification operation.

FIG. 32 depicts an example controller configured to perform an asset identification operation.

FIG. 33 depicts an example procedure for performing an asset identification operation.

FIG. 34-36 depict example additional or alternative operations for an asset identification operation.

FIG. 37 depicts example asset identification operations.

FIG. 38 depicts example asset identification operations.

FIG. 39 depicts an example procedure to determine an asset ranking description.

FIG. 40 depicts an example controller configured to perform a seller identification operation.

FIG. 41 depicts example seller identification operations.

FIG. 42 depicts an example procedure to perform a seller identification operation.

FIG. 43-45 depict example additional or alternative operations for a seller identification operation.

FIG. 46 depicts an example procedure for determining a seller ranking description.

FIG. 47 depicts an example controller configured to perform an equivalent attribute operation.

FIG. 48 depicts example equivalent attribute operations.

FIG. 49 depicts an example procedure to perform an equivalent attribute operation.

FIG. 50 depicts example equivalent attribute values.

FIG. 51 depicts an example procedure to perform an equivalent attribute operation.

FIG. 52 depicts an example procedure to determine an entity equivalence value.

FIG. 53 depicts an example controller configured to perform a cross-chain interaction operation.

FIG. 54 depicts an example blockchain group index data structure.

FIG. 55 depicts example cross-chain interaction operations.

FIG. 56 depicts example cross-chain attribute rankings.

FIG. 57 depicts example cross-chain interaction operations.

FIG. 58 depicts an example procedure to perform a cross-chain interaction operation.

FIG. 59 depicts an example controller configured to provide a rarity communication.

FIG. 60 depicts example owner characteristics.

FIG. 61 depicts example asset characteristics.

FIG. 62 depicts example external data values.

FIG. 63 depicts example rarity communications.

FIG. 64 depicts an example procedure to provide a rarity communication.

FIG. 65 depicts an example controller configured to provide a rarity communication.

FIG. 66 depicts an example controller configured to perform an account trust operation.

FIG. 67 depicts example account trust operations.

FIG. 68 depicts example account trust operations.

FIG. 69 depicts an example procedure to perform an account trust operation.

FIG. 70 depicts an example controller configured to perform an equivalent asset operation.

FIG. 71 depicts example equivalent asset operations.

FIG. 72 depicts example asset similarity values.

FIG. 73 depicts example asset similarity values.

FIG. 74 depicts an example procedure to perform an equivalent asset operation.

FIGS. 75-79 depict example additional or alternative operations for determining an asset similarity value between assets.

### DETAILED DESCRIPTION

Numerous aspects of the present disclosure include a controller, circuit, processor, and/or computing device, which may be configured to perform, or structured to perform, one or more aspects of embodiments herein. Such devices are depicted in an example arrangement to illustrate aspects of the present disclosure, but the depicted arrangements are non-limiting examples. A given device may be a single device, a distributed device, and/or may be positioned in a first location at a first time or operating condition, and positioned, in whole or part, in a second location at a second time or operating condition. For example, an account information circuit may be structured to determine information about an account, wallet, or the like, interacting with a particular blockchain, where the account information circuit is positioned on a first device (e.g., a desktop computer) at a first time (e.g., when a user accesses a blockchain interface platform using the desktop computer accessing a web portal), and positioned on a second device (e.g., a mobile phone) at a second time (e.g., when the user accesses the blockchain interface platform using an application on the mobile phone). Such devices may be embodied, in whole or part, as executable instructions stored in a computer readable format and configured to perform certain aspects of the embodiment when executed by a processor. Such devices may additionally or alternatively be embodied, in whole or part, as hardware components (e.g., a processor, physical memory, input device, output device, a network physical layer, etc.). Any arrangement of hardware devices and/or executable instructions configured to perform the operations of embodiments herein is contemplated as an example embodiment for descriptions herein. One of skill in the art, having the benefit of the present disclosure, can readily determine specific hardware components, executable instruction sets, interfaces, and communications, to perform operations set forth herein. In certain embodiments, storage of data, data structures, and/or executable instructions may be distributed, for example in an embodiment where one or more aspects are performed on a dedicated server, a cloud server, or the like, where the physical location of certain aspects are not critical to the arrangement structured to perform the described operations.

Certain aspects of the present disclosure reference an entity in various contexts. An entity, as utilized herein, should be understood broadly. An entity as utilized herein may reference an entity associated with a blockchain. An example entity includes a user having an account capable to access and/or perform transactions on the blockchain. Such users may be referenced as a buyer user or a seller user, for example depending upon the context of the description, including where the user is a prospective buyer. For example, a user intending to buy an asset may be referenced as a buyer user, whether the user completes the operation to buy the asset. A given user may be a buyer user at a first time and a seller user at a second time, for example a buyer user during operations to buy an asset and/or determine whether to buy an asset, and a seller user during operations to sell an asset and/or determine whether to sell an asset. An example entity includes a creator of content, for example the creator of artwork associated with a token, where the token represents certain rights relative to the artwork (e.g., a non-fungible token (NFT) representing unique rights relative to the artwork). An example entity includes an account on a blockchain, and/or a wallet or other application that manages one or more blockchain accounts. An example entity includes an asset associated with the blockchain, such as an asset that can be traded in transactions on the blockchain. An example entity includes a smart contract, or a set of criteria which, if met according to the terms therein, can execute a transaction on the blockchain. In certain embodiments, the smart contract is associated with an asset, where operations according to the smart contract perform operations for the asset, for example executing a trade of the asset.

Certain aspects of the present disclosure reference an asset. An asset, as utilized herein, should be understood broadly. An asset may reference an asset available for trading on a blockchain, for example a token and/or an NFT. In certain embodiments, an asset may not literally be traded on the blockchain, but may be related to a tradeable aspect on the blockchain, such as a token representing certain rights with respect to the asset. In certain embodiments, an asset is a digital asset, such as an image, an audio file, or a video clip. However, an asset may be a physical asset, for example with rights related to the asset tradeable on the blockchain. For example, a token may represent rights to access the physical asset, rights to take delivery of the physical asset, and/or option rights to purchase or sell the physical asset. In certain embodiments, depending upon the specific context of the description, a token (and/or an NFT) may be referenced as an asset, for convenience of the present description, even where the asset may a separate but closely related object from the token itself.

Certain aspects of the present disclosure reference a non-fungible token (NFT). An NFT, as utilized herein, should be understood broadly. In certain embodiments, an NFT is identifiable and unique, for example providing rights to an asset, and/or embodying the asset, that can be identified as unique, and are tradeable on a blockchain. In certain embodiments, an NFT may be technically fungible, but representing a limited set of tokens, for example associated with a limited edition right to an asset, with a very limited quantity of holders for the tokens. In certain embodiments, for example with limited edition tokens, individual tokens of the group may be identifiable (e.g., token #7 of 10 tokens), or not identifiable (one token of 10 total available tokens). All of these concepts are contemplated herein, utilizing NFT terminology, for clarity of the present description.

Certain aspects of the present disclosure reference a token or a fungible token. A token may be utilized for security, for example to ensure that a user has the right to perform certain actions. A token may be utilized to represent a fungible right or ownership (e.g., a unit of cryptocurrency), or a non-fungible right or ownership (e.g., an NFT). All of these token examples, including security tokens, rights based tokens, ownership based tokens, and fungible tokens or NFTs are contemplated herein, and are not limiting to the general utilization of token terminology in the art.

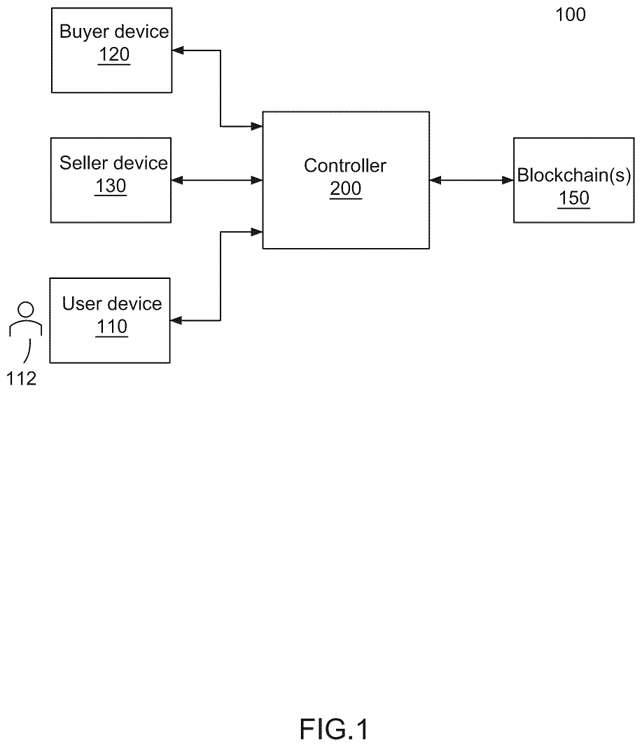

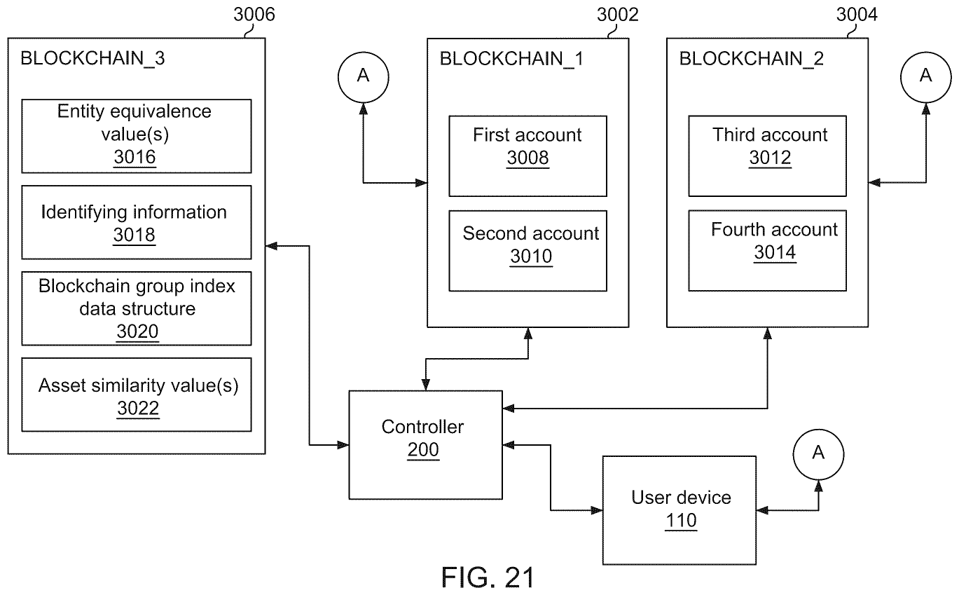

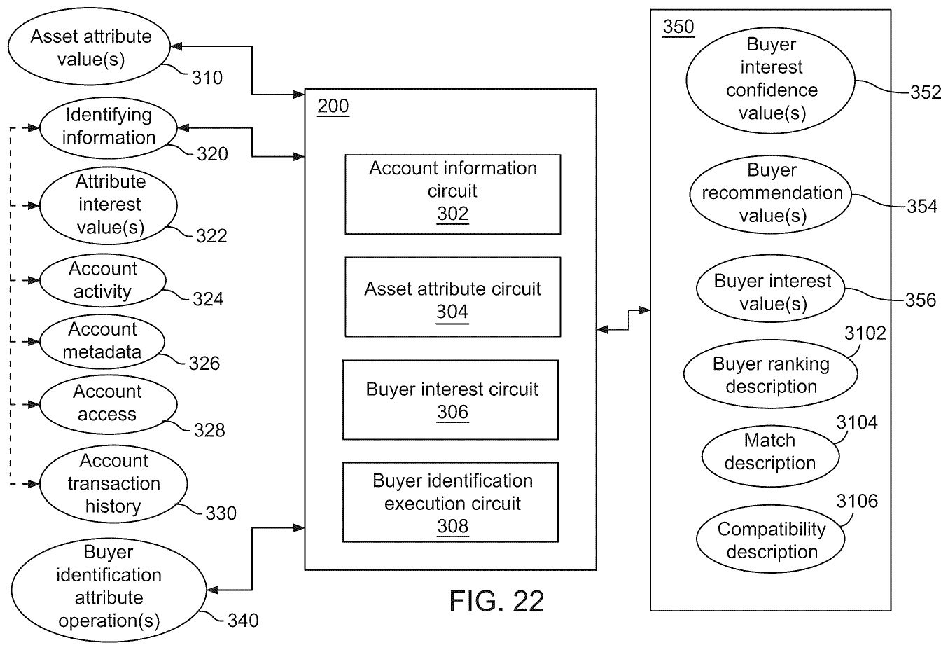

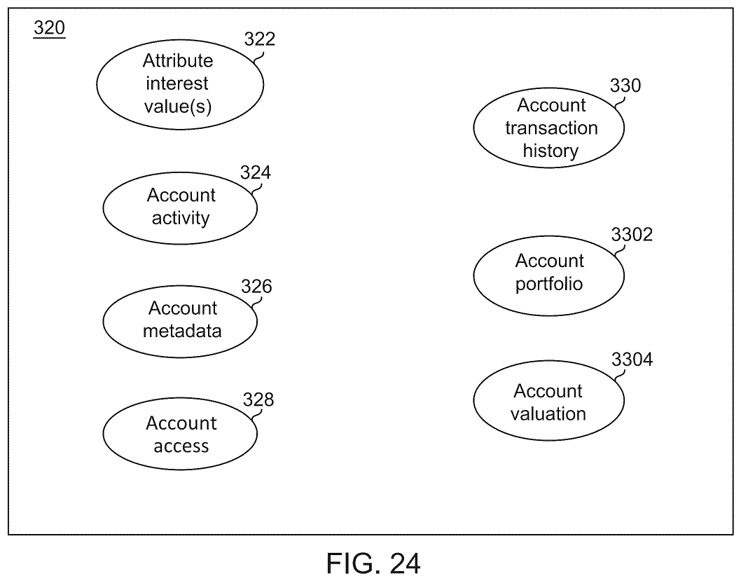

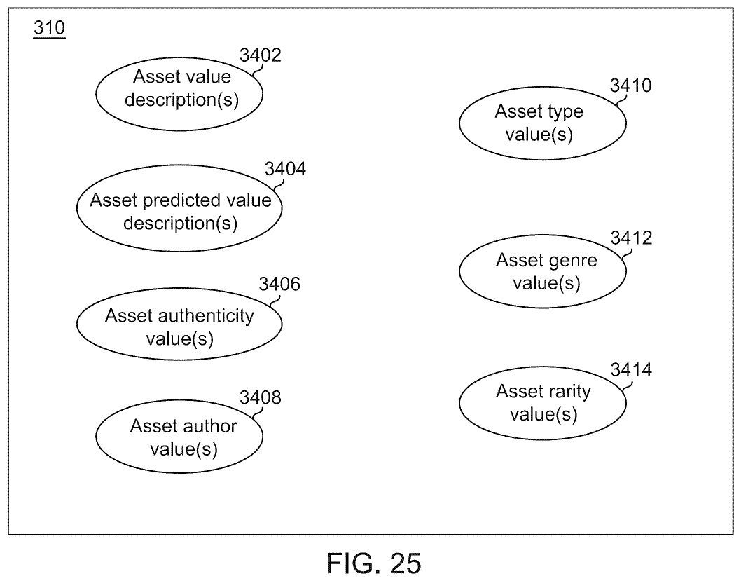

Certain aspects of the present disclosure reference equivalence, including for example equivalence values and/or equivalence determinations. Equivalence, as utilized herein, should be understood broadly. Equivalence may indicate an identity equivalence, for example where a first account and a second account are determined to be equivalent, such a determination may indicate that the beneficial owner of the accounts is the same entity. Equivalence may, additionally or alternatively, indicate an equivalence with regard to some other aspect of the parameters determined to be equivalent. For example, a first account holding assets of a certain type (e.g., an NFT for artwork) and a second account holding assets of the same type, may be determined to be equivalent accounts for certain purposes. These parameters that may be compared for equivalence determinations include, without limitation, any aspect about an account (e.g., reference identifying information, for example at FIGS. 22 and 24, and the related description), any aspect about an asset (e.g., reference asset attribute values, for example at FIGS. 22 and 25, and the related description), any aspect about an entity related to a blockchain (e.g., users, accounts, wallets, assets, tokens, etc.), and/or any aspect about an entity related to a system of the present disclosure (e.g., reference FIGS. 1 and 21, and the related description, but a system may be embodied at least in part in any components, devices, controllers, circuits, apparatuses, etc. as set forth throughout the present disclosure). Example entities related to a system of the present disclosure include, without limitation, any entity using the system (e.g., a user utilizing the system to enhance blockchain interactions, searching, finding asset matches, finding seller matches, finding buyer matches, confirming that an asset is legitimate, determining whether other parties in a transaction are trustworthy, and/or confirming whether a transaction is likely to fulfill intended goals, such as portfolio development, valuation targets, liquidity targets, etc.; such usage may include accessing through a web portal, mobile application, dedicated application such as for a laptop or PC, etc.), an administrator of the system itself (e.g., an entity creating, configuring, updating, evaluating, and/or operating a system of the present disclosure), a creator planning an NFT rollout (e.g., creating the NFT, utilizing a system of the present disclosure to inform the configuration of aspects of the NFT, and/or utilizing a system of the present disclosure to target likely buyers for the NFT), an entity utilizing an API to exercise operations of the system, an entity subscribing to information generated from operations of a system of the present disclosure, an entity providing external data utilized by a system of the present disclosure, and/or an entity interacting with a system of the present disclosure for any other purpose. The determination of equivalence depends upon the context for determining the equivalence, and includes at least determination of identity equivalence (e.g., are the entities literally the same entity), determination of attribute equivalence (e.g., are the comparable attributes the same value, for example is the account creation date for both entities the same date; and/or are the comparable attributes able to be treated as the same for the specific purpose, for example do both entities own more than 10 assets having a total value exceeding $100,000), and/or determination of function equivalence (e.g., are both entities capable to purchase assets on a given blockchain, are both entities interested in assets of the type “sunset landscape”, are both entities capable to create assets for sale on a blockchain, etc.). In certain embodiments, equivalence includes determining that the aspects are the same. In certain embodiments, equivalence includes determining that the aspects are close enough to be treated the same for a specific purpose. It can be seen that whether aspects are determined to be equivalent depends upon the context, including the purpose for determining the equivalence value and the manner in which the equivalence value will be used. Accordingly, entities may be determined to be equivalent for certain purposes (e.g., the owner of two separate accounts is the same person, which is equivalent for operations that rely upon the accounts being held by the same person), but not equivalent for other purposes (e.g., accounts having the same person as an owner may not be equivalent where operations rely upon accounts having the same beneficial owner (e.g., the person owning the account) with the same behaviors, interests, and purposes for each account (e.g., where the person utilizes a first account in a work role and a second account for personal use, the utilization of the two accounts may differ significantly in account behavior, and may have fundamentally distinct matching criteria for target asset acquisitions, buyer matching, and/or seller matching).

Certain aspects of the present disclosure reference similarity, including for example similarity values and/or similarity determinations. Similarity, as utilized herein, should be understood broadly.

Similarity may indicate a similarity with regard to some other aspect of the parameters determined to be similar. For example, a first account holding of a certain mix of types may be determined to be similar to a second account holding a different mix of types, with sufficient overlap that the accounts may be determined to be similar accounts for certain purposes. These parameters that may be compared for similarity determinations include, without limitation, any parameters as set forth in the description for equivalence. Example entities that may have an aspect evaluated for similarity determination include, without limitation, any entity as set forth in the description for equivalence. The determination of similarity depends upon the context for determining the similarity, and includes at least determination of identity similarity, determination of attribute similarity, and/or determination of function similarity. In certain embodiments, a similarity value and/or a similarity includes a determination that the aspects are not similar, for example where a similarity value includes a description (e.g., categorization, quantification, etc.) of the differences between the aspects. In certain embodiments, similarity indicates that the aspects are close enough to be treated the same for a specific purpose, and/or close enough to be treated similarly with modifications to operations. For example, two entities having a similar trust score may be treated similarly with regard to trust based operations (e.g., two seller accounts that are both recommended based on the similar trust scores), but may be treated distinctly for the other operations, or even for the same operations depending upon the context (e.g., the two seller accounts may both be listed and recommended, with the account having the higher trust score listed at a higher ranking position). Due to the distinct purposes and utilization of similarity values and equivalence values, aspects of entities may be considered to be similar values but not equivalent values in a particular embodiment, or considered to be equivalent values for a particular operation but not similar values for a different operation.

Certain aspects of the present disclosure reference a buyer interest value. A buyer interest value provides an indication of whether a buyer is likely to show some interest in a particular asset. The buyer interest value may be provided as a quantitative indicator, such as an index number indicating a relative likelihood that the buyer would be interested (e.g., normalized from 1-100, or utilizing any other indexing mechanism), an estimate of the actual likelihood that the buyer would be interested (e.g., 6% chance that the buyer would purchase within two weeks of the asset being available, etc.), a categorical description of the buyer interest (e.g., LOW, MEDIUM, HIGH), and/or may further include aspects about the buyer interest that further inform the determination (e.g., three attributes of the asset match with corresponding elements of an attribute interest value, which may be provided as a count, a listing of the matching elements, etc.), that can be utilized by an AI component, iterative improvement algorithm, and/or an administrator of a system of the present disclosure to improve the determination of buyer interest values over time—for example to find parameters that are predictive of buyer interest. In certain embodiments, the buyer interest value includes aspects about the buyer interest that may be helpful to users to understand which aspects of an asset drive buyer interest, and/or which constraints, attribute interest values, and/or asset interest values for a potential buyer limit seller matches and/or asset matches for that buyer. In certain embodiments, the buyer interest value may include confidence descriptions (e.g., confidence of the underlying data, such as whether attributes and interests actually match; and/or confidence of the interest determination, for example where weak but positive predictors match, but stronger predictors may not match as well), match descriptions, compatibility descriptions (e.g., allowing the buyer interest value to be utilized for other purposes, such as AI component operations, iterative improvement, and/or notification to an entity that a given attribute or interest is blocking some potential matches, while preventing listing of the asset, seller, or buyer where the compatibility issue precludes a successful transaction). In certain embodiments, the buyer interest value includes a trust score for an entity, recommendation values (e.g., seller, buyer, and/or asset recommendations), ranking values, and/or ranking descriptions (e.g., ranking values, ranking versus various ranking criteria, underlying information utilized to inform or implement the rankings, etc.). In certain embodiments, the buyer interest value may include additional information (e.g., trust scores, confidence values, etc.; for example to keep the information readily available for further analysis and/or presentation to a user), and/or the additional information is not included in the buyer interest value, for example such information may be generated as needed and discarded (e.g., to preserve memory storage). In certain embodiments, the buyer interest value is not expected to indicate that a particular buyer has a high likelihood of buying a target asset, but instead the buyer interest value may typically be utilized to indicate that a sufficient number of potential buyers having a sufficient interest level are likely to, among the group, create a likelihood that a buyer will emerge within the group, and/or that a sufficient number of buyers will emerge to provide the seller with commercially appropriate choices for the sale. Where the buyer interest value is sufficiently modeled, and sufficiently detailed information is available to the buyer interest circuit, a specific estimate of purchase likelihood for a particular buyer may be presented within the buyer interest value.

Certain aspects of the present disclosure reference a trust score, a trust indicator, and/or a trust value. As utilized herein, a trust score, a trust indicator, and/or a trust value should be understood broadly. A trust score as utilized in embodiments herein provides an indication for a user that an asset, seller, buyer, or the like is likely to acceptably execute a transaction. In certain embodiments, the trust score may indicate that the asset is likely to be what it is purported to be, that the transaction is being performed with a known entity, that the other party to the transaction is not a scammer, or the like. In certain embodiments, the trust score may be developed based upon historical activity for a party, a confirmation of assets on the blockchain, a confirmation of the portfolio and/or asset holdings of a party, an amount of time since the relevant account was created, or the like. In certain embodiments, the trust score may be based upon transactions that have been verified, and/or a trust score based upon unverified transactions may be utilized as a preliminary score, and/or the trust score may be updated based upon verification results of recent transactions once verified (or not). In certain embodiments, the trust score may be associated with a particular purpose, for example a given account may have different trust score values for different asset types, asset genres, whether the transaction is buying or selling, or the like. In certain embodiments, the trust score may be provided to the user, and/or the user may receive a passive value indicating that the trust score is acceptable (e.g., a check or other notification if there is no trust based issue). In certain embodiments, the trust score may be provided to the user, and/or the trust value may include the trust score, indicia that inform the trust score, or the like.

Certain aspects of the present disclosure reference a blockchain, and/or a blockchain corpus. In certain embodiments, a blockchain references a particular blockchain implementation, for example a blockchain utilized to implement a particular transaction environment (e.g., Bitcoin). In certain embodiments, a blockchain may include branches of the blockchain, or a blockchain and a branch may be treated as separate blockchains for purposes of the present disclosure. In certain embodiments, multiple blockchains may be utilized together, for example where operations of a system of the present disclosure are configured to index, track, and support searching, recommendations, analysis, and the like for the multiple blockchains within the group. In certain embodiments, depending upon the context of the disclosure, such a group of blockchains may be referenced as “a blockchain” for clarity of the description, where it is understood that certain features such as entity equivalence operations, cross-chain trust determinations, and/or cross-chain operations may be utilized to facilitate operations. In certain embodiments, depending upon the context of the disclosure, such a group of blockchains may be referenced as a “blockchain corpus”, where the term blockchain corpus references the appropriate scope of a blockchain, branches thereof, and/or additional blockchains, where the appropriate scope may potentially include just a single blockchain.

Referencing FIG. 1, an example system 100 is schematically depicted, having various aspects that may be present in embodiments herein, and/or that may utilize one or more aspects of embodiments herein. The example system 100 includes a controller 200 configured to perform operations as set forth throughout the present disclosure, for example assisting users in searching one or more blockchains to find assets of interest, to find buyers or potential buyers of interest, to find sellers or potential sellers of interest, and/or to find potential creators of interest. The example controller 200 is depicted as a single device for clarity of the description, but may be a distributed device, embodied one or more cloud servers, or the like. The example system 100 includes blockchain(s) 150, for example any blockchain as set forth herein, including blockchains for trading of NFTs, blockchains for storing data aspects described herein (e.g., trust scores, entity associations, underlying data for making determinations, etc.). In certain embodiments, a blockchain, as will be understood in the art, represents a corpus of transactions and/or other data, that may be distributed broadly across a number of computing devices, including computing devices that are outside the system or other embodiments of the present disclosure. In certain embodiments, the blockchain(s), and/or a copy thereof, may be stored on a same physical device as the controller 200, and/or may be stored separately, in a cloud data storage, and/or a combination of these. The example system 100 includes a buyer device 120, a seller device 130, and a user device 110 associated with a user 112. The devices 120, 130, 110 are at least intermittently in communication with the controller 200, for example using a web portal, mobile application, proprietary application, or the like. In certain embodiments, communications between devices 120, 130, 110 and the controller 200 are performed over a WAN, the internet, through direct communications (e.g., FTP), or the like. A given device 120, 130, 110 may communicate with the controller 200 using different communication schemes at different times and/or for different types of operations, for example communicating through a web portal at a first time and/or for a first operation, and communicating through a mobile application at a second time and/or for a second operation. The devices 120, 130, 110 are depicted as separate, single devices for clarity of the present description. A given device (e.g., a laptop utilized by a user) may be a buyer device 120 at a first time (e.g., when the user is performing operations to buy an asset, to find asset targets for buying, and/or searching for assets having a certain type or characteristic), a seller device 130 at a second time (e.g., when the user is performing operations to sell an asset, to find asset targets for selling, etc.), and/or a user device 110 at yet another time (e.g., when the user is accessing user device functions as set forth herein). In certain embodiments, a first user may use a given device at a first time, and a second user may use the given device at a second time, where the physical hardware device acts as a first type of device with the first user (e.g., a buyer device, seller device, and/or user device) and acts as a second type of device with the second user (e.g., a buyer device, seller device, and/or user device)—for example with a publicly shared computer where the first and second user may utilize different login or authentication information to cause the device to perform operations specific for the given user. In certain embodiments, separate hardware devices (e.g., a mobile phone and desktop computer) may be utilized by a user at different times, and both hardware devices may act as a given device (e.g., a buyer device, a seller device, and/or a user device) at different times and/or for performing different operations—for example the user may search assets on a first device (e.g., the mobile phone) and purchase assets on a second device (e.g., the desktop computer), with each device sequentially (and/or simultaneously) acting as one of the devices (e.g., a buyer device, in the example). The depiction of separate devices, and the terminology utilized for those devices, is for clarity of the present description, and not limiting to which hardware devices correspond to the devices 120, 130, 110 of embodiments herein. Stated differently, in certain embodiments there may be a many-to-many relationship between hardware devices and the devices 120, 130, 110 of embodiments herein.

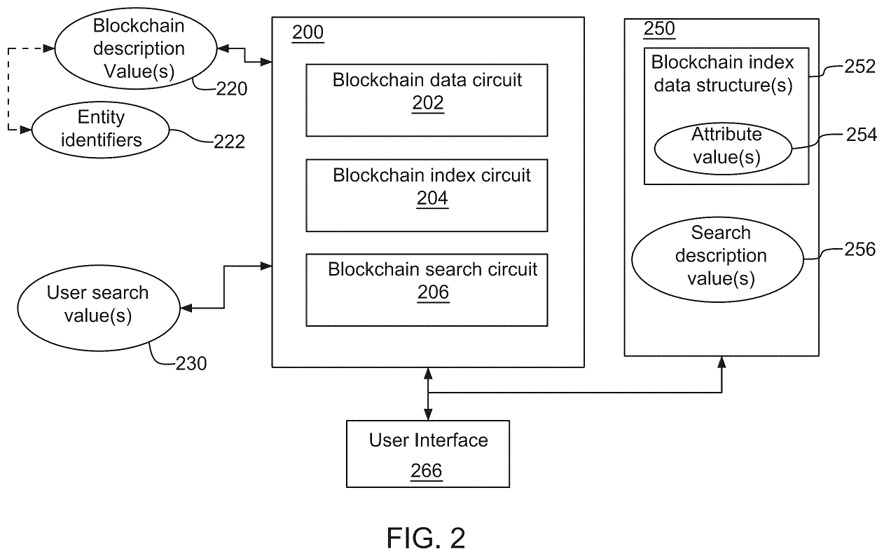

With reference to the example of FIG. 2, an example controller 200 includes a number of circuits structured to functionally execute one or more operations of the controller 200. The examples throughout the present disclosure depict the controller 200 as a single device including circuits thereon, but the controller 200 and/or circuits thereof may be distributed, in whole or part, across a number of hardware devices, and/or may be embodied at least in part in one or more hardware devices. The terms controller, circuit, processor, computing device, and similar terms as used throughout the present disclosure should be understood broadly. Embodiments of these terms include, without limitation: computing devices and/or elements thereof configured to perform one or more operations of the associated circuit and/or controller; logic circuits configured to perform one or more operations thereof; hardware devices configured to be responsive to commands and/or user interactions to perform one or more operations thereof (e.g., an I/O device, screen, keyboard, mouse); a server hosting one or more aspects of a circuit and/or controller and/or storing data related to the controller and/or circuit; computer readable instructions configured to, when executed by a processor, perform one or more operations of the circuit and/or controller. In certain embodiments, a circuit may be distributed across a number of devices, such as a portion of a circuit embodied in the controller 200 and another portion of the circuit embodied on a user device 110, and the distribution of the circuit may vary based on the specific configuration of a system, at different times for a given system, and/or for distinct interactions or transactions for a given system.

An example controller 200 includes a blockchain data circuit 202 structured to interpret a blockchain description value 220, which may include entity identifiers 222, transaction descriptions 224, and/or asset descriptions 226. In certain embodiments, the blockchain description value 220 is embodied as a blockchain 250, and/or as an associated value—for example the blockchain description value 220 may be an instance of the blockchain, an identifier of an entity of interest (e.g., a particular person, organization, account name, wallet identifier, and/or determined between these by equivalence operations as set forth in the present disclosure). In certain embodiments, the blockchain description value 220 is a blockchain identifier, for example to be utilized by the blockchain data circuit 202 to retrieve appropriate data from and/or to record appropriate entries to the blockchain 250 during operations of the controller 200.

The example controller 200 includes a blockchain index circuit 204 structured to provide a blockchain index data structure 252 in response to the blockchain description value 220. The example blockchain index data structure 252 is depicted as stored on a blockchain 250, but the blockchain index data structure 252 may be stored as separate data (e.g., in a database that is stored on the controller 200 and/or stored in a location accessible to the controller 200), on a separate blockchain (not shown) from a first blockchain 250 that is being indexed, or the like. The blockchain index data structured 252 may include indexing of the blockchain 250 by one or more attribute values 254 for any aspect of the blockchain 250, for example, including an entity based index, an asset based index (e.g., indexing based on an asset class, asset type, asset value(s), etc.). In certain embodiments, indexing may be based on aggregated and/or processed values of the attributes, for example indexing based on asset values, account/wallet identifiers, account/wallet attributes (e.g., age of the account, transaction history of the account such as earliest transaction, latest transaction, an activity description, a trust description, etc.), and/or bucketed, classified, and/or categorized groupings of one or more of these. In certain embodiments, as described throughout the present disclosure, a blockchain index data structure 252 may include indexing across more than one blockchain 250, for example with indexing based on determined equivalence and/or comparison values between entities, assets, transactions, accounts, or the like, allowing for a given index 252 to provide insight into multiple blockchains at once. In certain embodiments, the index 252 may be adjusted to reflect equivalences determined within a given blockchain 250, for example where equivalence operations have determined that a given entity may be a holder of more than one wallet or account, and thereby the index 252 is adjusted to reflect the equivalence relationship (e.g., treating the accounts as a combined unit, relating the accounts, or the like).

Certain aspects and/or operations of the present disclosure reference equivalence values, determining that certain subjects are equivalent in whole or part, or the like. Equivalence, as utilized herein, should be understood broadly. An equivalence value is a value, for example a quantitative value (e.g., a normalized score, count value, or other quantitative construct), a qualitative value (e.g., an equivalence level description, such as “unrelated”, “same net value”, “same asset type”, etc.), and/or a categorical or classification value (e.g., “ART”, “SOUND ASSET TYPE ONE”, etc.) describing the equivalence between the compared aspects. The equivalence between two aspects may be a determination that the aspects are identical for some purpose (e.g., two wallets held by the same entity), that they are related in some manner (e.g., two assets having a same asset class, asset value, or predicted future value response), and/or that the aspects have an attribute having some equivalence. In certain embodiments, equivalence may be determined with regard to a classification, category, bucketed quantity, or the like. In certain embodiments, equivalence value includes a range of values, with some values indicating no equivalence and/or a position within an equivalence range (e.g., a normalized 0-1 type of value, with 0 Xindicating no equivalence, and a 1 indicating full equivalence for the purpose of the equivalence range, such as “same asset”, “same asset attribute”, or the like). In certain embodiments, two aspects may be equivalent for one purpose (e.g., finding assets of a particular class, value range, etc.) but not equivalent for another purpose (e.g., two assets may be equivalent for asset class determination, but not equivalent for entity ownership determination). In certain embodiments, the equivalence value may include and/or be associated with a confidence value—for example a description indicating the likelihood that the confidence value itself is correct. The confidence value may be quantitative, qualitative, categorical, or the like.

The example blockchain index data structure 252 includes a plurality of attribute values 254 for each of a plurality of entities (or other organizing concept) associated with the blockchain description value 220. The example controller 200 includes a blockchain search circuit 206 structured to exercise a user interface (e.g., on the user device, on a mobile application, on a web portal, and/or on a proprietary application) interpret a user search value 230, and to provide a search description value 256 to the user interface in response to the user search value 230 and the blockchain index data structure 252. For example, the user search value 230 may be a user entry (e.g., a word or phrase for searching), a user selection (e.g., selecting categories to be searched, suggested searches based on information about the user, a selection of a picture, sound, or other asset aspect presented to the user—for example allowing the user to find similar assets to an asset of interest indicated by the user selection), or a combination of these. Example user search values include: a word search term; an asset type selection; an asset valuation selection; a reference asset selection; an attribute selection; an attribute priority; or a time horizon value. In certain embodiments, equivalence values may be exposed to certain users (e.g., an administrator, third party provider of the controller 200, or the like), allowing authorized users to review, provide reports on, and/or adjust equivalence values—for example allowing a user to enter known relationships, to adjust to changes in relationships (e.g., an asset or account that is transferred to another entity), and/or to determine the usefulness and/or performance of equivalence value determinations by the controller 200.

Example attribute values 254 may be related to an entity, a wallet/account, an asset, a transaction, and/or a contract, and may include values such as: a transaction amount, an asset type, an asset description 226 (e.g., categories or classifications, characteristics of the asset such as genre, color palette, etc.), an entity identifier 222 (e.g., where an entity is a wallet, account, owners thereof, and/or a characteristic such as “individual seller.” “corporate buyer.” “investor class entity”, etc.), a metadata value of any type, a timestamp value, an asset valuation, a trust value (e.g., as described throughout), and/or an asset future valuation (e.g., as described throughout).

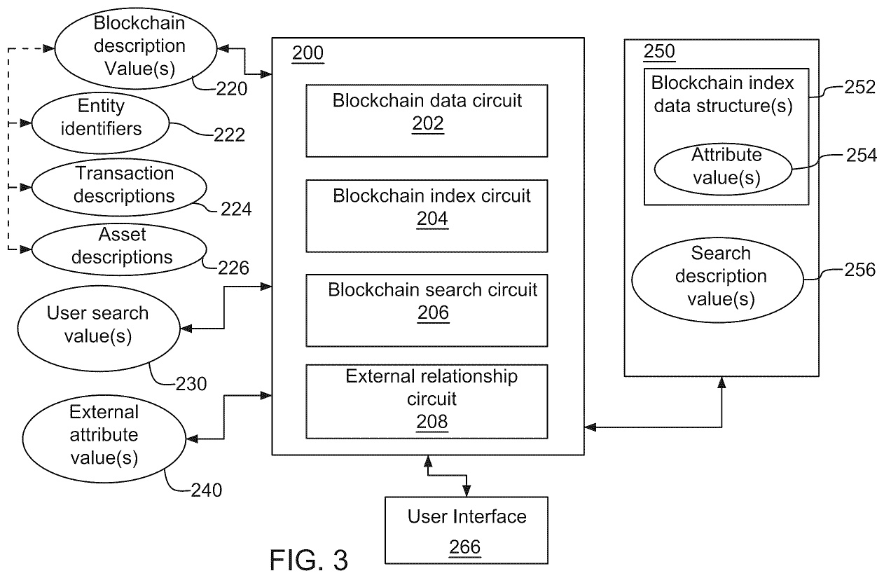

Referencing FIG. 3, an example controller 200 may further include an external relationship circuit 208 structured to interpret an external attribute value 240 corresponding to at least one of the plurality of entities. The external attribute value 240 may be any attribute value for the entity from another blockchain, and/or attributes known about the entity apart from the blockchain (e.g., a net worth value determined for the entity determined at least partially based on data external to the blockchain 250). The blockchain index circuit 204 may be further structured to provide the blockchain index data structure 252 in response to the external attribute value 240, for example where the external attribute values 240 are included on the index in addition to the blockchain related attribute values 254.

The apparatus may further include an external relationship circuit 208 structured to interpret an external attribute value 240 corresponding to at least one of the plurality of attribute values 254, for example where a trust value, asset preferences, net worth value, or the like is utilized from the blockchain attribute value for the external attribute value, and/or from the external attribute value for the blockchain attribute value. The blockchain index circuit 204 may be further structured to provide the blockchain index data structure 252 in response to the external attribute value 240, for example where the external attribute value is utilized to determine and/or adjust the blockchain attribute value.

The apparatus may further include an external relationship circuit 208 structured to interpret an external attribute value 240 corresponding to at least one of the plurality of entity values, and wherein the blockchain search circuit 206 is further structured to provide the search description value 256 in response to the external attribute value 240. For example, the search results returned may be adjusted based on the external attribute value 240, which may determine relevant search results that are determined due to the external attribute value 240 (e.g., an entity that has an interest for certain asset types based on the external attribute value, which may not be evident or as strongly indicated considering only the blockchain attribute values 254).

The apparatus may further include an external relationship circuit 208 structured to interpret an external attribute value 240 corresponding to at least one of the plurality of attribute values 254. For example, one or more of the attribute values 254 may be substituted, in whole or part, for the external attribute value 240, for example based on an equivalence of an entity related to each of the attribute values 254 and the external attribute value 240.

Example external attribute values 240 include values such as: an entity trust value; an asset type value; an asset value description; an asset future value description; an entity equivalence value; or an asset equivalence value.

The blockchain index circuit 204 may be further structured to store the blockchain index data structure 252 as a blockchain data element in the blockchain 250 and/or in one or more separate blockchains.

Certain descriptions herein reference a method, procedure, operation, or the like, including operations or steps to be performed by embodiments herein, and/or operations that are performable by properly configured aspects of the present disclosure. Any such methods, procedures, steps, and/or operations are depicted and described schematically, and may be divided into separate operations, combined in whole or part, omitted in certain embodiments, and/or be re-ordered in whole or part. Any such methods, procedures, and/or operations may be performed by any aspect of systems, apparatuses, or other assemblies of the present disclosure, including at least by any controller, circuit, or device as set forth herein.

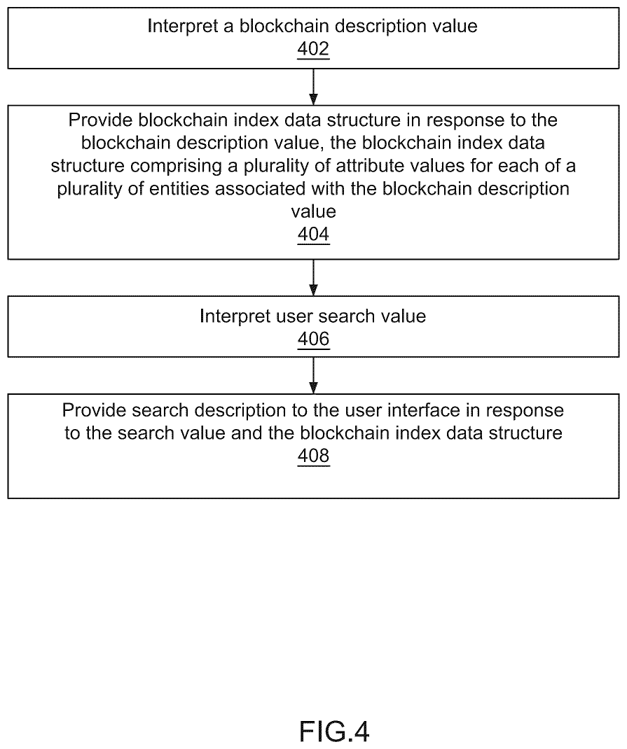

With reference to the example of FIG. 4, an example method includes the step of interpreting a blockchain description value 402. In embodiments, the blockchain description value may be received from a database of blockchain description values, from a user, from a service, in response to a query, and the like. As described herein, blockchain description value, which may include entity identifiers, transaction descriptions, and/or asset descriptions, an instance of the blockchain, an identifier of an entity of interest, and the like. Interpreting the blockchain description value may include processing the description value to extract relevant information. In one example, the description value may be a text string and interpreting may include using natural language processing to extract elements such as asset descriptions, an entity of interest, and the like. In one example, the description value may be a numerical value and interpreting may include normalizing, offsetting, decrypting, and the like. In embodiments, interpreting the blockchain description value may include operations such as extracting, simplifying, lookup operations, and the like and different operations may be required for different types of data. In embodiments, operations may be selected based on user selections, may be automatically selected based on machine learning, and the like.

The method may include providing a blockchain index data structure in response to the blockchain description value. The blockchain index data structure may include a plurality of attribute values for each of a plurality of entities associated with the blockchain description value 404. In embodiments, providing the blockchain index data structure may include transmitting the structure via a network. In some embodiments, providing the blockchain index data structure may include one or more of proving a link to a server, access to a server that includes the index, providing credentials or access to a service that includes the index data structure and the like.

The method may include interpreting user search value 406. The user search value may be provided by one or more interfaces via a webpage, application, mobile device, and the like. Interpreting user search value may include operations applied to the search value. In embodiments, operations may include operations such as extracting semantic meaning from the search value (using any number of natural language processing techniques), converting values, normalizing values, expanding values, and the like. Interpreting user search value may include accessing one or more knowledgebases and/or databases to identify related search values such as related text or numerical values to generalize the search value or narrow the search value.

The method may include providing a search description to the user interface in response to the search value and the blockchain index data structure 408. As described herein, the search description may be an output of a search of the index using the interpreted search value. The search description may be direct indexes or blocks of a blockchain that match the search. In embodiments, the search description may be further interpreted or supplemented with external data, filtered, enhanced, the like.

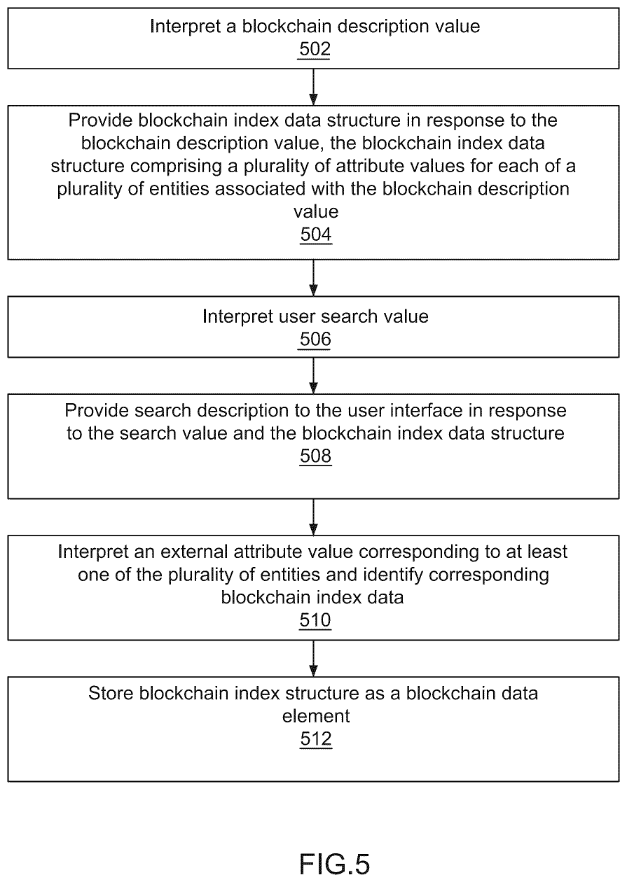

With reference to the example of FIG. 5, an example method includes the step of interpreting a blockchain description value 502, providing a blockchain index data structure in response to the blockchain description value 504, and interpreting a user search value 506.

The method may include interpreting external attribute values, such as external attribute values corresponding to at least one of a plurality of entities, and identifying corresponding blockchain index data 508. The external attribute values may include any attribute value for the entity from another blockchain, and/or attributes known about the entity apart from the blockchain. In embodiments, the external attribute values may be interpreted based on the user profile providing the search value. The user profile may indicate user interests, purchases, online engagements, and the like. The external attribute value may identify aspects such as blocks that are similar to user interest, relate to ownerships with a user that matches the profile aspects and the like.

The method may further include providing a search description to the user interface in response to the search value, the blockchain index data structure, and the external attribute values 510. The search description may include ratings of search results with respect to the matching of the results to the external attribute values. The method may further include storing the blockchain index structure as a blockchain data element 512.

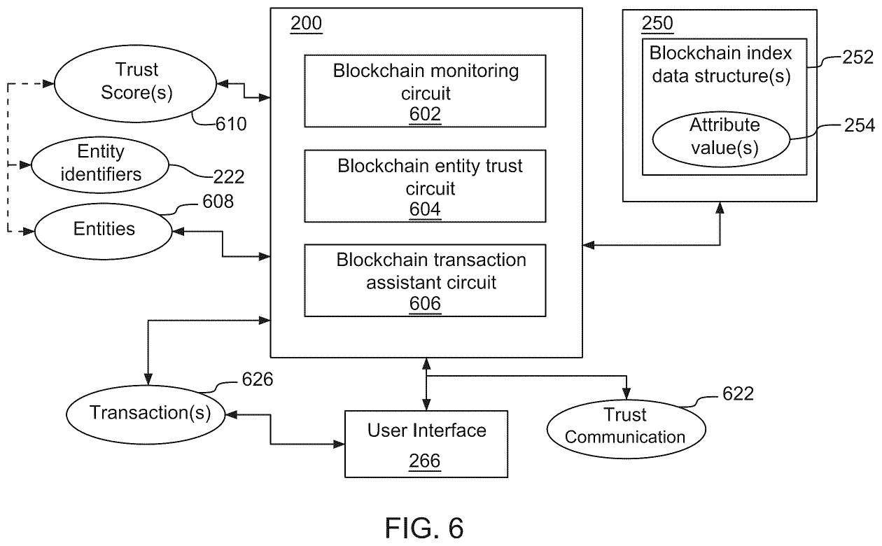

With reference to the example of FIG. 6, an example controller 200 may include a blockchain monitoring circuit 602 structured to interpret a blockchain index data structure 252. The blockchain index data structure 252 may include a plurality of attribute values 254 for each of a plurality of entities 608 associated with a blockchain 250. The controller 200 may include a blockchain entity trust circuit 604 structured to determine a trust score 610 for at least one of the plurality of entities 608. The controller 200 may further include a blockchain transaction assistant circuit 606 structured to provide a trust communication 622, in response to the trust score 610, to a user interface 266 for transactions associated with the blockchain 250. The operations of the blockchain transaction assistant circuit 606 allow for the user to perform transactions 626 with a high confidence that the asset will have characteristics as described, that the transaction is likely to be completed successfully, and/or that the user will have sufficient funds, executes transactions properly, has proper ownership of assets, or the like.

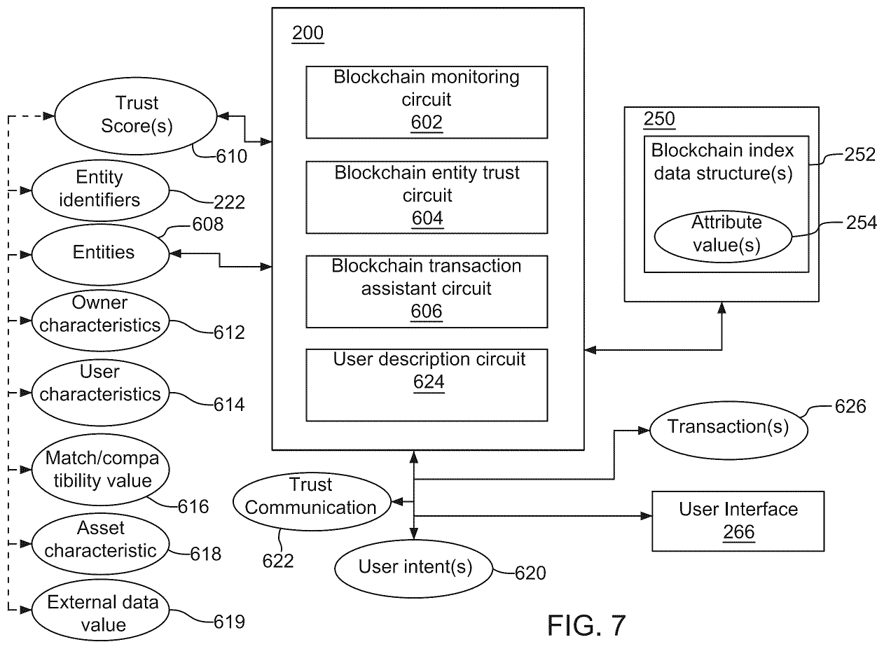

With reference to the example of FIG. 7, an example controller 200 may include a blockchain monitoring circuit 602 structured to interpret a blockchain index data structure 252.

The blockchain index data structure 252 may include a plurality of attribute values 254 for each of a plurality of entities 608 associated with a blockchain 250. The plurality of entities 608 may each comprise at least one of an asset, a token, or a contract. The plurality of attribute values 254 may include values such as a transaction amount, an asset type, an asset description, an entity identifier, a metadata value, a timestamp value, an asset value description, an asset authenticity value, a trust value, and/or an asset future valuation.

The controller 200 may include a blockchain entity trust circuit 604 structured to determine a trust score 610 for at least one of the plurality of entities 608. The plurality of entities 608 may each include at least one of an account, a wallet, or a user identifier. The blockchain entity trust circuit 604 may be structured determine the trust score 610 in response to an owner characteristic of an owner associated with the corresponding one of the plurality of entities.

The blockchain entity trust circuit 604 is further structured to determine the trust score 610 in response to an owner characteristic 612 of an owner associated with the corresponding one of the plurality of entities 608. Owner characteristics 612 may include one or more characteristics. Owner characteristics 612 may include a portfolio description related to the owner. Owner characteristics 612 may include a transaction history associated with the owner. Owner characteristics 612 may include a value performance for similar entities associated with the owner. Owner characteristics 612 may include a feedback value associated with the owner.

The blockchain entity trust circuit 604 may be further structured to determine the trust score 610 in response to a user characteristic 614 of a user interacting with the user interface 266. The blockchain entity trust circuit 604 may be further structured to determine the trust score 610 in response to a match 616 between the owner characteristic 612 and the user characteristic 614. The blockchain entity trust circuit 604 may be further structured to determine the trust score 610 in response to a compatibility value 616 between the owner characteristic 612 and the user characteristic 614.

The blockchain entity trust circuit 604 may be further structured to determine the trust score 610 in response to a user characteristic of a user interacting with the user interface 266.

The blockchain entity trust circuit 604 may be further structured to determine the trust score 610 in response to a match 616 between the owner characteristic 612 and the user characteristic 614. The blockchain entity trust circuit 604 may be further structured to determine the trust score 610 in response to a compatibility value 616 between the owner characteristic 612 and the user characteristic 614. The blockchain entity trust circuit 604 may be further structured to determine the trust score 610 in response to an asset characteristic 618 of the corresponding one of the plurality of entities 608. The asset characteristic 618 may include one or more different characteristics. The asset characteristic 618 may include a value performance prediction. The asset characteristic 618 may include a value performance of an offset asset. The asset characteristic 618 may include a classification value. The asset characteristic 618 may include a liquidity prediction. The asset characteristic 618 may include a liquidity performance of an offset asset. The asset characteristic 618 may include an ownership history value. The blockchain entity trust circuit 604 may be further structured to determine the trust score 610 in response to a user characteristic of a user interacting with the user interface 266.

The blockchain entity trust circuit 604 may be structured to determine the trust score in response to an external data value 619. The external data value 619 may include one or more different values. The external data value 619 may include a social media signal value. The external data value 619 may include a news signal value. The external data value 619 may include a search engine popularity value. The external data value 619 may include an asset transaction trending value.

The blockchain entity trust circuit 604 may be structured to determine the trust score 610 in response to a user intent 620 of a user interacting with the user interface 266. Example and non-limiting user intent(s) 620 include an investment intent (e.g., indications that the user tends to hold assets to sell at a higher price and/or to increase a value of an asset portfolio), a collector intent (e.g., indications that the user tends to hold assets, for example in a collection), and/or a seller intent (e.g., the user tends to sell assets and/or maintain an asset inventory, and/or the user acts as a seller for certain asset genres, creators, or the like). The user intent 620 may be performed using a classifier and available data about the specific user (e.g., a target buyer, target seller, etc., and/or which may be performed over time for all users accessing a specific blockchain, and/or prioritized for users accessing the specific blockchain, such as based on user asset holdings value, transaction value, transaction frequency, or the like), such as transaction data, asset holdings data, expressed user intents (e.g., in a profile associated with the user), and/or based on external data such as social media postings, news articles, or the like. In certain embodiments, the user intent 620 may be determined by an expert system (e.g., rules around asset or transaction thresholds, keywords utilized by the user, etc.), based on statistical determinations (e.g., average asset values, hold times, sell times, buy/sell values, etc.), and/or using an artificial intelligence based classifier (e.g., according to similarity on selected or determined characteristics to a trained data set of users or pseudo-users having classified intents). The user intent(s) 620 may be associated with the user generally, associated with the user by blockchain (e.g., the user interacting with Blockchain One exhibits a first intent, and the same user interacting with Blockchain Two exhibits a second intent), and/or associated with the user by asset (e.g., the user exhibits investment behavior for a first asset type and/or asset genre, and exhibits collector behavior for a second asset type and/or asset genre), and/or according to any other context set forth throughout the present disclosure (e.g., intent based on searching, buying, selling, etc.).

In embodiments, the owner characteristic 612 includes one or more characteristics. The owner characteristic 612 may include a portfolio description related to the owner. The owner characteristic 612 may include a transaction history associated with the owner. The owner characteristic 612 may include a value performance for similar entities associated with the owner. The owner characteristic 612 may include a feedback value associated with the owner, for example provided by other users of the system and/or automatically determined based on transaction outcomes, asset holdings, or the like.

The controller 200 may further include a blockchain transaction assistant circuit 606 structured to provide a trust communication 622, in response to the trust score 610, to a user interface 266 for transactions associated with the blockchain 250.

The controller 200 may further include a user description circuit 624 structured to determine a user intent in response to at least one of: a transaction history associated with the user, a portfolio description related to the user, or interactions of the user with the user interface 266. The user description circuit 624 may be structured to provide an intent declaration communication to the user interface 266, and to determine the user intent in response to user interactions responsive to the intent declaration communication. User intent may include an ownership interest intent, a portfolio value intent, and/or an asset value intent. In one example the trust communication may include the trust score, a trust category, or a trust indicator.

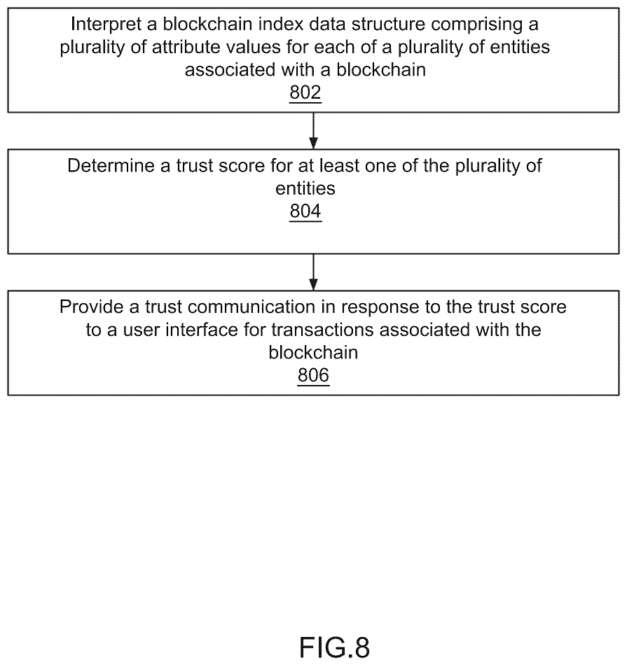

With reference to the example of FIG. 8, an example method includes the step of interpreting a blockchain index data structure comprising a plurality of attribute values for each of a plurality of entities associated with a blockchain 802. The method may further include determining a trust score for at least one of the plurality of entities 804. The method may further include providing a trust communication in response to the trust score to a user interface for transactions associated with the blockchain 806.

In embodiments, assets in a blockchain may be evaluated based on a plurality of parameters and a value may be determined and associated with the asset. In embodiments, parameters may include aspects of the asset, owner of the asset, activity of the asset, blockchain parameters associated with the asset, and the like.

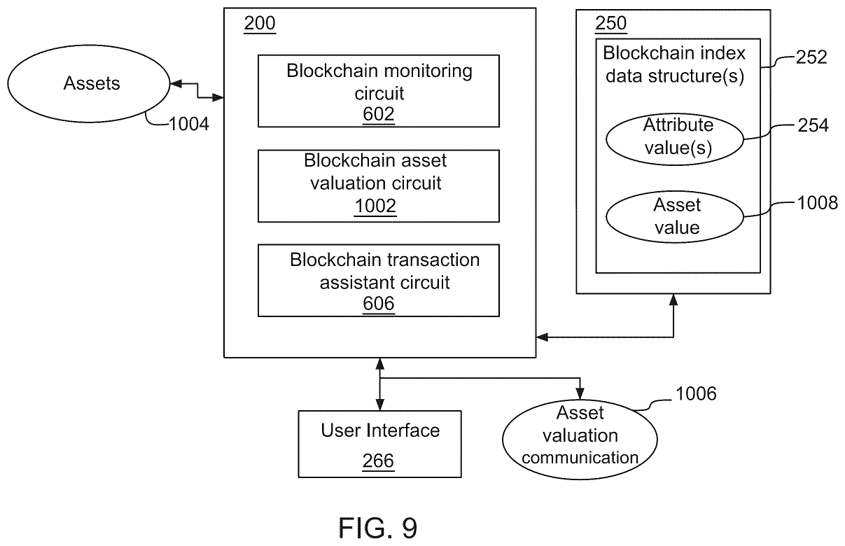

With reference to the example of FIG. 9, an example system may include a blockchain monitoring circuit 602 structured to interpret a blockchain index data structure 252. The blockchain index data structure 252 may include a plurality of attribute values 254. The attribute values 254 may be defined for each of a plurality of assets 1004 associated with a blockchain 250. A controller 200 may include a blockchain asset valuation circuit 1002 structured to determine an asset value 1008 for at least one of the plurality of assets 1004. The controller 200 may further include a blockchain transaction assistant circuit 606 structured to, in response to the asset value 1008, perform one or more operations. In embodiments, the operations may include one or more of provide an asset valuation communication 1006 to a user interface 266 for transactions associated with the blockchain and/or store the asset value 1008 on the blockchain index data structure 252.

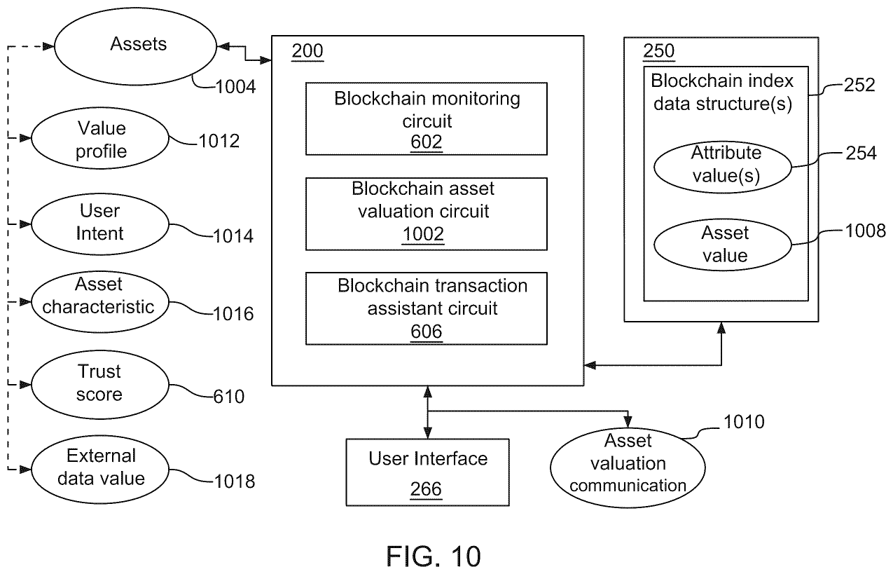

With reference to the example of FIG. 10, an example system may include a blockchain monitoring circuit 602 structured to interpret a blockchain index data structure 252. The blockchain index data structure 252 may include a plurality of attribute values 254. The attribute values 254 may be defined for each of a plurality of assets 1004 associated with a blockchain 250. Each one of the attribute values 254 may correspond to each one of the plurality of assets 1004 and may include one or more aspects to each attribute value. The attribute values 254 may include an asset predicted value description (e.g., the expected value of the asset over time, at a specific future time, as an expected rate of return, as a net present value, etc.), an asset type value (e.g., the form of the asset, how it is transacted, ownership characteristics such as rights and responsibilities for the asset, etc.), an asset genre value (e.g., which genre the asset belongs to, such as portrait, person, science fiction, etc., and which may include more than one genre), an asset rarity value (e.g., whether the asset is rare, based on raw numbers, frequency of occurrence for similar assets, context of the rarity such as by blockchain, and/or a description of which asset attributes or characteristics contribute to the rarity of the asset), an asset author value (e.g., the creator of the asset, the source of the asset, etc.), and/or an asset authenticity value (e.g., an index, categorical description, and/or quantitative description indicating the likelihood that one or more asset attributes, such as valuation and/or associated creator, is consistent with the stated or advertised attribute—for example whether the listed author for the asset is likely to be correct).

A controller 200 may include a blockchain asset valuation circuit 1002 structured to determine an asset value 1008 for at least one of the plurality of assets 1004. The blockchain asset valuation circuit 602 may be structured to interpret a value profile 1012 for at least one entity associated with the blockchain (e.g., a current value of an asset and/or of holdings by a user, projected or estimated values for these, and/or any context parameters such as assumptions of hold times, transaction activity, portfolio future holding assumptions, etc.), and to determine the asset value 1008 further in response to the value profile 1012. The value profile 1012 may include a plurality of parameters. Example parameters for the value profile 1012 include one or more parameters such as: an asset type for one or more assets, a portfolio description related to the at least one entity, a transaction history associated with the at least one entity, a value performance for an offset asset (e.g., historical value performance for an asset having similar attributes and/or characteristics), and/or an indicated acquisition goal related to the at least one entity (e.g., whether the entity is a collector, investor, seller, etc., which may affect the asset value and/r future asset expected value).

In embodiments, the value profile may include a user intent 1014 corresponding to the at least one entity. The user intent may include an ownership interest intent (e.g., the purpose of ownership, expected hold time, expected future transaction time, etc.), a portfolio value intent (e.g., whether the asset value is at least partially due to other assets held in a portfolio, whether that portfolio mix is expected to change, etc.), and/or an asset value intent (e.g., whether the asset holder intends to hold the asset as an investment, to sell the asset based on portfolio content, to sell the asset based on future value, etc.).

In embodiments, the blockchain asset valuation circuit 1002 is further structured to determine the asset value 1008 further in response to an asset characteristic 1016 corresponding to the at least one asset 1004. Asset characteristics may include a value performance prediction, a classification value (e.g., to group the asset with other assets having similar attributes and/or characteristics, for example which may enhance the capability of value predictions, future transaction predictions, or the like), a liquidity prediction (e.g., an estimate of how readily the asset will be able to be sold, how large the potential buyer pool is or is expected to be, etc.), a liquidity performance of an offset asset, and/or an ownership history value (e.g., predicting the value trajectory, hold time, future transaction time, etc., of an asset based on the ownership history of the asset holder).

The asset characteristic may include a trust score 610. The trust score 610 may correspond to at least one asset 1004 and/or a second entity associated with at least one asset. For example, the trust score 610 may be a score related to the asset (e.g., whether the asset is authentic, properly owned, available for sale, etc.) and/or to a related entity (e.g., based on transactions or other characteristics for the asset holder and/or for potential future buyers or sellers for the asset). In certain embodiments, the trust score 610 may additionally or alternatively be based on asset characteristics, for example where an asset holder has a generally high trust score, for example due to numerous successful transactions, but the asset in particular is unusual for the user (e.g., a higher value than previous transactions, a significant portion of the holder's overall portfolio, etc.) which may indicate that the trust score 610 for that user should be decremented with regard to that particular asset.

In embodiments, the blockchain asset valuation circuit 1002 may be further structured to determine the asset value 1008 in response to an external data value 1018. The external data value may include one or more different values. The external data may include a social media signal value (e.g., general activity indicating that the asset is trending favorably or unfavorably, and/or specific messages such as from the asset holder that indicate the asset holder's assessment of the asset and/or assets of the type are likely to be divested, that the asset holder wants to increase their position with such assets, etc.). The external data may include a news signal value (e.g., indications based on news documents that the asset is trending favorably or unfavorably, will be subject to additional regulatory and/or social scrutiny, etc.). The external data may include a search engine popularity value (e.g., determining that searches related to the asset and/or an attribute thereof are indicating that the asset is trending favorably or unfavorably). The external data may include or an asset transaction trending value (e.g., a determination that the asset is becoming more popular or less popular, utilizing any external data such as social media, news, search engine activity, proprietary databases, industry analysis, journal articles, etc.).

In embodiments, one or more of the assets 1004 may include a fungible token or a non-fungible token. The controller 200 may also include a blockchain transaction assistant circuit 606 structured to, in response to the asset value(s) 1008, perform an asset valuation communication 1010. Example asset valuation communications 1010 include providing the asset value 1008 to a user interface 266 for transactions associated with the blockchain 250, and/or storing the asset value 1008 on a blockchain index data structure 252.

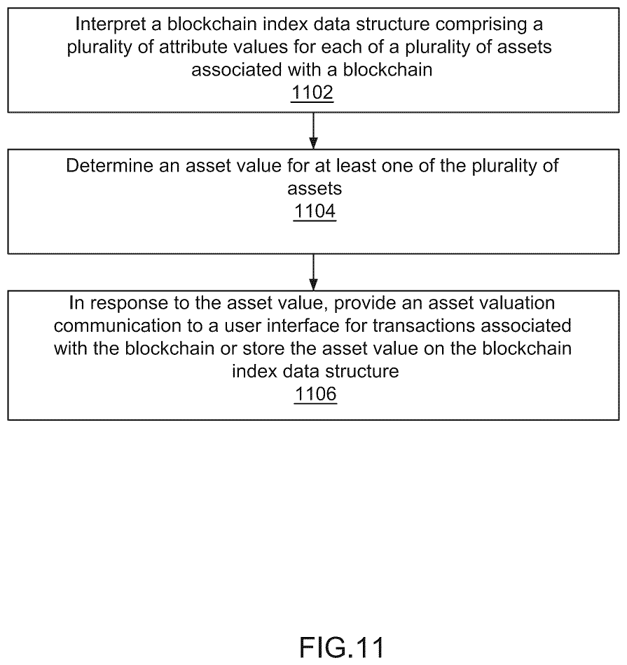

With reference to the example of FIG. 11, an example method includes the step of interpreting a blockchain index data structure comprising a plurality of attribute values for each of a plurality of assets associated with a blockchain 1102. The method may further include determining an asset value for at least one of the plurality of assets 1104. In response to the asset value, the method 1100 may include providing an asset valuation communication to a user interface for transactions associated with the blockchain or store the asset value on the blockchain index data structure 1106.

In embodiments, assets in a blockchain may be evaluated based on a plurality of parameters and assets may be ranked. In embodiments, parameters may include aspects of the asset, owner of the asset, activity of the asset, blockchain parameters associated with the asset, and the like.

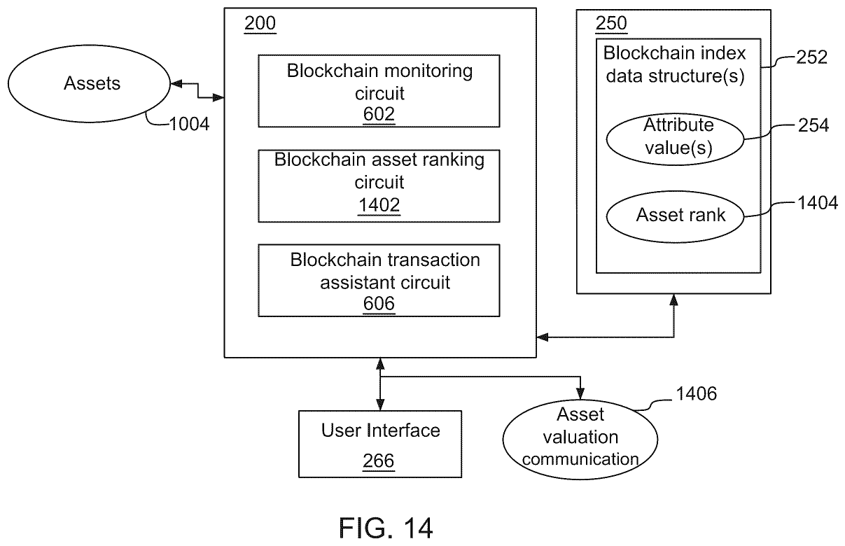

With reference to the example of FIG. 14, an example system may include a blockchain monitoring circuit 602 structured to interpret a blockchain index data structure 252. The blockchain index data structure 252 may include a plurality of attribute values 254 for each of a plurality of assets 1004 associated with a blockchain 250. The controller 200 may include a blockchain asset ranking circuit 1402 structured to determine an asset rank value 1404 for each asset of the plurality of assets 1004. The asset rank value 1404 may be based on a particular blockchain, across a group of blockchains, based on a collection of assets, based on a particular portfolio (e.g., the asset is the most valuable asset in the portfolio), and/or may be a quantitative rank value (e.g., top 3% of asset values, asset #17 of 1000, etc.) and/or a categorical rank value (e.g., a high/medium/low value, which may be determined statistically and/or defined by the user, a second quintile asset ranking, etc.), and/or may be utilized to filter assets such that just the top few ranked assets are returned for search results, the top few ranked assets are featured more prominently, etc. The controller 200 may also include a blockchain transaction assistant circuit 606 structured to, in response to the asset rank value 1404 for each asset 1004, perform one or more operations. In embodiments, the operations may include providing an asset ranking communication 1406 to a user interface 266 for transactions associated with the blockchain 250. In embodiments, the operations may include storing the asset rank value 1404 for each asset of the plurality of assets 1004 on the blockchain index data structure 252.

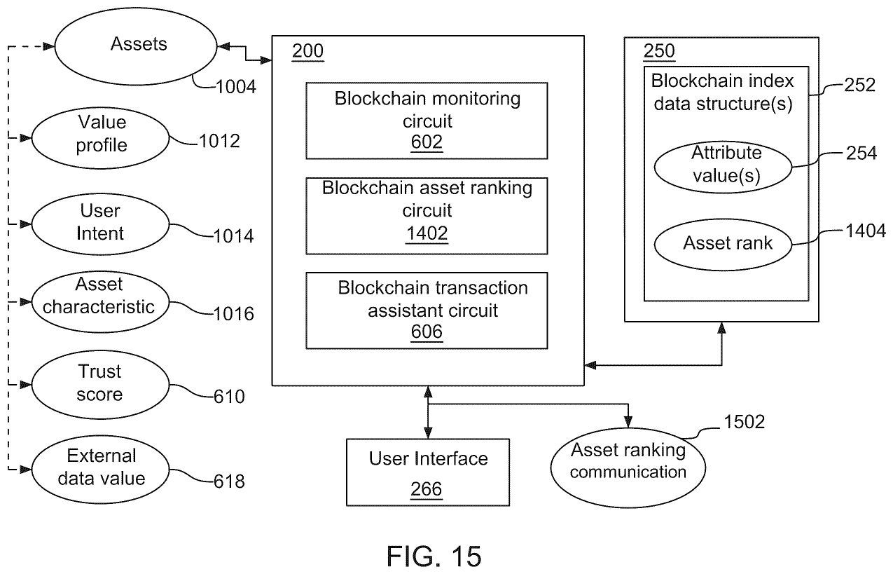

With reference to the example of FIG. 15, an example system may include a blockchain monitoring circuit 602 structured to interpret a blockchain index data structure 252. The blockchain index data structure 252 may include a plurality of attribute values 254 for each of a plurality of assets 1004 associated with a blockchain 250. Each asset of the plurality of assets may include one of a fungible token and/or a non-fungible token.

The controller 200 may include a blockchain asset ranking circuit 1402 structured to determine an asset rank 1404 value for each asset of the plurality of assets 1004. The blockchain asset ranking circuit 1402 may be structured to interpret a value profile 1012 for at least one entity associated with the blockchain 250. The blockchain asset ranking circuit 1402 may be structured to determine the asset rank value 1404 for each asset of the plurality of assets 1004 further in response to the value profile 1012.

In embodiments, the value profile 1012 may include one or more parameters. The value profile 1012 may include an asset type of the corresponding asset of the plurality of assets, the value profile 1012 may include a portfolio description related to the at least one entity. The value profile 1012 may include a transaction history associated with the at least one entity. The value profile 1012 may include a value performance for an offset asset. The value profile 1012 may include an indicated acquisition goal related to the at least one entity.

In embodiments, the value profile 1012 may include a user intent 1014 corresponding to the at least one entity. The user intent may include one or more intents. The user intent 1014 may include an ownership interest intent (e.g., indicating whether the user intends to own the asset for a period of time, hold the asset as an investor, and/or hold the asset as a collector). The user intent 1014 may include a portfolio value intent (e.g., indicating whether the asset maintains independent value as a part of a portfolio, for example to support selected financial performance of the portfolio, to provide a diversity of assets, asset types, or asset genres within the portfolio, and/or to as a part of a set of assets within the portfolio). The user intent 1014 may include or an asset value intent (e.g., indicating whether the asset is expected to increase in value, by how much, and time frames for these, and/or indicating that the asset may be available for divestment at a target valuation and/or selected time frame).

In embodiments, the blockchain asset ranking circuit 1402 may be structured to determine the asset rank value 1404 further in response to an asset characteristic 1016 corresponding to each asset of the plurality of assets 1004. Each asset characteristic 1016 may include one or more characteristics. Asset characteristic 1016 may include a value performance prediction. Asset characteristic 1016 may include a value performance of an offset asset. Asset characteristic 1016 may include a classification value. Asset characteristic 1016 may include a liquidity prediction. Asset characteristic 1016 may include a liquidity performance of an offset asset. Asset characteristic 1016 may include or an ownership history value. In embodiments, each asset characteristic 1016 may include a trust score that correspond to the corresponding asset of the plurality of assets 1004. In embodiments, each asset characteristic 1016 may include a trust score that correspond to a second entity associated with the corresponding asset of the plurality of assets 1004.

The controller 200 may also include a blockchain transaction assistant circuit 606 structured to, in response to the asset rank 1404 value for each asset 1004, perform one or more operations. In embodiments, the operations may include providing an asset ranking communication 1502 to a user interface 266 for transactions associated with the blockchain 250. In embodiments, the operations may include storing the asset rank value 1404 for each asset of the plurality of assets 1004 on the blockchain index data structure 252.

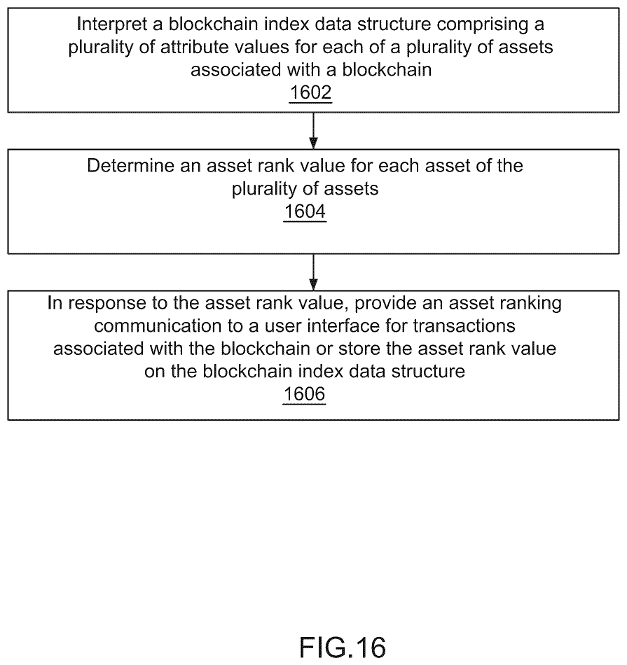

With reference to the example of FIG. 16, an example method includes the step of interpreting a blockchain index data structure comprising a plurality of attribute values for each of a plurality of assets associated with a blockchain 1602. The method may further include determining an asset rank value for at least one of the plurality of assets 1604. In response to the asset rank value, the method may include providing an asset ranking communication to a user interface for transactions associated with the blockchain or store the asset value on the blockchain index data structure 1606.

In embodiments, assets in a blockchain may be evaluated based on a plurality of parameters and assets may be ranked. In embodiments, parameters may include aspects of the asset, owner of the asset, activity of the asset, blockchain parameters associated with the asset, and the like.

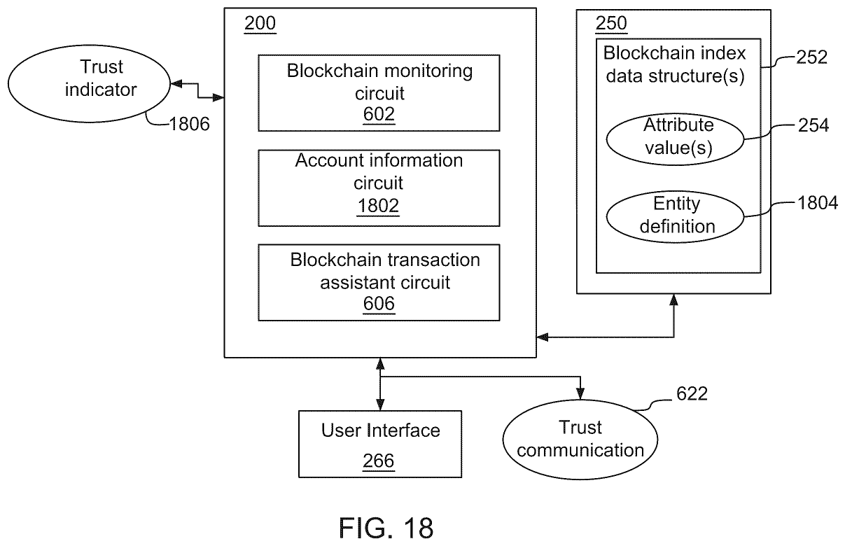

With reference to the example of FIG. 18, an example system may include a controller 200 that includes an account information circuit 1802 that is structured to determine entity definition data 1804 for a plurality of entities corresponding to accounts on a blockchain 250. Account information circuit 1802 may be configured to store at least a portion of the entity definition data 1804 as a blockchain index data structure 252. The controller 200 may further include a blockchain monitoring circuit 602 structured to interpret the blockchain index data structure 252 to determine a trust indicator 1806 description for at least one of the plurality of entities. The controller 200 may further include a blockchain transaction assistant circuit 606 structured to provide a trust communication 622, in response to the trust indicator data 1806, to a user interface 266 for transactions associated with the blockchain 250. The example of FIG. 18 allows for trust indicators to be associated with particular accounts or entities, allowing for operations to provide a trust indicator for particular transactions to a user, to associate trust indicators between accounts that are associated by other operations of the present disclosure, or the like. The trust indicator 1806 may be based on the success of executed transactions, overall portfolio value for the account, consistency of transactions on the account (e.g., timing, completion, types of assets, indicated intents, etc.), the age of the account, feedback provided by other users interacting with the account, or the like.

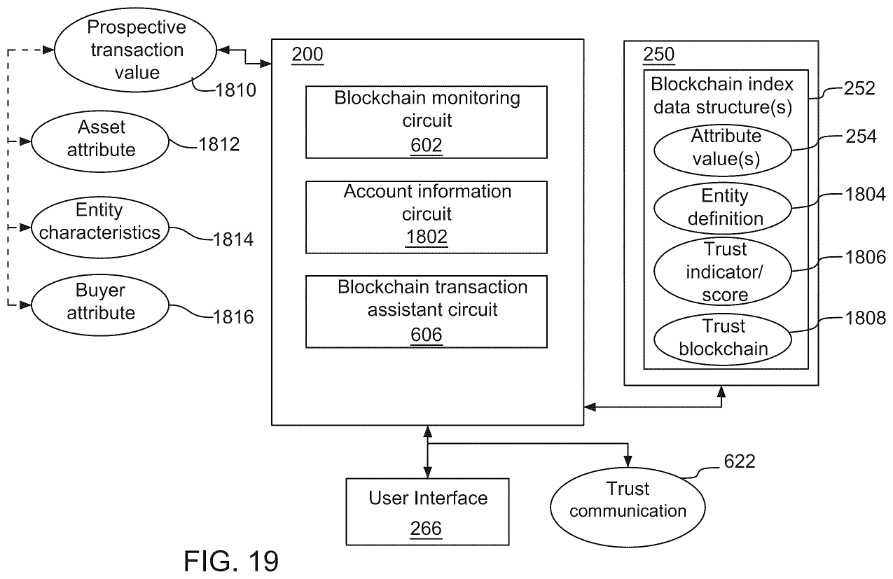

With reference to the example of FIG. 19, an example system may include a controller 200 that includes an account information circuit 1802 that is structured to determine entity definition data 1804 for a plurality of entities corresponding to accounts on a blockchain 250. Account information circuit 1802 may be configured to store at least a portion of the entity definition data 1804 as a blockchain index data structure 252. Entity definition data 1804 may include any data that can be utilized to determine whether a given transaction, asset, user, another account on the same or a different blockchain, or the like, is related to the account held by, or embodied by, the entity in question. For example, the entity definition data 1804 may include one or more identifiers (e.g., usernames, IP addresses, related entities such as persons or companies, contact information, addresses, etc.), and/or ancillary information (e.g., transaction types, transaction valuations, asset holding information, time of day history for searches or transactions, etc.) that can be utilized to determine the trust indicators 1806, to relate the trust indicators 1806 to other entities (e.g., an account held by the same entity), and/or to provide a context based adjustment to the trust indicators 1806 for the purpose of the present user (e.g., adjusting the trust indicator 1806 if a contemplated transaction is unusual for the entity holding the asset, and/or if there is a good or bad match between intents, interests, or holding between the present user and the entity holding the asset).

The controller 200 may further include a blockchain monitoring circuit 602 structured to interpret the blockchain index data structure 252 to determine a trust indicator 1806 (and/or trust score) description for at least one of the plurality of entities. The blockchain monitoring circuit 602 may be further structured to determine a trust score 1806 for the at least one of the plurality of entities in response to the trust indicator description. The blockchain monitoring circuit 602 may be further structured to store at least one of the trust indicator descriptions and/or the trust indicator 1806 on the blockchain index data structure 252.

In embodiments, the blockchain index data structure 252 may include a trust blockchain 1808. In some embodiments, the blockchain index data structure 252 may comprises a trust relational database.

The controller 200 may further include a blockchain transaction assistant circuit 606 structured to provide a trust communication 622, in response to the trust indicator 1806, to a user interface 266 for transactions associated with the blockchain 250.

In embodiments, the blockchain transaction assistant circuit 606 may be further structured to determine a prospective transaction value 1810. The blockchain monitoring circuit 602 may be further structured to determine the trust score 1806 in response to the prospective transaction value 1810. The blockchain transaction assistant circuit 606 may be further structured to provide the trust communication 622 in response to the trust score 1806. The prospective transaction value 1810 may include a value of the prospective transaction, such as an expected gain, a rate of return, a net present value, a future estimated value at a selected time, etc. The prospective transaction value 1810 may include a value of an offset transaction. The prospective transaction value 1810 may include a selling entity identifier. The prospective transaction value 1810 may include a buying entity identifier. The prospective transaction value 1810 may include an asset type value. The prospective transaction value 1810 may include an asset genre value.

In embodiments, the system may further include a means for providing the trust score 1806 in response to at least one entity characteristic 1814 (e.g., incrementing or decrementing the trust score where the entity characteristic indicates a good or bad match for the transaction, such as whether the transaction is normal or unusual for the entity; for determining whether estimated values are likely to be true, such as whether the entity is likely to be sophisticated with regard to the asset, and/or whether past holdings of similar assets by the entity have performed according to expectations; and/or whether relevant attributes of the entity are similar to relevant aspects of the present user, and/or consistent with the purpose of the proposed transaction). The characteristic 1814 may include a characteristic of a selling entity for the prospective transaction. The characteristic 1814 may include a characteristic of a buying entity for the prospective transaction. The characteristic 1814 may include a characteristic of an asset entity for the prospective transaction. The system may include a means for providing the trust score 1806 in response to a correspondence between an asset attribute 1812 and a buyer attribute 1816 (and/or seller attribute, not shown) for the prospective transaction. The system may include a means for providing the trust score in response to a correspondence between a buyer attribute (e.g., the present user and/or a prospective buyer entity) and a seller attribute (e.g., the present user and/or a prospective seller entity) for the prospective transaction.

Examples herein reference a means for performing certain functions, for example and without limitation: a means for providing a trust score in response to entity characteristics, and/or in response to entity attributes; a means for identifying at least one prospective buyer for a prospective transaction; a means for ranking identified prospective buyers for prospective transaction(s); a means for identifying at least one prospective seller for a prospective transaction; a means for ranking identified prospective sellers for prospective transaction(s); a means for identifying at least prospective creator for a prospective transaction; and/or a means for ranking identified prospective creator(s) for prospective transaction(s). Without limitation to any other aspect of the present disclosure, a means for any one or more of these operations includes: a controller configured to perform related operations, including identifying and/or ranking potential buyers, sellers, and/or creators, communicating the identified prospects to the user (e.g., implicitly, such as by displaying potential assets in view of the identification and/or rankings, and/or explicitly such as by providing a list of potential buyers, sellers, and/or creators), where the controller can be configured in whole or part utilizing any controller aspects as set forth throughout the present disclosure, and which may include one or more circuits as set forth herein; and/or any operations, procedures, methods, or the like, as set forth throughout the present disclosure. Operations to provide trust score(s), prospective buyers, prospective sellers, prospective creators, and/or related communications as set forth throughout the present disclosure may be scoped according to associated blockchains (e.g., limited to a particular blockchain, and/or a selected group of blockchains), entities (e.g., considering tagged or identified accounts, assets, users, etc., but not other entities outside of the selected group), assets (e.g., tagged or identified assets, asset genres, asset types, etc.), attribute filtered versions of these (e.g., considering only accounts having a minimum transaction activity, portfolio holding value, etc.), and/or combinations of these.

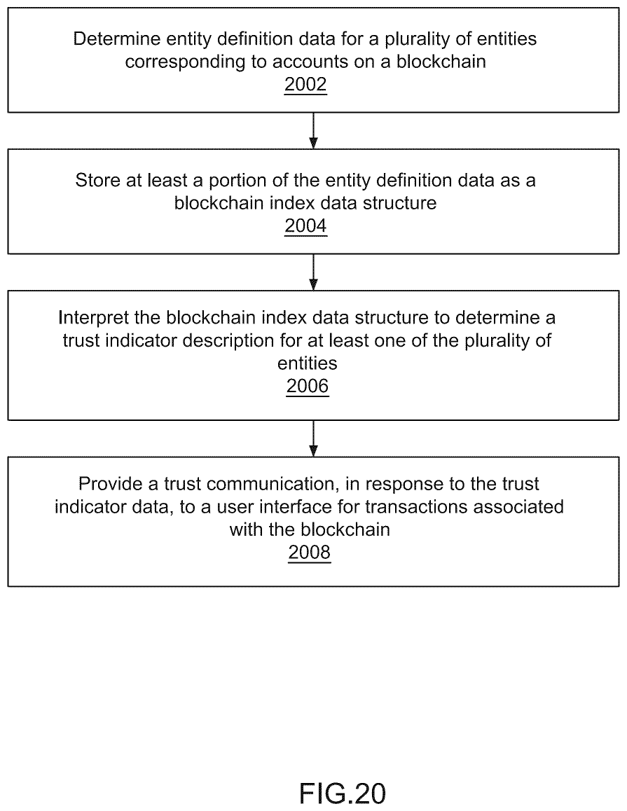

With reference to the example of FIG. 20, an example method includes the step of determining entity definition data for a plurality of entities corresponding to accounts on a blockchain 2002. The method may further include storing at least a portion of the entity definition data as a blockchain index data structure 2004. The method may further include interpreting the blockchain index data structure to determine a trust indicator description for at least one of the plurality of entities 2006. The method may further include providing a trust communication, in response to the trust indicator data, to a user interface for transactions associated with the blockchain 2008.

Referencing FIG. 21, an example system for performing operations related to a blockchain, decentralized networking arrangement, or the like, is schematically depicted. The example system may be utilized with any controllers, circuits, procedures, or the like as set forth throughout the present disclosure. The example system depicts an example arrangement to illustrate aspects of the present disclosure, but is not limiting to the description herein. The example system may be utilized with, in whole or part, other systems such as depicted in FIG. 1, and/or with any other aspect of the present disclosure. The example system depicts a controller 200 configured to perform operations such as, without limitation: assisting a user in finding appropriate sellers for assets that interest the user; assisting a user in finding appropriate buyers for assets owned by, controlled by, or otherwise within the sphere of influence of the user, including assets where the user may have an option to acquire the asset and/or is prospectively considering acquiring the asset; assisting the user in determining whether a potential buyer or seller has a high trust score; assisting the user in determining whether a potential buyer or seller has additional accounts, wallets, or a presence separate from the presently considered account or wallet, including on a same blockchain or another blockchain; assisting a user in finding appropriate content creators for assets or asset types that interest the user; assisting the user in determining whether an asset acquisition or divestment is likely to meet the user's goals, whether the goals are valuation goals, investment goals, collection goals, ensuring that assets are appreciated, or the like; and/or assisting a user in determining whether an asset is a copy of another asset (whether a proper copy or improper copy) and/or a copy of an asset source (e.g., whether the asset was created by a particular artist), including determining whether the copy is a high quality copy. The example controller 200 is depicted as a single device for clarity of the present description. In certain embodiments, the controller 200 may be distributed, have portions implemented in the cloud, have portions present on the user device 110, or the like.

In certain embodiments, the controller 200 is capable to perform operations on a target blockchain and/or across a number of blockchains. In certain embodiments, the controller 200 is capable to perform operations on a collection of assets, whether the collection of assets is with a single owner, distributed across multiple owners, and/or distributed across a number of platforms. The example system depicts the controller 200 as a single device in communication with other aspects of the system, for example a first blockchain 3002 (e.g., a blockchain storing and/or allowing transactions related to a number of assets), a second blockchain 3004 (e.g., a second blockchain storing and/or allowing transactions related to a number of assets), a user device 110 (e.g., a computing device, web application, dedicated proprietary program, mobile application, or the like, that implements a user interface allowing a user to interact with the controller 200 and/or the blockchains 3002, 3004), and a third blockchain 3006. It will be understood that the arrangement of aspects of the system may be distinct from that shown, for example with one or more blockchains stored on the controller 200 or otherwise accessible to the controller 200. Further, a blockchain is a distributed data object, and the schematic depiction of FIG. 21 is illustrative of the logical and communication connections between the controller 200 and the rest of the system. A blockchain will exist on a large number of computing devices, and the depiction of FIG. 21 illustrates blockchains that can be accessed by the controller 200, but the physical arrangement of the blockchains will not typically be as depicted.

In the example system, the first blockchain 3002 is shown with two accounts, a first account 3008 and a second account 3010. The depicted accounts are shown to illustrate aspects of the disclosure as presented herein. The accounts 3008, 3010 may be owned by a same user, or distinct users, as will be understood in the context of various examples of the present disclosure. Additionally, one or more of the accounts 3008, 3010 may be owned by a user accessing the user device 110, or may be owned separately, as will be understood in the context of various examples of the present disclosure. Similarly, the second blockchain 3004 is utilized to illustrate embodiments where more than one blockchain is accessed by the controller 200, and the accounts 3012, 3014 on the second blockchain 3004 may be owned by various entities, including by owners of the accounts 3008, 3010, the user accessing the user device 110, or the like. In examples of the present disclosure, where the ownership distribution of accounts on blockchains is interesting to the example, the ownership distribution will be described. Otherwise, the number of accounts, number of blockchains, and relationship between these and various owners of the accounts is not limiting.

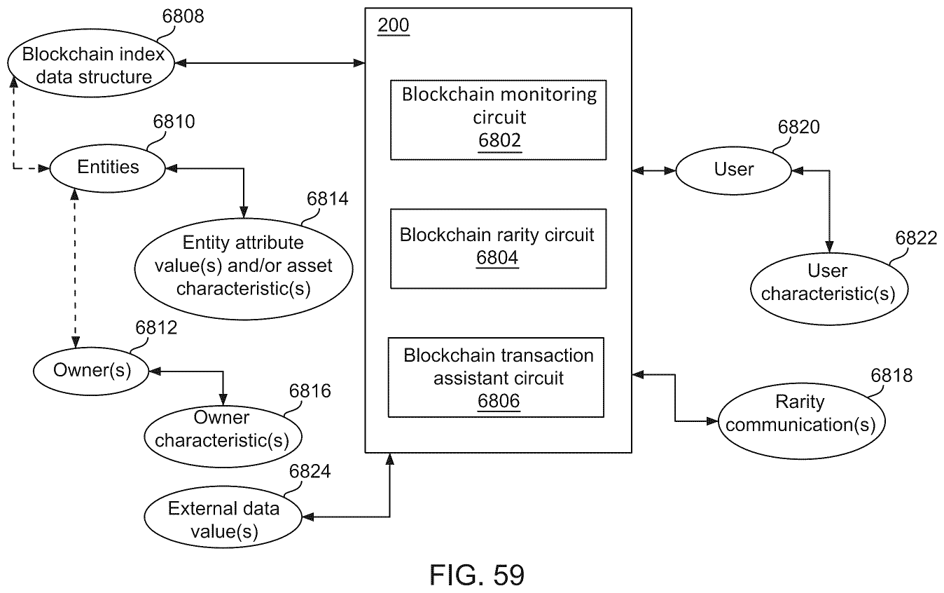

The example system depicts a third blockchain 3006 having a number of data elements stored thereon which may be accessed by the controller 200. In the example of FIG. 21, the third blockchain 3006 is an additional blockchain, created by and/or utilized by the controller 200 to store, secure, and update information to support operations of the controller 200 as set forth throughout the present disclosure. For example and without limitation, the third blockchain 3006 may be utilized to store, access, and/or update information such as: a trust catalog, trust scores, interest values (e.g., buyer interest values), descriptions (e.g., buyer interest descriptions, seller interest descriptions, quality descriptions, match descriptions, compatibility descriptions, etc.), equivalence values 3016, similarity values 3022, data structures (e.g., a blockchain group index data structure 3020, and/or a blockchain index data structure 6808—e.g., reference FIG. 59 and the related description), identifying information 3018 (e.g., identifying information for assets, tokens, accounts, wallets, etc.). In certain embodiments, the third blockchain 3006 may instead include a number of blockchains, for example divided categorically (e.g., a first type of information on a first blockchain, and a second type of information on a second blockchain, etc.), functionally (e.g., high access rate information on a dedicated blockchain, secure information such as personally identifiable information (PII) on a dedicated blockchain; information separated on blockchains by geographic region; information separated on blockchains according to the retention period applicable to the information, etc.), and/or practically (e.g., separated between blockchains to limit the size of a block and/or a blockchain). In certain embodiments, other data structures may be utilized for some or all of the information depicted in the context of the third blockchain 3006, for example a relational database, a general database, an inverted index data structure, or the like. In certain embodiments, multiple data structures may be utilized, for example with data stored on a relational database, and migrated to a blockchain at a later time. The examples depicted in FIG. 21, and set forth in the description referencing FIG. 21, are illustrative and non-limiting.

In certain embodiments, the user device 110 accesses a blockchain independently from the controller 200, for example where operations of the controller 200 assist the user in various transactions, searching for assets, buyers, sellers, content creators, and the like, and in determining whether transactions will support the goals of the user. In certain embodiments, the controller 200 is configured to implement operations for the user on blockchains 3002, 3004, for example allowing the user to select or confirm a transaction with the controller 200 that is then implemented on the user's behalf on the underlying blockchain 3002, 3004. In certain embodiments, the situation may be mixed, with the user able to implement certain transactions and/or transactions with certain blockchains through an interface with the controller 200, and transactions and/or transactions with certain blockchains through direct interactions with a blockchain 3002, 3004. It will be understood that the user device 110 may represent a number of user devices, for example where a single user interacts with the system using different devices at different times, and/or where multiple users each interact with one or more user devices during certain operations as set forth herein.

Referencing FIG. 22, an example apparatus includes a controller 200 having an account information circuit 302 structured to interpret identifying information 320 for a seller blockchain account and for each one of at least one buyer blockchain account. In certain embodiments, the example apparatus of FIG. 22 provides for an efficient determination of target buyers for a seller of an asset. In certain embodiments, operations of the apparatus of FIG. 22 may be performed prospectively, for example where a prospective seller seeks a listing of potential buyers for an asset before acquiring or creating the asset, and/or performed for a presently owned asset, for example where a seller is seeking a list of buyers for an asset, which may allow the seller to reach out directly to buyers from the list of buyers, to configure aspects of the asset and/or a smart contract for the asset to be attractive to buyers, or the like. In certain embodiments, the seller may adjust the asset and/or terms related to the asset (e.g., labeling of the asset, listing locations for the asset, and/or smart contract terms for the asset) and iteratively improve the chances of a successful sale, and/or conditions of the sale, by repeating operations of the apparatus thereby refreshing the list of buyer targets after adjustments.

In the example, the identifying information 320 for each one of the at least one buyer blockchain accounts includes an attribute interest value 322. The attribute interest value 322 may be an expression of any attribute that may be of interest to a potential buyer for an asset, token, NFT, or the like, for example a type of asset (e.g., picture, sound clip, work of art, etc.), a value description for the asset (e.g., target value, minimum value, maximum value, etc.), a genre of the asset (e.g., comedy, aesthetic value, science fiction, mystery, etc.), a creation date or range of creation dates, etc. In certain embodiments, the attribute interest value 322 may be entered directly by the buyer, for example where the buyer indicates through a search term, a preference setting, or other interface attributes of interest to the buyer. In certain embodiments, the attribute interest value 322 may be determined or inferred separately from, or in conjunction with, direct indications by the buyer. For example, the attribute interest value 322 may be determined according to previous transactions by the buyer, previous searches by the buyer, attributes of assets currently held by the buyer, or the like.

The example controller 200 includes an asset attribute circuit 304 structured to interpret an asset attribute value 310 for an asset (not shown) associated with the seller blockchain account. An asset that is associated with the seller blockchain account may be any asset presently owned by the account, historically owned by the account, having a similar aspect to assets owned by the account and/or having another connection to the account (e.g., an asset similar to assets typically owned by, and/or transacted by, the account; and/or an asset having an author that is associated with the account, for example if the account typically owns and/or transacts assets by that author). The example controller 200 includes a buyer interest circuit 306 structured to determine a buyer interest value 356 for each one of the at least one buyer blockchain accounts in response to each corresponding attribute interest value 310 and the asset attribute value 322. In certain embodiments, the buyer interest value 356 is an indication of the likelihood that a given buyer will be interested in acquiring the asset, and the buyer interest value 356 may be categorical (e.g., likely buyer, unlikely buyer, etc.) or quantitative (e.g., an index value or other quantification, with a scale allowing for specific comparisons between buyers, where the index value is determined in response to a number of attribute matches and/or a quality of the matches for a given buyer). In certain embodiments, the buyer interest value 356 is determined for all prospective buyers. In certain embodiments, the buyer interest value 356 is determined for only a subset of prospective buyers, for example by filtering on highly selective criteria such as transaction value, transaction history of the buyers, etc.

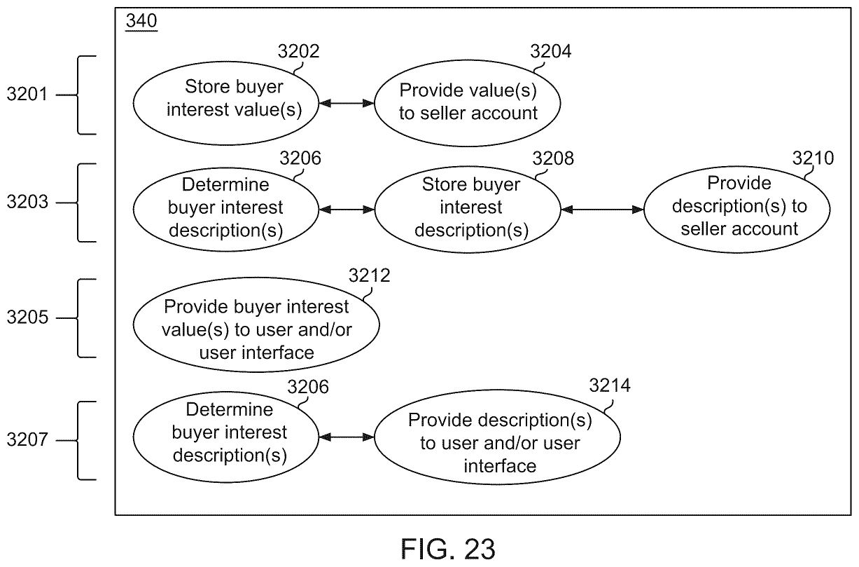

The example controller 200 includes a buyer identification execution circuit 308 structured to perform a buyer identification attribute operation 340 (or buyer identification operation) in response to the buyer interest value(s) 356. The buyer identification operation 340 is the mechanism by which the controller 200 specifically assists the seller in determining the set of likely buyers, or the set of buyers having the highest likelihood to purchase the asset. Referencing FIG. 23, example buyer identification operations 340 are schematically depicted.

An example buyer identification operation 340 includes operations 3201, including an operation 3202 to store buyer interest values (e.g., in an index, data structure, and/or on a separate blockchain) and an operation 3204 to provide the buyer interest values to the seller account. Operation 3204 includes any operations such as, without limitation: providing a list of potential buyers (e.g., the top 5, top 10, top 50, etc.); providing a list of potential buyers with a categorical notation (e.g., likely, unlikely, etc.); providing a list of potential buyers with additional information interpreted from the attribute matching (e.g., likely buyer, but at a lower valuation; likely buyer, but faster or slower turnaround time expected relative to a nominal expectation; unlikely buyer, but a close match with the exception of one or two attributes, such as age of the asset, color palette, etc.); and/or a list of buyers with the buyer interest value 356 presented (e.g., showing an index score of the match for comparison by the seller). The operations 3201 allow for a convenient representation of potential buyers for the seller, confirmation of general interest in the asset, and/or a quick determination of which aspects of the asset make the asset highly desirable or less desirable, for example allowing the seller to plan future asset acquisition or creation, and/or to adjust aspects of the asset that are adjustable (e.g., asking price, labels or presentation, and/or smart contract terms).

An example buyer identification operation 340 includes operation 3203, including an operation 3206 to determine buyer interest descriptions, an operation 3208 to store the buyer interest descriptions, and an operation 3210 to provide the buyer interest descriptions to the seller account. The buyer interest description may include information such as the buyer interest value 356, a confidence that the buyer interest value is correct (e.g., based on the quantity and/or certainty of information utilized to determine the buyer interest value), criteria that make the buyer a strong match and/or a weaker match (e.g., genre, type, buyer portfolio contents, etc.), and/or other buyer information that may be of interest to the seller (e.g., buyer turnaround time, time between transactions for the buyer, average hold times of similar assets by the buyer, etc.). The operation 3203 otherwise functions similarly to operation 3201.

An example buyer identification operation 340 includes operation 3205, including an operation 3212 to provide buyer interest values to a user and/or to a user interface. For example, operations 3201, 3203 to store the information may include making the information accessible to the seller for access at a later time, where operation 3205 includes providing the information directly to the seller through a user interface, using a message (e.g., a text, e-mail, and/or using a messaging app). The operation 3205 may be combined with storing the information, and/or the operation 3205 may be utilized to provide immediate feedback without storing the buyer list, buyer interest values, and/or buyer interest descriptions.

An example buyer identification operation 340 includes operation 3207, including the operation 3206 and an operation 3214 to provide buyer description values to a user and/or to a user interface.

In certain embodiments, the buyer identification operation 340 includes an interface to allow the seller to act on the buyer list, for example allowing the seller to directly contact buyers, to list the asset for sale, and/or to store the buyer list for future reference.

Again referencing FIG. 22, an example buyer interest value 356 includes a buyer recommendation value 354, for example determined according to a best match between the buyer and the asset (e.g., matching the greatest number of attributes, matching the highest priority attributes, having a highest index score, etc.). In certain embodiments, the buyer recommendation value 354 may be utilized to summarize the top buyer and/or top several (e.g., top 3 buyers, top 10 buyers, etc.) buyers for the seller without the seller having to review the entire list of prospective buyers. In certain embodiments, the buyer recommendation value 354 may be utilized to provide the seller with the best immediate buyer options, for example omitting a buyer with a higher buyer interest value 356 having a characteristic that makes the current sale of the asset unlikely (e.g., the buyer only buys once per year, and bought an asset recently; the buyer already has a functionally identical asset or another asset that likely fulfills the same role, etc.). In certain embodiments, the buyer identification execution circuit 308 provides the buyer recommendation value 354 to a user associated with the seller blockchain account.

In certain embodiments, the buyer interest circuit 306 adjusts the buyer interest value 356 in response to the asset attribute value 310 and/or the attribute interest value 322. For example, where the buyer interest value 356 is stored, a change in the buyer's interest indications (e.g., a change in the assets held by and/or transacted by the buyer) and/or a change in the asset (e.g., valuation, popularity of the genre, etc.) since the buyer interest value 356 was stored may be utilized to recalculate and adjust the buyer interest value 356. In another example, the buyer interest value 356 may be determined in real time, for example while the seller is accessing a list of potential buyers, allowing the list to be adjusted in real time in response to events such as buyer transactions, external data, changes in preferences and/or importance of criteria (e.g., time to sell, sale price, etc.) by the seller.

An example controller 200 includes the buyer interest circuit 306 determining a buyer ranking description 3102, which includes a ranking of at least a portion of the potential buyers, for example ordered according to the buyer interest values 356, the attribute interest values 322, or the like. The buyer ranking description 3102 may be utilized to provide a partial listing of buyer (e.g., top 50 buyers), to indicate the most promising buyers to the seller, to filter the potential buyers for deeper analysis (e.g., developing buyer interest descriptions for only a portion of the potential buyers, filtered according to the ranking), and/or to conserve storage space and related resources (e.g., by storing buyer interest values 356 according to the buyer ranking description 3102).

In certain embodiments, the buyer interest value 356 includes an identifier of the associated buyer blockchain account(s), which may be stored as a part of the buyer interest values 356, presented to the seller, utilized to allow the seller to contact the buyers (e.g., while selectively hiding or presenting the buyer identity), to associate various assets or determinations across blockchains, transactions, or time frames (e.g., allowing the controller 200 to evaluate transactions, interest values, holdings, etc. for the buyer in other contexts, such as operations set forth throughout the present disclosure). In certain embodiments, for example where the buyer interest value 356 does not include an identifier, operations of the controller 200 are still useful to the seller, for example allowing the seller to determine a level of interest among buyers for an asset, even where the actual potential buyers are not identified.

An example buyer interest value 356 further includes a match description 3104 between the asset attribute value(s) 310 and the attribute interest value(s) 322. For example, the match description 3104 may indicate aspects that are a match (e.g., genre of the asset and interested genre for the buyer are a match), that are not a match (e.g., buyer does not buy assets that are greater than $1,000, and the prospective list price of the asset is $2,000), and/or a distance between the asset attribute value 310 and the attribute interest value 322 (e.g., the asset is listed at $500 above the buyer's apparent limit, and the buyer tends to take 25 days for a transaction from listing, where the seller is hoping for a 7 day turnaround). In certain embodiments, for example where categorical attributes are utilized, a distance determination may be determined according to a classification function (e.g., a “distance” between horror and mystery may be determined to be lower than a “distance” between mystery and nature documentary). In certain embodiments, the match description 3104, for example including the number of matching attributes, the importance of the matching or unmatched attributes, and/or the distance between the attributes and the interest, may be utilized to determine the buyer interest value 356, a score or ranking of the buyer interest value 356, and/or the buyer interest description.

An example buyer interest value 356 further includes a compatibility description 3106 between the asset attribute value(s) 310 and the attribute interest value(s) 322. For example, the compatibility description 3106 may indicate aspects that are compatible (e.g., price target of the asset is compatible with transaction ranges executed by the buyer, value of assets within the buyer portfolio, etc.) and/or that are incompatible (e.g., the asset cannot be sold in the jurisdiction of the buyer). The compatibility description 3106 may be utilized to determine the buyer interest value 356, a score or ranking of the buyer interest value 356, and/or the buyer interest description. In certain embodiments, the compatibility description 3106 may indicate that an asset, buyer, or seller has an otherwise high buyer interest value 356, but is not applicable to the present situation and should not be included as a recommendation, listed in a ranking for the requesting user, or the like. However, utilization of compatibility values may be useful in various embodiments, for example allowing embodiments to utilize the buyer interest value 356 calculation for another user (e.g., a user having similar interests, and considering the same asset or another asset with similar attributes), where the subsequent user may not have the same compatibility issue, saving calculations and related resources (e.g., data storage, communications, time delays experienced by the user, etc.) for the system.

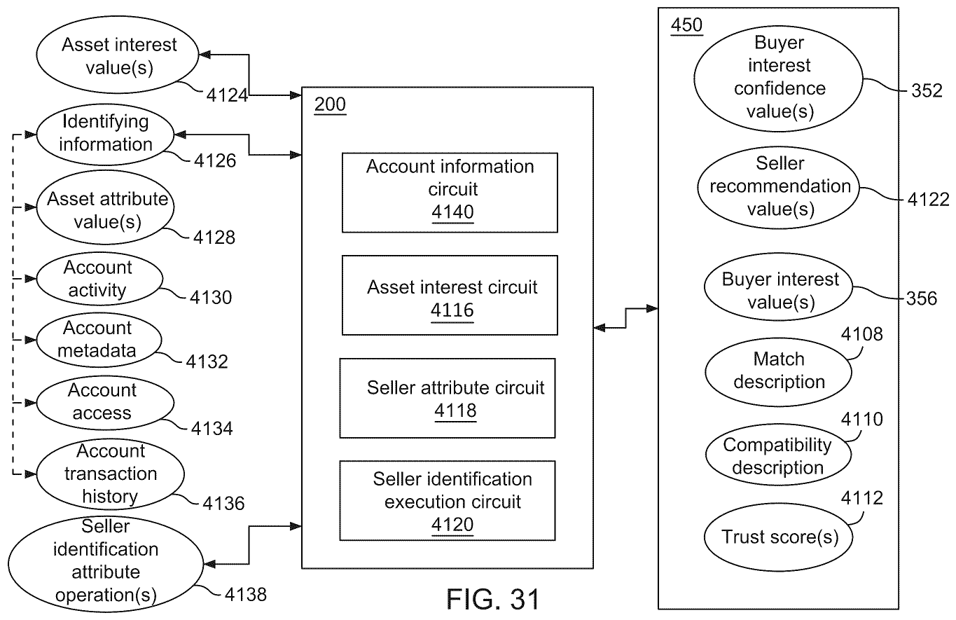

Example and non-limiting identifying information 320 for the buyer account(s) include information such as: account activity information 324 (e.g., how often the buyer accesses the blockchain, time since last access, transaction rates, changes in activity over time, etc.); account metadata 326 (e.g., time stamps for activity, location information, login times, etc.); account access information 328 (e.g., IP addresses associated with the account, devices associated with the account, applications and/or application versions utilized to access the account, etc.); account transaction history 330 information (e.g., information about previous transactions, including timing, amounts, success or failure of transactions, and/or data about assets that have been transacted); account valuation information 3304 (reference FIG. 24; e.g., total value of held assets, distribution of the value between assets, average asset values, minimum or maximum asset values, etc.); and/or account portfolio information 3302 (reference FIG. 24; e.g., types of assets held, attributes of assets held, holding time of assets, turnover of assets, etc.). In certain embodiments, identifying information 320 may be utilized to support a number of aspects and operations of the present disclosure, including with regard to both buyer accounts (the specific context of controller 200 of FIG. 22) and seller accounts (e.g., reference FIG. 31). Example supported operations include utilizing identifying information 320 to enhance confidence of the attribute preferences for a potential buyer, to determine equivalence between different accounts (e.g., including different accounts on a same blockchain or on separate blockchains), and/or to enhance artificial intelligence and/or iterative improvement operations (e.g., enhancing the number of available inputs that can be correlated to outcomes such as completion of a sale, turnaround time on a sale, etc., and/or to enhance pattern recognition operations where other criteria such as portfolio value or distribution can be correlated to likely activity on the blockchain).

An example buyer interest value 356 includes a buyer interest confidence value 452, which may capture the confidence that the buyer is a likely buyer, and/or the confidence that the buyer interest value 356 is correctly determined. For example, a buyer that has never bought an NFT with a valuation exceeding $10 may have a low buyer interest value 356 for an asset having a $1,000,000 valuation, where that buyer interest value 356 may have a high buyer interest confidence value 452 (e.g., the determination is likely to be correct). The buyer interest confidence value 452 may be adjusted over time, for example based on the success or failure of predictions related the buyer and/or the buyer interest value 356 algorithm utilized, and/or based upon the confidence of the asset attributes (e.g., the seller may have a low certainty of the intended price, and/or may utilize a wide price range) and/or the buyer interest (e.g., buyer has only three assets, all in the “Historical Portrait” genre of the asset, giving a high percentage match to the genre of the asset and a high buyer interest value 356, but with low confidence due to the small sample size). In certain embodiments, the buyer interest confidence value 452 may be included in a buyer interest description, utilized in scoring or ranking buyers, utilized by an AI component and/or iterative improvement operation over time to improve the buyer interest value 356 model, or the like.

Referencing FIG. 25, example and non-limiting asset attribute values 310 are schematically depicted, which may be utilized in determining the buyer interest values 356, matching confidence, compatibility with buyer interests, or the like. In certain embodiments, asset attribute values 310 may be weighted, by the seller and/or by the buyer interest circuit 306, allowing the controller 200 to provide a buyer recommendation customized for the seller. For example two sellers having functionally equivalent assets may receive distinct buyer recommendations, for example due to a difference in importance of asset attributes for the sellers (e.g., a first seller wants to maximize the sale price or NPV, while a second seller wants to sell quickly to a buyer that is likely to hold and appreciate the asset). Example attribute values 310 include one or more of: an asset value description 3402 (e.g., an estimated value of the asset, based on expected sale price, time to sell, etc.); an asset predicted value description 3404 (e.g., a trajectory of the value over time); an asset type value 3410 (e.g., a type of the asset such as a picture, sound file, title to a real asset outside the blockchain, etc.); an asset genre value 3412 (e.g., a category of the asset by subject matter, physical characteristic such as color palette, scenery type, depicting people or animals, etc.); an asset rarity value 3414 (e.g., asset occurrence frequency based upon selected characteristics such as value, author, genre, and/or any other characteristic of the asset that is infrequent, and preferably but not exclusively having a rare characteristic that is relevant to the asset value); an asset author value 3408 (e.g., an identifier of the author for the asset); and/or an asset authenticity value 3406 (e.g., whether the asset is authenticated, potentially including a related confidence to the authentication determination, which may be determined according to any confidence determination operations described herein, determined according to a trust score associated with the seller or owner, and/or according to a separate certification, for example by an independent certifying authority).

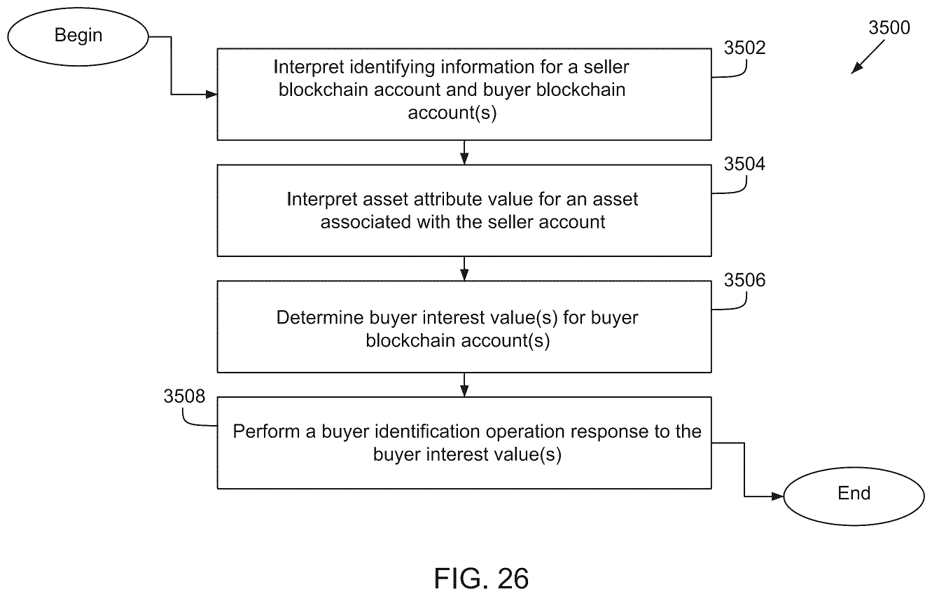

Referencing FIG. 26, an example procedure 3500 for identifying buyers for a seller on a blockchain is schematically depicted. The example procedure 3500 may be performed, in certain embodiments, by any controller, circuit, or apparatus herein, and/or may be performed as a part of a system herein. The example procedure 3500 includes an operation 3502 to interpret identifying information for a seller blockchain account and for each one of at least one buyer blockchain account, the identifying information for each one of the at least one buyer blockchain account including an attribute interest value, and an operation 3504 to interpret an asset attribute value for an asset associated with the seller blockchain account, and an operation 3506 to determine a buyer interest value for each one of the at least one buyer block chain accounts in response to each corresponding attribute interest value and the asset attribute value. The example procedure 3500 further includes an operation 3508 to perform a buyer identification operation in response to the buyer interest value.

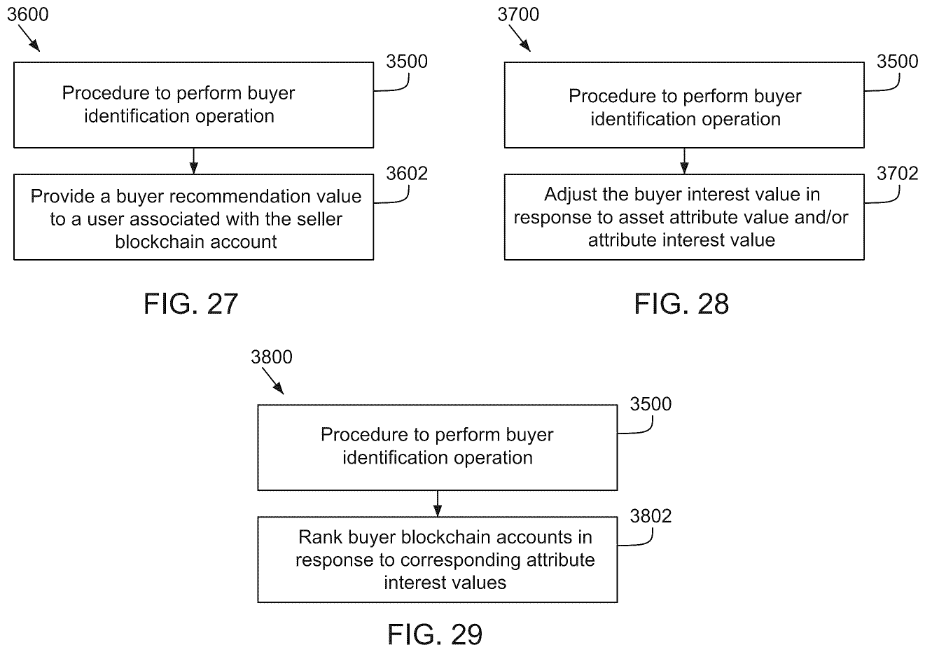

Referencing FIG. 27, an example procedure 3600 further includes an operation 3602 to provide a buyer recommendation value to a user associated with the seller blockchain account in response to the buyer interest value. Referencing FIG. 28, an example procedure 3700 further includes an operation 3702 to adjust the buyer interest value in response to at least one of the asset attribute value or the attribute interest value for at least one of the buyer blockchain accounts. Referencing FIG. 29, an example procedure 3800 includes an operation 3802 to rank at least a portion of the buyer blockchain accounts in response to the corresponding attribute interest values.

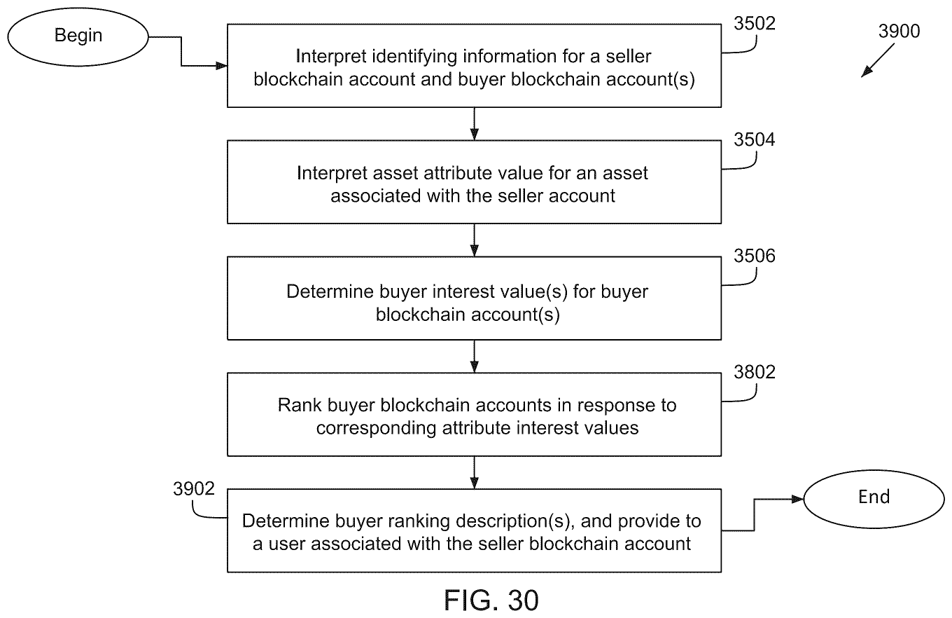

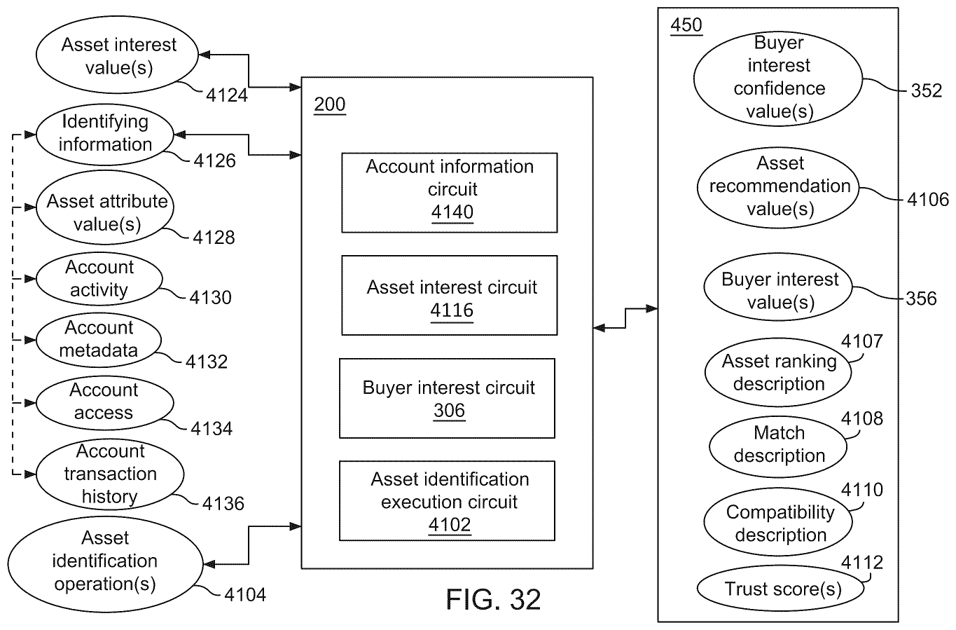

Referencing FIG. 30, an example procedure 3900 includes the operation 3802 to rank the buyer blockchain accounts, and an operation 3902 to determine buyer ranking descriptions in response to the rankings (e.g., from operation 3802), and to perform the buyer identification operation by providing the buyer ranking description to a user associated with the seller blockchain account. In certain embodiments, a procedure includes performing operation 3508, for example utilizing any of the operations set forth in regard to one or more operations 3201, 3203, 3205, 3207 set forth in FIG. 32 and the related description.

Referencing FIG. 31, an example controller 200 is schematically depicted, configured to perform seller identification attribute operations, for example to identify sellers for a potential buyer looking to obtain assets having one or more attributes of interest. The example controller 200 includes an account information circuit 4140 structured to interpret identifying information 4126 for a buyer blockchain account (e.g., to determine asset attributes that the buyer is interested in, which may be determined directly, for example by the buyer exercising a user interface, and/or indirectly, for example by evaluating buyer account information such as attributes of assets already owned by the buyer, the transaction history of the buyer, account activity of the buyer, etc.), and for seller account(s) on one or more relevant blockchains. In certain embodiments, the identifying information 4126 may further include asset attribute values 4128, either for a seller account (e.g., averaged and/or aggregated attributes for all assets and/or relevant assets owned by the seller account) and/or for individual assets associated with the seller account. The example controller 200 includes an asset interest circuit 4116 that interprets an asset interest value 4124, for example including attributes that the buyer is interested in acquiring during the specific interactions with the controller 200. In certain embodiments, the controller 200 determines the attributes that the buyer is interested in in response to the asset interest value 4124, and/or further in conjunction with the identifying information 4126 for the buyer account. The example controller 200 includes a seller attribute circuit 4118 that determines a buyer interest value 356 for one or more assets associated with one or more of the seller accounts (e.g., determining assets that are likely to be desirable to the buyer based on the asset interest value 4124 and/or the identifying information 4126 for the buyer account, which is based on the asset attribute values 4128 for individual assets and/or the identifying information 4126 for the associated seller account(s)). The example controller 200 further includes a seller identification execution circuit 4120 that performs a seller identification attribute operation 4138 (or a seller identification operation) in response to the buyer interest value(s) 356. Example and non-limiting seller identification attribute operations 4138 include operations such as: providing a list of sellers likely to have assets of interest; ranking sellers and providing a ranked list of sellers likely to have assets of interest; identifying specific assets likely to be of interest; ranking assets likely to be of interest, and providing a ranked list of assets likely to be of interest; storing a seller list, ranked seller list, buyer interest value(s) 356, asset list, ranked asset list, and/or providing the stored information to a user interface and/or to the buyer user (e.g., on request, periodically, in a location accessible to the buyer user, etc.). In certain embodiments, the identifying information 4126 includes one or more of: asset attribute value(s) 4128, account activity 4130, account metadata 4132, account access 4134 information, and/or account transaction history 4136. In certain embodiments, the controller 200 stores and/or accesses information on a blockchain 450 (and/or other data structure), including one or more of buyer interest confidence value(s) 352 (e.g., related to a confidence that interest determinations are correct), seller recommendation value(s) 4122 (e.g., providing sellers that tend to sell assets of interest, whether those sellers presently have an asset of interest presently available), the buyer interest value(s) 356, match description 4108 information (e.g., detailing aspects of the match between the interest 4124 and attributes 4128, including match/no-match information, and/or match distance information), compatibility description 4110 information (e.g., detailing aspects of the asset that are not compatible with the interests 4124, confirmation of compatibility, or the like), and/or trust scores 4112 (e.g., associated with the seller account, equivalence related accounts, and/or specific assets that may be of interest).

Referencing FIG. 32, an example controller 200 configured to identify assets that may be of interest for a potential buyer, such as a user associated with a buyer account, is schematically depicted. The example controller 200 includes an account information circuit 4140 that interprets identifying information 4126 for a buyer blockchain account and for at least one asset each associated with a corresponding seller blockchain account. The example identifying information 4126 includes asset attribute value(s) 4128 for each asset. The example controller 200 includes an asset interest circuit 4116 that interprets an asset interest value 4124 associated with the buyer blockchain account. As in other embodiments, the asset interest value 4124 may be determined according to explicit criteria provided by the buyer user, and/or according to the identifying information 4126 for the buyer account. The example controller 200 further includes a buyer interest circuit 306 that determines a buyer interest value 356 for each asset in response to the asset interest value 4124 and the asset attribute value(s) 4128 for each asset. In certain embodiments, the buyer interest circuit 306 determines buyer interest value(s) 356 only for those assets that are likely to be a good match, for example utilizing highly selective information for potential assets such as asset valuation, asset type, asset genre, or the like. The example controller 200 further includes an asset identification execution circuit 4102 that performs an asset identification operation 4104 in response to the buyer interest value(s) 356. The example controller 200 further accesses a blockchain 450 (or other data structure) to store and/or access information to support asset identification operations 4104, such as buyer interest confidence value(s) 352, asset recommendation value(s) 4106, the buyer interest value(s) 356, an asset ranking description 4107, a match description 4108, a compatibility description 4110, and/or trust score(s) 4112 (e.g., trust scores associated with particular assets, corresponding seller account(s), and/or equivalence related seller account(s)).

In certain embodiments, the buyer interest value 356 further includes an asset recommendation value 4106, for example providing assets that may be of interest based on the asset interest value(s) 4124, which may include selecting a number of assets having a similarity to assets where a formal interest determination has been made, based on a ranking of potential assets, or the like. An example asset identification execution circuit 4102 provides the asset recommendation value 4106 to a user associated with the buyer blockchain account, for example as an asset identification operation 4104.

In certain embodiments, assets evaluated, recommended, ranked, and/or checked by the controller 200 include tokens, for example a fungible token, non-fungible token, limited edition token, or the like. In certain embodiments, an asset may be a real asset, for example where a token on the blockchain provides title to the real asset, and/or provides a contractual obligation to the real asset (e.g., demonstrating availability of the real asset; an option related to the real asset such as an option to buy or sell the real asset at a future time and/or price point; and/or provides access to the real asset, such as an access code or the like).

In certain embodiments, the buyer interest circuit 306 adjust the buyer interest value 356, for example in response to a change in the asset interest value 4124, and/or a change in the identifying information 4126 for the buyer user (e.g., which can be determined to reflect a change in the asset interest value 4124, priorities of the buyer, weighting criteria to evaluate the value and/or interest of the asset to the buyer user), for a seller account (e.g., which may adjust the trust score of the seller, change the value of the asset in view of changes to the seller portfolio, and/or otherwise change an aspect of the asset for the buyer, such as a change in estimated response time of the seller or the like), and/or for the asset (e.g., indicating that an attribute of the asset has changed or updated, a transfer of the asset to another seller, and/or a change to an offset asset that may change the buyer interest value 356—e.g., due to a change in the valuation of an offset asset, liquidity of an offset asset, or the like). In certain embodiments, adjustments to the buyer interest value 356 may be performed in real time (e.g., while the buyer user is interacting with a list of recommended assets), periodically (e.g., where the buyer user sets a watch for particular assets, and the buyer interest circuit 306 refreshes the buyer interest values 356 on a schedule, for example weekly or daily), and/or in an event driven manner (e.g., refreshing the buyer interest values 356 in response to a significant event, such as a change in trending for an important class of assets, in response to significant transactions such as a high volume, high price, and/or low price transaction occurring for offset assets, in response to a significant change in user indicated asset interest value(s) 4124 and/or in response to a significant change for the identifying information 4126 for the buyer account, and/or in response to a request from the buyer user).

Changes in the identifying information 4126 for the buyer account that are significant will depend upon the circumstances, the asset attributes of interest, or the like. For example, an identifying information 4126 change indicating a significant change to the value of the buyer portfolio (e.g., acquisition or divestment of assets that greatly increase the total or average value, or that greatly decrease the total or average value), a change in asset genre mix in the buyer portfolio, a change in the asset type mix in the buyer portfolio, and/or a change in the trust scores that appear to be acceptable to the buyer, may be significant enough to indicate that a check of the buyer interest value(s) 356 for adjustment is indicated. In certain embodiments, in relation to the controller 200 depicted in FIG. 32, and/or in relation to any other buyer interest value determinations throughout the present disclosure, storing the buyer interest values and updating operations for the buyer interest value, may result in significant resource savings, for example avoiding recalculation of interest values previously determined where there has not been a significant change in the parameters utilized to determine the interest values. Without limitation to any other aspect of the present disclosure, operations to store the buyer interest value(s) and to selectively update buyer interest value(s) may be utilized for asset identification (e.g., as in FIG. 32), for buyer identification (e.g., as in FIG. 22), and/or for seller identification (e.g., as in FIGS. 31 and/or 40). In certain embodiments, as will be understood to one of skill in the art having the benefit of the present disclosure, considerations to determine whether a significant change has occurred indicating that a recalculation of the buyer interest value(s) may differ for buyer identification embodiments and/or for seller identification embodiments.

An example asset identification execution circuit 4102 performs the asset identification operation 4104 by ranking assets associated with the corresponding seller blockchain accounts in response to the corresponding asset attribute values 4128 and the asset interest value 4124. In certain embodiments, the ranking is stored, at least in part, as an asset ranking description 4107, which may be based upon the buyer interest value(s) 356 for the assets, and/or based upon criteria such as availability, liquidity of the assets, number and/or quality of attribute matches with interest, or the like. In certain embodiments, the asset ranking description 4107 may be based upon one or more of: a match quality between each corresponding asset attribute value 4128 and the asset interest value 4124; a trust score 4112 associated with a corresponding one of the assets; and/or a trust score 4112 associated with a corresponding seller blockchain account for an asset. In certain embodiments, the trust score 4112 for an asset is based upon distinct criteria from the trust score 4112 of a seller account (e.g., asset trust score may be based upon an authenticity estimate for the asset, where the seller trust score may be based upon prior transactions, seller account history and longevity, etc.), and/or the trust score 4112 for an asset may be combined with and/or limited by the trust score 4112 for the seller (e.g., producing an overall trust score 4112 for the particular seller/asset combination, and/or the asset trust score 4112 may be affected by the trust score 4112 for the seller).

An example asset identification execution circuit 4102 performs the asset identification operation 4104 by storing the buyer interest value 356, wherein the buyer interest value 356 includes one or more parameters such as: an identifier of at least one seller blockchain account, an identifier of at least one of the assets, and/or at least a portion of at least one of the asset attribute values. In certain embodiments, parameters included with the buyer interest value 356 are utilized to display additional information to the buyer user, to inform future determinations of buyer interest value(s) 356 (e.g., for the specific buyer user, and/or for other buyer users), and/or to determine whether a significant change has occurred indicating that the buyer interest value(s) 356 are indicated for adjustment and/or updating.

An example asset identification execution circuit 4102 performs the asset identification operation 4104 by storing a match description 4108 between the asset interest value 4124 and asset attribute value(s) 4128 (e.g., indicating which attributes matched or did not match, match distances, etc.). An example buyer interest value 356 additionally or alternatively includes a match confidence value, for example as a part of the match description, and indicating the certainty associated with the match determination between the asset interest value 4124 and asset attribute value(s) 4128. An example asset identification execution circuit 4102 performs the asset identification operation 4104 by storing a compatibility description 4110 between the asset interest value 4124 and asset attribute value(s) 4128.

An example buyer interest circuit 306 determines the buyer interest value 356 in response to account portfolio information 3302 (e.g., reference FIG. 24), for example indicating assets held by the buyer, a seller associated with the asset under consideration, or the like. In certain embodiments, the account portfolio information 3302 provides an indication of how the asset fits within the buyer's portfolio—for example if the asset value is similar to other assets held by the buyer, if asset fills a gap in the buyer's portfolio, and/or if the asset is in a genre, of a type, has a liquidity, or other attributes that are likely to be a good fit for the buyer. In certain embodiments, the account portfolio information 3302 provides an indication of how likely the seller is a sophisticated holder of the asset (e.g., holding numerous assets that are similar may indicate that the seller has properly valuated the asset, made good choices in acquiring and/or creating the asset, etc.), and/or the motivation of the seller (e.g., if the seller appears to be a collector, a broker, and/or whether the seller is a commercial seller or a personal seller, where any of these categories may be desirable or undesirable depending upon the buyer's goals and priorities).

Example asset attribute values 4128 may be any asset attribute values set forth throughout the present disclosure, for example as depicted in FIG. 25. Example and non-limiting identifying information 4126 may be any identifying information set forth throughout the present disclosure, for example as depicted in FIG. 24.

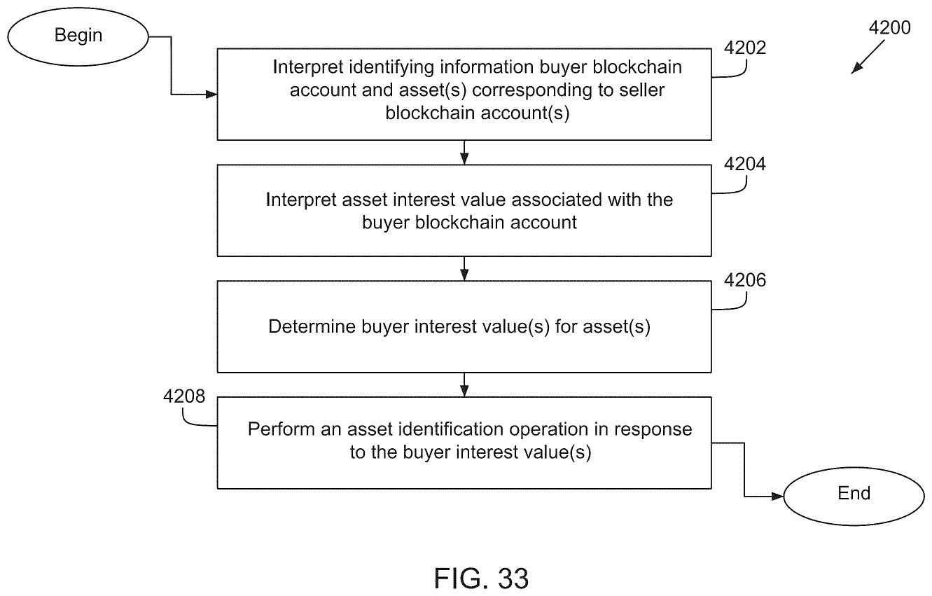

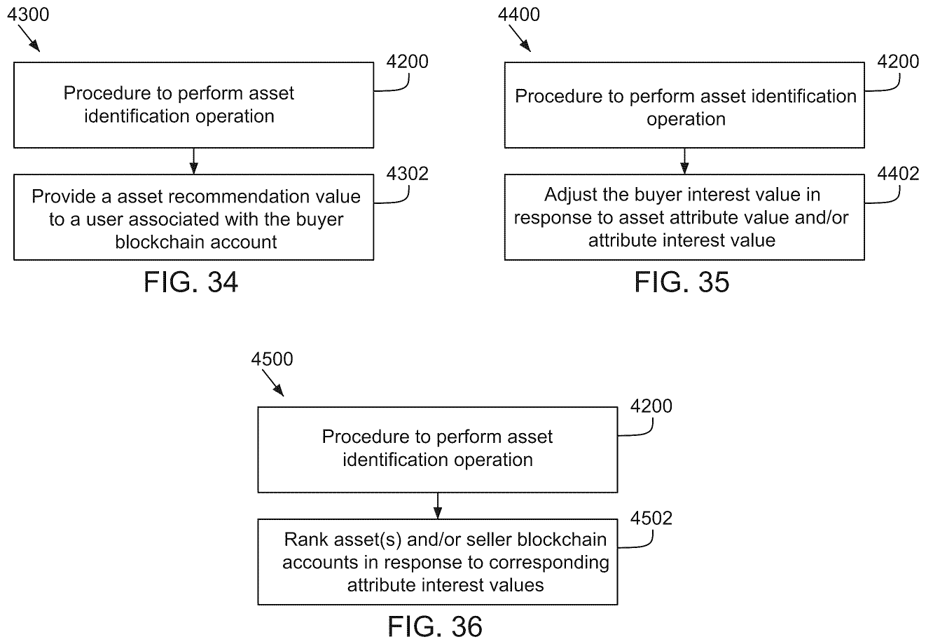

Referencing FIG. 33, an example procedure 4200 for performing an asset identification operation is schematically depicted. The example procedure 4200 includes an operation 4202 to interpret identifying information for a buyer blockchain account and for at least one asset each associated with a corresponding seller blockchain account, the identifying information for each of the at least one asset including an asset attribute value for the corresponding asset. The example procedure 4200 includes an operation 4204 to determine a buyer interest value for each one of the at least one asset in response to each corresponding asset attribute value and the asset interest value, and an operation 4206 to perform an asset identification operation in response to the buyer interest value. Referencing FIG. 34, an example procedure 4300 includes an operation 4302, which may be at least a part of operation 4208, to provide an asset recommendation value to a user associated with the buyer blockchain account. Referencing FIG. 35, an example procedure 4400 includes an operation 4402, which may be at least a part of operation 4208, to adjust the buyer interest value in response to asset attribute value(s) and/or the attribute interest value. Referencing FIG. 36, an example procedure 4500 includes an operation 4502, which may be at least a port of operation 4208, to rank asset(s) and/or seller blockchain account(s) in response to corresponding attribute interest values.

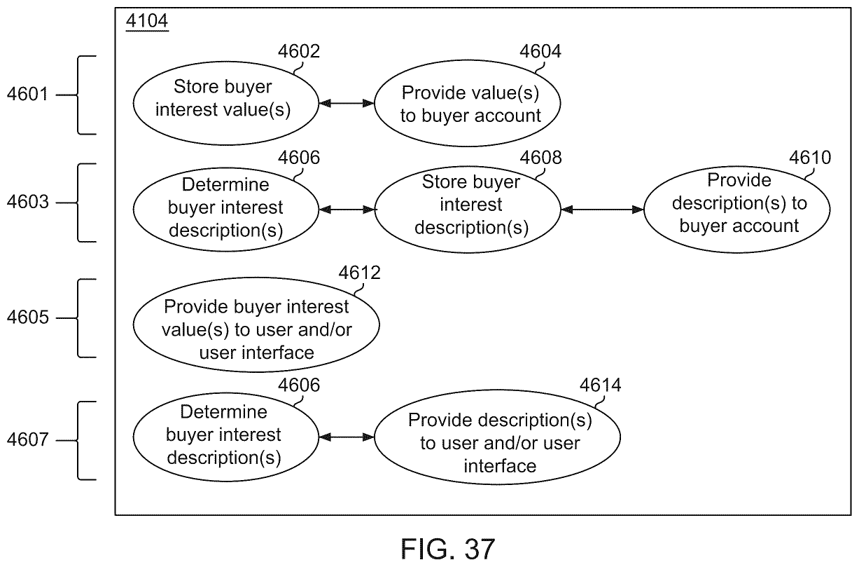

Referencing FIG. 37, example and non-limiting workflows, which may be performed as an asset identification operation 4104, and/or which may be performed as an operation 4208 as a part of a procedure 4200, are schematically depicted. An example workflow 4601 includes an operation 4602 to store buyer interest value(s), and an operation 4604 to provide buyer interest value(s) to a buyer account. An example workflow 4603 includes an operation 4606 to determine buyer interest descriptions, an operation 4608 to store the buyer interest descriptions, and an operation 4610 to provide the buyer interest description(s) to a buyer account. An example workflow 4605 includes an operation 4612 to provide buyer interest value(s) to a user (e.g., a buyer user) and/or to a user interface (e.g., implemented by the controller 200 on a user device). An example workflow 4607 includes the operation 4606, and an operation 4614 to provide buyer interest description(s) to a user and/or to a user interface.

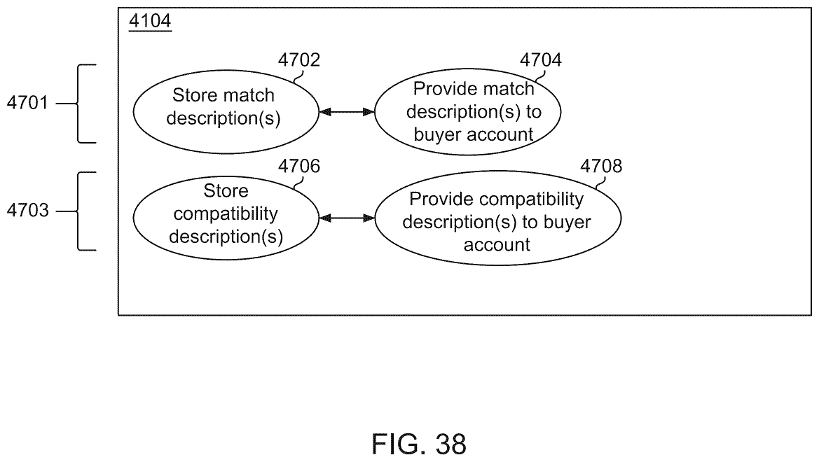

Referencing FIG. 38, example and non-limiting workflows, which may be performed as an asset identification operation 4104, and/or which may be performed as an operation 4208 as a part of a procedure 4200, are schematically depicted. An example workflow 4701 includes an operation 4702 to store match descriptions (e.g., match descriptions determined in response to attribute interest values, and attribute values of considered assets), and an operation 4704 to provide the match descriptions to a buyer account. An example workflow 4703 includes an operation 4706 to store compatibility descriptions (e.g., compatibility descriptions determined in response to attribute interest values, and attribute values of considered assets), and an operation 4708 to provide the compatibility descriptions to a buyer account. In certain embodiments, asset identification operations may include utilization of the match description(s) and/or compatibility description(s) for other purposes, for example in determining whether buyer interest value(s) can be re-utilized for the same or another buyer user (e.g., determining whether the match and/or compatibility information is the same between two separate buyer users, and/or whether an aspect associated with the user has changed such that the match and/or compatibility information has potentially changed), to determine whether a change in identifying information, attribute interest values, and/or attribute values of considered assets have potentially changed the match description and/or compatibility description for the user, and/or whether the buyer interest value(s) should be recalculated and/or adjusted.

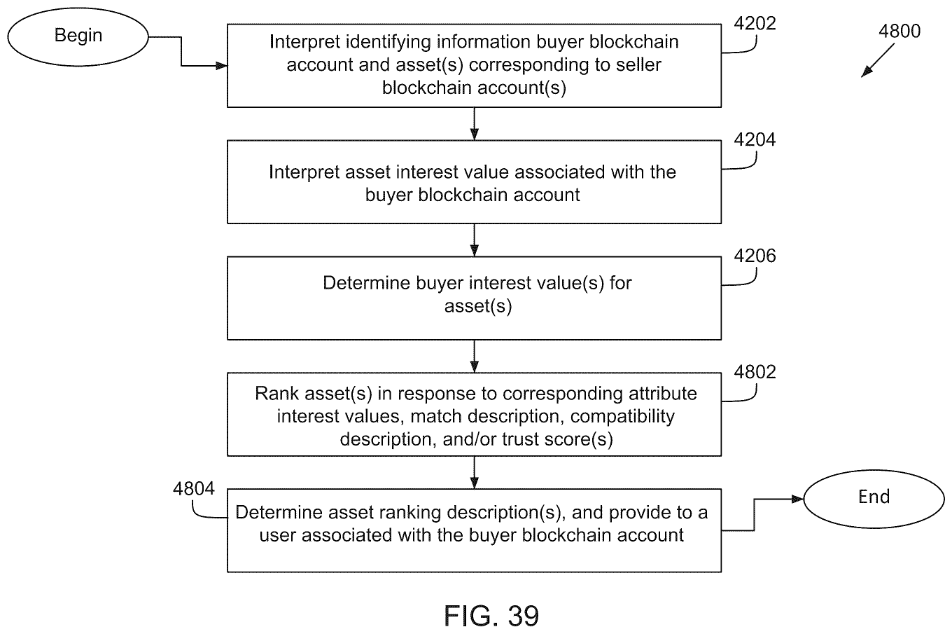

Referencing FIG. 39, an example procedure 4800 for performing an asset identification operation 4104 is schematically depicted. The example procedure 4800 includes operations 4202, 4204, 4206, for example as set forth in relation to FIG. 33. The example procedure 4800 includes an operation 4802 to rank asset(s) in response to the corresponding attribute interest values, asset attribute values, a match description, a compatibility description, and/or trust scores for each asset and/or associated seller account(s). The example procedure 4800 further includes an operation 4804 to determine asset ranking description(s), for example a limited set of the ranked assets, a filtered set of the ranked assets (e.g., with low match or low compatibility assets removed), a ranking with other descriptive information (e.g., notations on deviations from desired attributes, general information of interest such as valuation, author, genre, etc.), and/or ranking according to selected criteria (e.g., ranked by valuation, ranked by match quality, ranked by trust score, etc.).

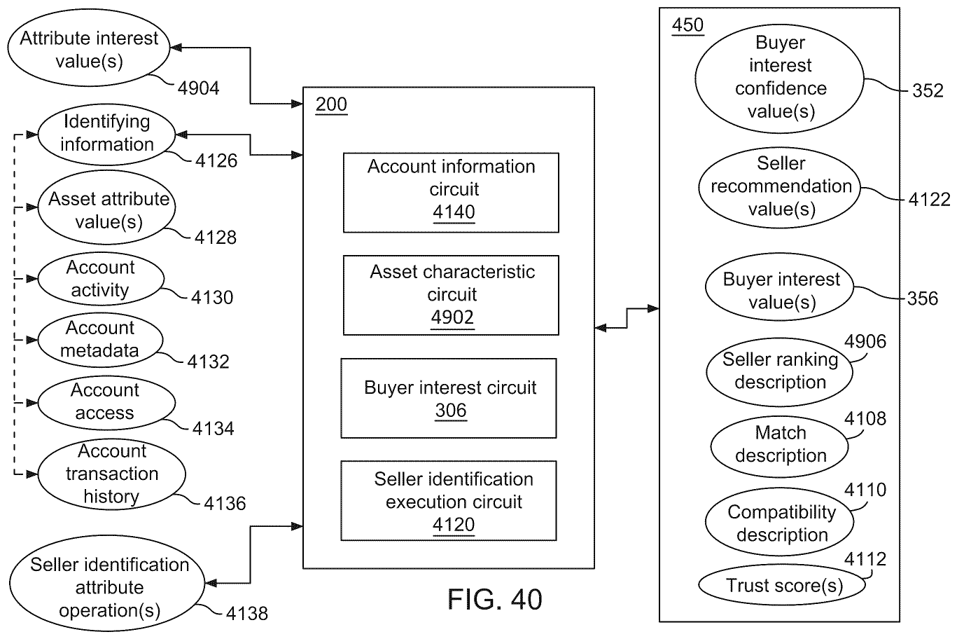

Referencing FIG. 40, an example controller 200 configured to identify seller accounts that may be of interest for a potential buyer, such as a user associated with a buyer account, is schematically depicted. The example controller 200 includes an account information circuit 4140 that interprets identifying information 4126 for a buyer blockchain account and for each one of at least one seller blockchain accounts, the identifying information 4126 for each one of the at least one seller blockchain accounts including an asset attribute value 4128 for one or more assets associated the corresponding seller account. The example controller 200 includes an asset characteristic circuit 4902 that interprets an attribute interest value 4904 associated with the buyer blockchain account, and a buyer interest circuit 306 that determines a buyer interest value 356 for each seller blockchain account in response to each corresponding asset attribute value 4128 and the attribute interest value 4904. The example controller 200 includes a seller identification execution circuit 4120 that performs a seller identification operation 4138 in response to the buyer interest value(s) 356. An example controller 200 accesses a blockchain 450 (or other data structure) including one or more aspects of information such as: buyer interest confidence value(s) 352, seller recommendation value(s) 4122, the buyer interest value(s) 356, a seller ranking description 4906, a match description 4108, a compatibility description 4110, and/or trust score(s) 4112.

An example buyer interest value 356 includes a seller recommendation value 4122, for example including a recommendation of a seller having at least one asset of interest to the buyer user. In certain embodiments, the seller recommendation value 4122 is determined based on the buyer interest value 356, for example based on quality of the match between the attribute interest value 4904 (e.g., setting forth the attributes of interest to the buyer) and asset attribute value(s) 4128 of relevant assets of the seller. In certain embodiments, the seller recommendation value 4122 may be determined from other criteria, for example providing a recommendation for a seller having an asset that is almost as good a match compared to an asset from another seller, but has other desirable characteristics—for example determined from the identifying information 4126 for the seller(s)—such as having a higher trust score 4112, a greater number of assets having a good match (e.g., a seller having three assets with a quality “85” match may be recommended over another seller having a single asset with a quality “90” match), and/or a seller having higher account activity 4130. In certain embodiments, the seller recommendation value(s) 4122, may include multiple sellers, a set number of sellers (e.g., 5 sellers, 10 sellers, 100 sellers, and/or a selected number of sellers), or the like. An example seller identification execution circuit 4120 provides the seller recommendation value 4122 to a user associated with the buyer blockchain account, for example as a seller identification operation 4908.

An example buyer interest circuit 306 adjusts the buyer interest value 356 in response to the attribute interest value 4904 and/or the asset attribute value 4128, for example by updating a stored buyer interest value 356 in response to a significant change in identifying information 4126 for the buyer account and/or a seller account, in response to a change in the attribute interest value 4904, and/or in response to a change in an asset attribute value 4128 for an asset.

An example buyer interest circuit 306 determines a seller ranking description 4906 including a ranking of one or more of the seller blockchain accounts, in response to the corresponding asset attribute values 4128. The seller ranking description 4906 may be stored, provided to the buyer user, utilized to inform information provided to the buyer user (e.g., a list of sellers and/or a list of assets that may be of interest to the buyer user), updated and/or adjusted in response to a significant change in identifying information 4126 for the buyer account and/or a seller account, in response to a change in the attribute interest value 4904, and/or in response to a change in an asset attribute value 4128 for an asset. In certain embodiments, providing the seller ranking description 4906 and/or information provided to the buyer user may be performed by providing the information on a user interface accessed by the buyer user, providing the information in a communication to the buyer user (e.g., as a message, text, e-mail, or the like), and/or providing the information in a location accessible to the buyer user (e.g., stored in a location accessible on an application interfacing with the controller 200, on a web portal, on a mobile application, or the like).

An example buyer interest value 356 includes an identifier of the seller blockchain account(s). An example buyer interest value 356 includes a match description 4108 between the attribute interest value 4904 and the asset attribute value(s) 4128, which may include an indication of matching or non-matching attributes, and/or a matching distance value. An example buyer interest value 356 includes a compatibility description 4110 between the attribute interest value and the asset attribute value(s) 4904, which may include an indication of aspects that are not compatible, and/or may be utilized to remove incompatible assets (and/or sellers having only incompatible assets) from recommendations, lists, and/or rankings of sellers and/or assets.

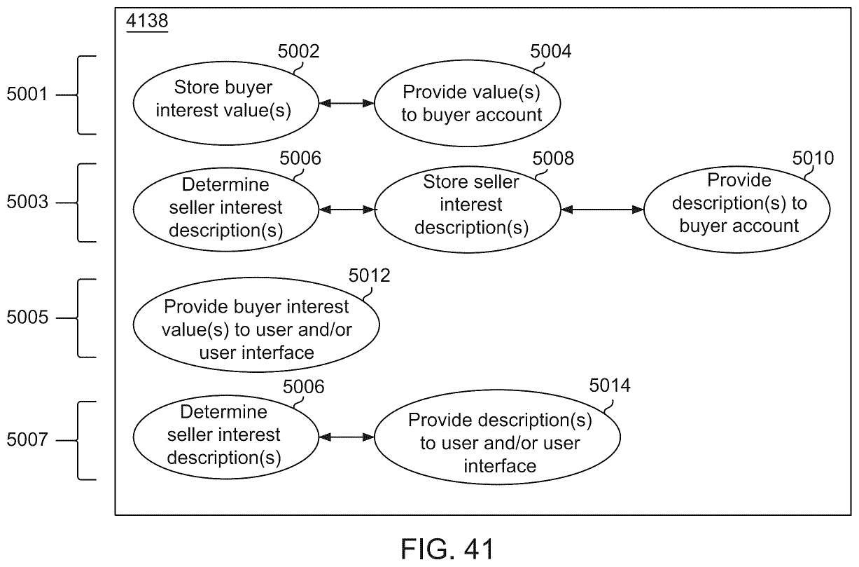

Referencing FIG. 41, example and non-limiting workflows, which may be performed as a seller identification operation 4138, are schematically depicted. An example workflow 5001 includes an operation 5002 to store buyer interest value(s), and an operation 5004 to provide buyer interest value(s) to the buyer account (and/or to a buyer user associated with the buyer account). An example workflow 5003 includes an operation 5006 to determine seller interest description(s)—for example setting forth sellers that, according to the buyer interest value(s), have assets for sale that are of interest to the buyer, an operation 5008 to store the seller interest descriptions, and an operation 5010 to provide the seller interest descriptions to the buyer account (and/or to a buyer user associated with the buyer account). In certain embodiments the seller interest description may include one or more of: a list of sellers of interest to the buyer, a ranking of sellers of interest to the buyer, and/or a seller recommendation value. An example workflow 5005 includes an operation 5012 to provide buyer interest value(s) to the buyer user and/or to a user interface accessible to the buyer user. An example workflow 5007 includes the operation 5006, and an operation 5014 to provide the seller interest descriptions to the buyer account (and/or to a buyer user associated with the buyer account).

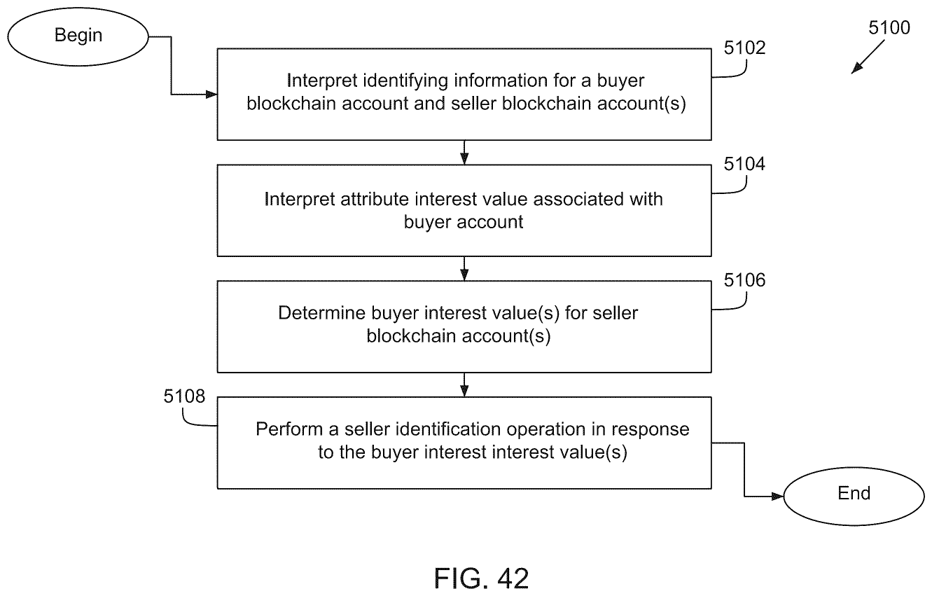

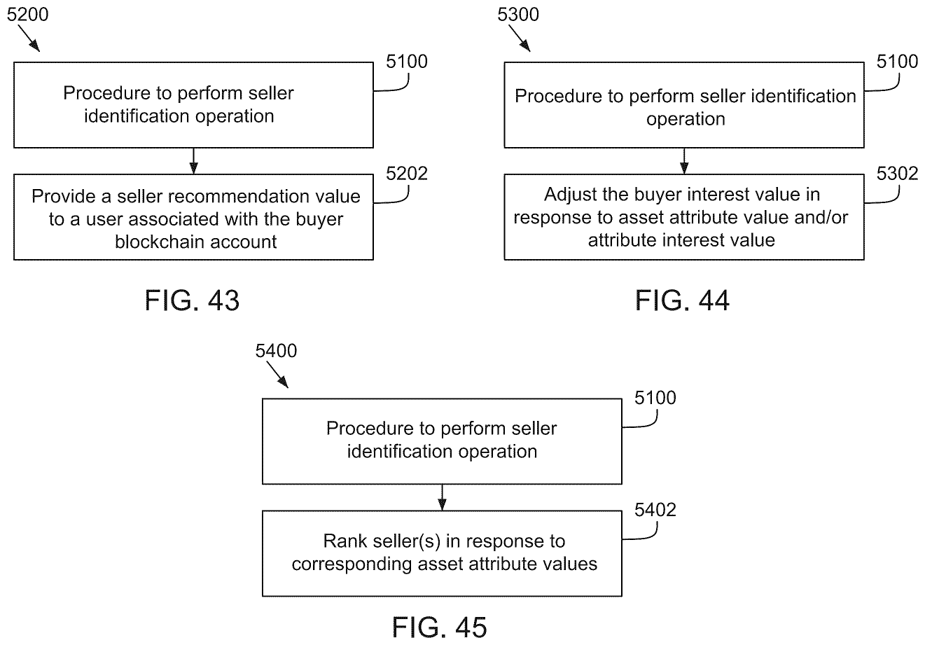

Referencing FIG. 42, an example procedure 5100 for performing a seller identification operation 4908 is schematically depicted. The example procedure 5100 includes an operation 5102 to interpret identifying information for a buyer blockchain account and seller blockchain account(s), an operation 5104 to interpret an attribute interest value associated with the buyer account, and an operation 5106 to determine buyer interest value(s) for the seller blockchain account(s). The example procedure 5100 includes an operation 5108 to perform a seller identification operation in response to the buyer interest value(s). Referencing FIG. 43, an example procedure 5200 includes an operation 5202, which may be at least a part of operation 5108, to provide a seller recommendation value to a user associated with the buyer blockchain account. Referencing FIG. 44, an example procedure 5300 includes an operation 5302, which may be at least a part of operation 5108, to adjust the buyer interest value in response to the asset attribute value and/or attribute interest value. Referencing FIG. 45, an example procedure 5400 includes an operation 5402, which may be at least a part of operation 5108, to rank seller(s) in response to corresponding attribute values (e.g., for assets associated with the respective sellers).

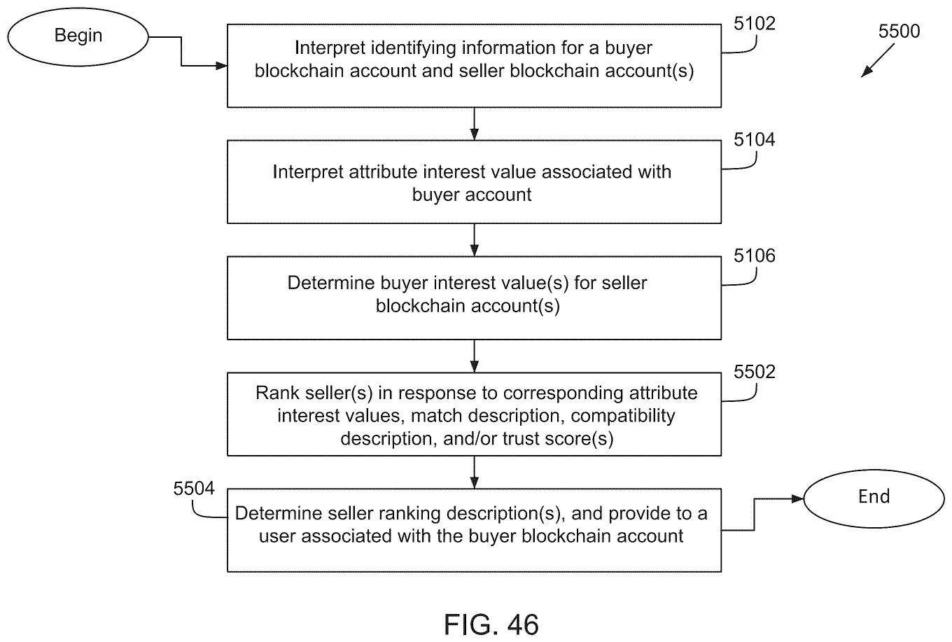

Referencing FIG. 46, an example procedure 5500 for performing a seller identification operation 4908 is schematically depicted. The example procedure 5500 includes operations 5102, 5104, 5106, and further includes an operation 5502 to rank seller(s) in response to corresponding attribute value(s), a match description, a compatibility description, trust scores, and/or the attribute interest value. The example procedure 5500 further includes an operation 5504 to determine seller ranking description(s), and to provide the seller ranking description(s) to a user and/or to a user interface accessible to the user (e.g., the buyer user) associated with the buyer blockchain account.

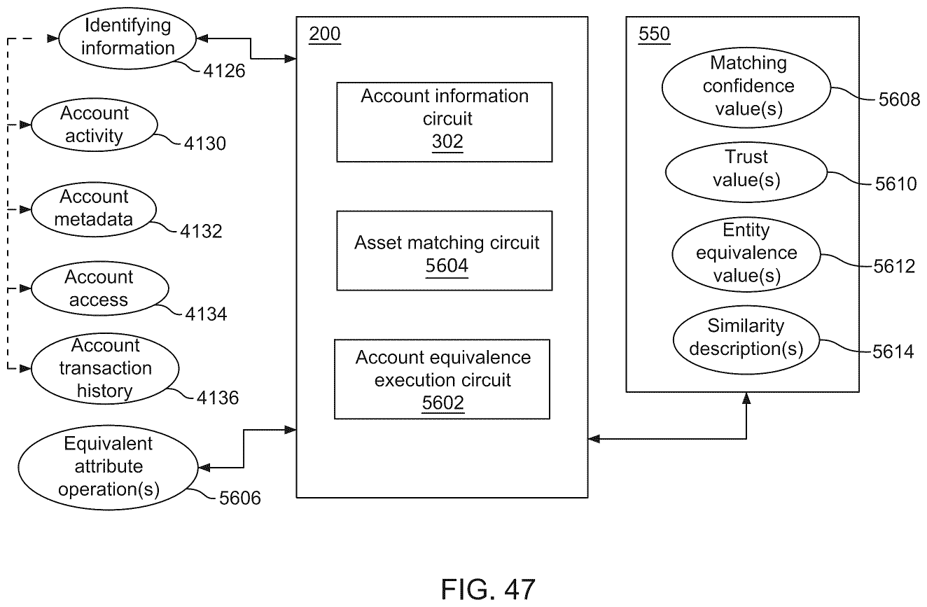

Referencing FIG. 47, an example controller 200 configured to identify equivalences between blockchain accounts and/or wallets, including separate wallets on a single blockchain, and/or wallets on two or more distinct blockchains, is schematically depicted. Without limitation to any other aspect of the present disclosure, an account may represent a single user access element, for example an account having a username, password, and/or other accessing information that is exercised on an interface to a blockchain allowing the user to perform transactions or other activity on the blockchain. A wallet may represent an account, and/or more than one account, including potentially accounts on more than one blockchain. In certain embodiments, a wallet and an account may reference the same concept. In certain embodiments, a wallet may be an organizing application, for example as provided by a service provider, to facilitate access and security for a user to one or more accounts. The example controller 200 includes an account information circuit 302 that interpret identifying information 4126 for each blockchain account and/or wallet, for example for a first blockchain account and for a second blockchain account. Example and non-limiting identifying information 4126 includes one or more of account activity 4130, account metadata 4132, account access 4134 information, and/or account transaction history 4136. Aspects of the identifying information 4126 may include any aspects of identifying information as set forth throughout the present disclosure.

The example controller 200 includes an account matching circuit 5604 that determines an entity equivalence value 5612 in response to the identifying information 4126 for each of the wallets and/or blockchain accounts. Without limitation to any other aspect of the present disclosure, the entity equivalence value 5612 includes an indication, which may be qualitative (e.g., categorical descriptions such as “collector.” “investor,” etc.), and/or quantitative descriptions (e.g., a trust score, account value, transaction value, index value for any aspect herein, or the like, and/or statistical descriptions of any one or more of these such as averages, distribution descriptions, maximum values, minimum values, or the like), for example indicating whether the wallets and/or blockchain accounts are equivalents (e.g., sharing an identity, such as the same user or beneficial owner; sharing a same value for one or more aspects of the identifying information such as activity, access values, metadata, transaction types, transaction values, etc.; and/or sharing a functionally equivalent value such as a same categorical description, having an aspect of the identifying information exceeding a specified threshold, etc.), and/or that the one or more aspects of the identifying information are sufficiently close to be treated as equivalent for the purpose of equivalent attribute operations 5606 of the account equivalence execution circuit 5602. The content of the equivalence value(s) 5612, the aspects compared to determine the equivalence value(s) 5612, and/or the utilization of the equivalence value(s) 5612 for equivalent attribute operation(s) 5606 will vary depending upon the purpose for determining equivalence of accounts/wallets and/or aspects thereof. For example, where the equivalent attribute operation 5606 includes an operation dependent upon the accounts/wallets being held by the same user and/or beneficial owner, the equivalence value(s) 5612 utilized will be values tending to indicate that the accounts/wallets are held by the same user, for example: the type and value of transactions; transaction frequencies; metadata such as time stamps, comment styles, language utilization, or the like; access information such as accessing time of day, calendar date patterns, day of the week patters, IP addresses utilized for access, or the like; and/or the types, values, and/or distribution of assets held. In certain embodiments, parameters may contribute to determination of the equivalence value 5612, such as: a weighted equivalence determination (e.g., several aspects compared, with some aspects having a higher contribution to the determination); a heuristic equivalence determination (e.g., utilization in a formula, expert system model, or the like); parameters may contribute to a confirmation determination (e.g., parameters that, alone, do not necessarily indicate equivalence, but are expected to be similar if the equivalence is actually correct, for example the accounts/wallets both having assets of expected types, genres, and/or other characteristics, and/or a confirmation that the identifying information does not make the equivalence highly unlikely to be correct—for example an account having a highly distinct IP address utilized for access, having a transaction with a high value on one account that is inconsistent with transactions on the other account, etc.); and/or parameters may contribute to a confidence determination (e.g., utilizing similar parameters as set forth throughout the present disclosure, where continued consistency in the parameters may be utilized to increment and/or determine a confidence value, and/or where inconsistent parameters may be utilized to decrement and/or determine the confidence value). In certain embodiments, a confidence value may be utilized with the equivalence value 5612, and/or may embody a part of the equivalence value 5612, which may further depend upon the specific equivalent attribute operation 5606 being performed. For example, where the specific identity of the user and/or beneficial user is important to the equivalent attribute operation 5606 being performed, a first threshold (e.g., a high value) for the confidence value may be utilized by such operations, where a different equivalent attribute operation 5606 utilizes a second threshold for the confidence value (e.g., a determination of whether both accounts are a good match as appropriate buyers or sellers for assets of interest).

One of skill in the art, having the benefit of the present disclosure, can readily determine the type and content of equivalence value(s) 5612, including whether a confidence determination and/or confirmation determination is included with and/or utilized with the equivalence value(s) 5612 for embodiments herein. Certain considerations for determining the type and/or content of equivalence value(s) 5612 include, without limitation: the type of activity performed by the equivalent attribute operation 5606; the consequences of a false positive and/or false negative determination for the equivalence value 5612 for the equivalent attribute operation 5606; the consequences of a false positive and/or false negative determination for the equivalence value 5612 for a user dependence upon the equivalence value 5612 and/or the related equivalent attribute operation 5606; the availability, resolution, reliability, and/or sampling rate of identifying information 4126 utilized to determine the equivalence value 5612; and/or the reason for determining whether the accounts/wallets and/or aspects thereof are equivalents (e.g., determining common entities, comparing and/or synchronizing trust scores, finding appropriate buyer and/or seller targets, finding appropriate content creator targets, etc.).

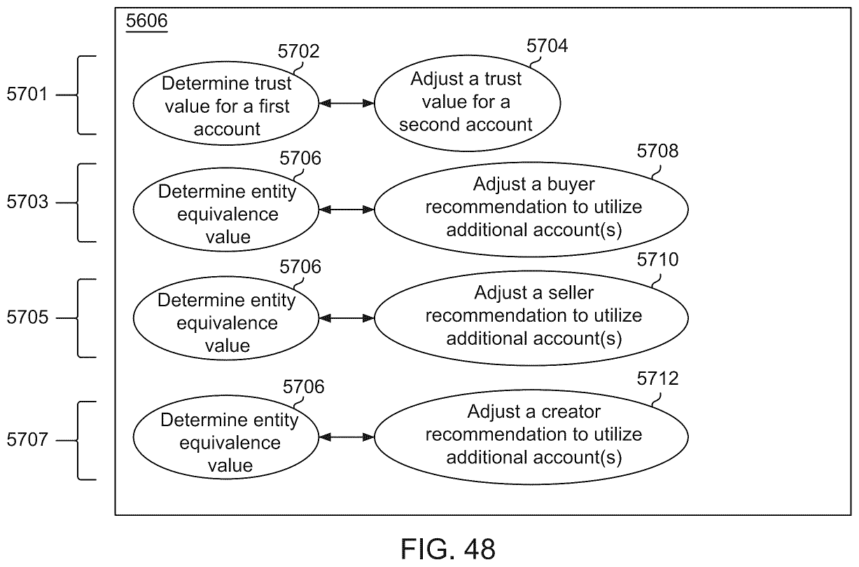

Referencing FIG. 48, example and non-limiting workflows, which may be performed as an equivalent attribute operation 5606, are schematically depicted. An example workflow 5701 includes the account equivalence execution circuit 5602 performing an operation 5702 to determine a first trust value 5610 for the first blockchain account, and an operation 5704 to adjust a second trust value 5610 for the second blockchain account in response to the first trust value 5610. For example, the operation 5704 may include averaging the trust values, utilizing a lower one of the trust values (e.g., limiting the trust of the equivalent accounts/wallets to the lower trust value), utilizing another function to mix the trust values (e.g., weighted according to the information from each account, for example utilizing more of the trust value from an account that is older, has more transactions, has higher confidence information built into the trust value, etc.), and/or performing a dynamic mixing of the trust values (e.g., utilizing a low pass filter, moving average, increment/decrement scheme, etc., to mix the trust values). In certain embodiments, both trust scores may be adjusted in response to the other trust score(s) and the equivalence value(s) 5612. In certain embodiments, the original and/or unadjusted trust score is also stored, for example to allow independent adjustment of the original trust score based on transactions or other activity with the associated account for the trust score, and/or to allow for the trust scores to be de-coupled in later operations—for example where the equivalence value 5612 is updated at a later time indicating that the equivalence was not properly made and/or has changed over time. In certain embodiments, other processing for the trust score adjustment may be applied, including operations such as, without limitation: resetting the trust score(s) (e.g., due to a large change in one or more of the underlying trust scores; in response to a high confidence trust score event; in response to a change in confidence of the equivalence value 5612, such as a confidence change indicating the equivalence determination is much more likely to be correct or incorrect than at a previous time; and/or in response to a change in the purpose of the equivalence determination); applying a hysteresis to trust score changes (e.g., applying a delay or rate change in trust score adjustment where the direction of the adjustment reverses, for example to reduce dithering the trust score and/or other potential instability); applying a rate limit to trust score adjustments; and/or adjusting a gain of trust score adjustments (e.g., increasing or decreasing a scale factor for increment or decrement operations, and/or adjusting a filter time constant for adjustment operations, for example allowing the rate of adjustment to vary based on confidence, continuing determinations confirming that the adjustments are going in the correct direction, etc.).

An example workflow 5703 includes an operation 5706 to determine an entity equivalence value between at least two wallets/accounts, and an operation 5708 to adjust a buyer recommendation—for example to add additional accounts to a buyer recommendation and/or remove accounts from the buyer recommendation. For example, a user accessing the controller 200 to get buyer recommendations for a particular asset and/or a prospective asset (e.g., an asset the user is contemplating for creation and/or acquisition) may get a buyer recommendation (e.g., reference FIG. 22), where the operation 5706 determines the entity equivalence value (e.g., as an initial determination and/or an update), and the operation 5708 adds one or more accounts/wallets (e.g., based on those accounts/wallets having a same beneficial owner, and/or equivalent relevant aspects, as an account/wallet already in the buyer recommendation), and/or removes one or more accounts/wallets (e.g., where one or more accounts/wallets are included in the buyer recommendation due to an equivalence determination, where a change to the equivalence determination and/or a confidence thereof indicates that the equivalence is no longer present and/or was not properly determined).

An example workflow 5705 includes operation 5706, and an operation 5710 to adjust a seller recommendation to add additional accounts to the seller recommendation and/or remove accounts from the seller recommendation. For example, a user accessing the controller 200 to get seller recommendations for a particular asset and/or a prospective asset (e.g., where the user is contemplating acquisition of a particular asset, asset type, asset genre, etc.). In certain embodiments, operation 5710 to add or remove accounts/wallets to a seller recommendation operates on similar principles to operation 5708 to add or remove accounts/wallets to a buyer recommendation.

An example workflow 5707 includes operation 5706, and an operation 5712 to adjust a creator recommendation, for example accounts/wallets tending to hold and/or sell assets created by certain authors, associated with a particular collection, and/or accounts/wallets that are identified as gatekeepers and/or initial offering accounts for these. In certain embodiments, a creator recommendation provides accounts/wallets for the user to contact for particular assets, to request assets having selected characteristics, and/or to watch for the availability of these. In certain embodiments, operation 5712 to add or remove accounts/wallets to a creator recommendation operates on similar principles to operation 5708 to add or remove accounts/wallets to a buyer recommendation.

In certain embodiments, the account matching circuit 5604 determines a similarity description(s) 5614 in response to the identifying information 4126. An example account matching circuit 5604 determines the entity equivalence value 5612 in response to the similarity description 5614 (e.g., utilizing the similarity description to determine confidence in the equivalence, as a part of the equivalence value, and/or to confirm the equivalence), and/or includes all or a part of the similarity description 5614 in the entity equivalence value 5612 (e.g., allowing certain operations 5606 to differentiate utilization of the equivalence value 5612 for different purposes—such as differentiating between equivalents for buyer determinations and seller determinations, and/or to adjust operations such as the rate of trust score adjustment).

In certain embodiments, the account matching circuit 5604 determines a matching confidence value 5608, for example a confidence value for any aspect utilized to determine the entity equivalence value 5612 (e.g., a confidence that the information is correctly determined or collected, a confidence that the aspects are a match or not a match between the wallets/accounts, etc.), and determines the entity equivalence value 5612 in response to the matching confidence value 5608. In certain embodiments, the account matching circuit 5604 includes all or a part of the matching confidence value 5608 in the entity equivalence value 5612.

An example account matching circuit 5604 determines the matching confidence value 5608 by determining source matching information corresponding to each of the first blockchain account and the second blockchain account, where source matching information includes, without limitation, information tending to demonstrate the beneficial owner and/or associated user of each blockchain account, such as access patterns, access locations, applications used for access (e.g., mobile application, web portal, web browser, versions of these, etc.), access identifiers (e.g., device MAC addresses or identifiers, IP addresses, etc.), transactions and/or transaction patterns, and/or asset holdings (e.g., asset types, genres, values, etc.). The source matching information may be utilized to determine the entity equivalence value 5612, as part of a confidence and/or confirmation determination, and/or included as a part of the entity equivalence value 5612. In certain embodiments, multiple source matching information options may be available on the data structure 550, for example with several groups different groups of identifying information 4126, any one of which may be predictive of the equivalence, and/or the groups may be predictive based on other parameters. The data structure 550 may be a separate blockchain, a relational database, or any other data structure as set forth throughout the present disclosure, and/or may further include an indexed data structure. In a first example, other parameters may include the blockchains involved with the accounts, e.g., accounts across blockchains A-B may be well predicted by source matching information group C, where accounts across blockchains F-G may be well predicted by source matching information group D, where source matching information groups C and D may have a distinct overall basket of identifying information 4126 aspects. In a second example, other parameters may include any identifying information, for example accounts accessing blockchains from a first geographic region may be well predicted by source matching information group X, and accounts accessing blockchains from a second geographic region may be well predicted by source matching information group Y (e.g., due to distinct usage patterns, user device types, accessing application types, etc. in those regions). In certain embodiments, the source matching information allows for iterative improvement operations for equivalence determinations (e.g., determining which information provides a strong signal for entity equivalence determination), and/or streamlines equivalence determinations (e.g., accounts may be quickly determined to be equivalent based on a group of parameters represented in the source matching information).

An example account matching circuit 5604 determines the matching confidence value 5608 by determining transaction matching information corresponding to each of the first blockchain account and the second blockchain account, where transaction matching information includes, without limitation, transaction value, smart contract types and/or versions utilized for transactions, transaction time of day, transaction frequency, transaction sequencing (e.g., grouping and occurrence, such as Poisson distribution modeling parameters indicated by the transactions on the account), and/or transaction asset values (e.g., asset values, types, and/or genres). The transaction matching information may be utilized to determine the entity equivalence value 5612, as part of a confidence and/or confirmation determination, and/or included as a part of the entity equivalence value 5612. In certain embodiments, multiple transaction matching information options may be available on the data structure 550, for example with several groups different groups of identifying information 4126, any one of which may be predictive of the equivalence, and/or the groups may be predictive based on other parameters, for example as set forth in regard to the source matching information.

An example account matching circuit 5604 determines the matching confidence value 5608 by determining portfolio matching information corresponding to each of the first blockchain account and the second blockchain account, where portfolio matching information includes, without limitation, asset types for the account, asset genres for the account, and/or asset values for the account (e.g., individual assets, asset total value, and/or statistical descriptions of the asset value), and/or a trajectory of these over time (e.g., two accounts having a similar portfolio mix, and evolution of the portfolio mix over time, are more likely to be equivalent—for account ownership purposes—than two accounts having only a similar portfolio mix). The portfolio matching information may be utilized to determine the entity equivalence value 5612, as part of a confidence and/or confirmation determination, and/or included as a part of the entity equivalence value 5612. In certain embodiments, multiple portfolio matching information options may be available on the data structure 550, for example with several groups different groups of identifying information 4126, any one of which may be predictive of the equivalence, and/or the groups may be predictive based on other parameters, for example as set forth in regard to the source matching information.

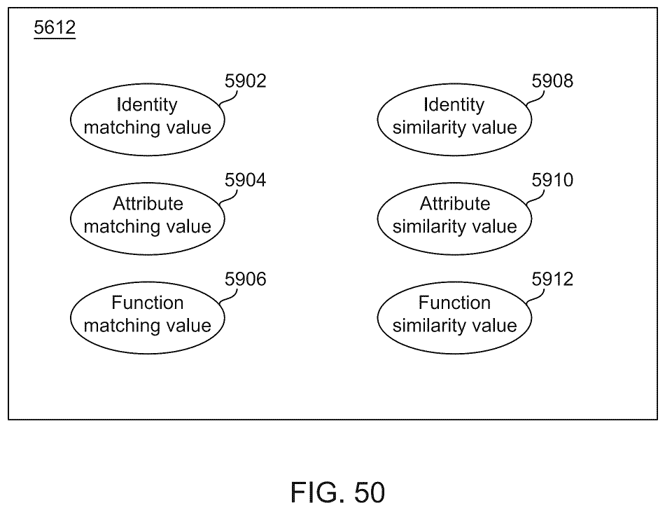

Referencing FIG. 50, example and non-limiting entity equivalence value(s) 5612 are schematically depicted. An example entity equivalence value 5612 includes, without limitation: an identity matching value 5902 (e.g., indicating whether the wallets/accounts have a same associated user and/or beneficial owner); at attribute matching value 5904 (e.g., indicating whether an attribute of the wallets/accounts are equivalent, such as asset value(s), portfolio description(s), transaction parameters, etc.); a function matching value 5906 (e.g., indicating whether the wallets/accounts are equivalent for a purpose, such as being appropriate buyers or sellers for particular assets, perform transactions within a value range, access the blockchain(s) at an equivalent time and/or frequency, etc.); identity similarity value(s) 5908 (e.g., if the wallets/accounts have an identity similarity, such as investor class, collector class, etc.); attribute similarity value(s) 5910 (e.g., if an attribute of the wallets/accounts have a similarity, such as transaction types, asset tastes, asset holding time, etc.); and/or a function similarity value(s) 5912 (e.g., indicating whether the wallets/accounts are similar for a purpose).

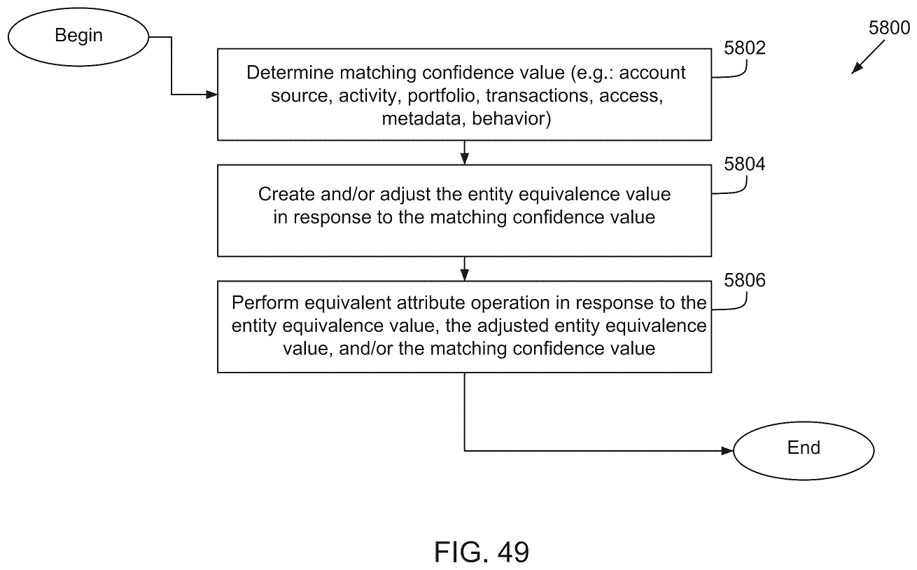

Referencing FIG. 49, an example procedure 5800 for performing an equivalent attribute operation is schematically depicted. The example procedure 5800 includes an operation 5802 to determine a matching confidence value, and an operation 5804 to adjust an entity equivalence value in response to the matching confidence value. In certain embodiments, operation 5802 may additionally or alternatively include determining trust score(s), transaction matching information, behavior matching information (e.g., access behavior, transaction behavior, asset related behavior, etc., for the wallets/accounts), portfolio matching information, and/or source matching information. The example procedure 5800 further includes an operation 5806 to perform an equivalent attribute operation in response to the adjusted entity equivalence value, and/or further in response to the matching confidence value.

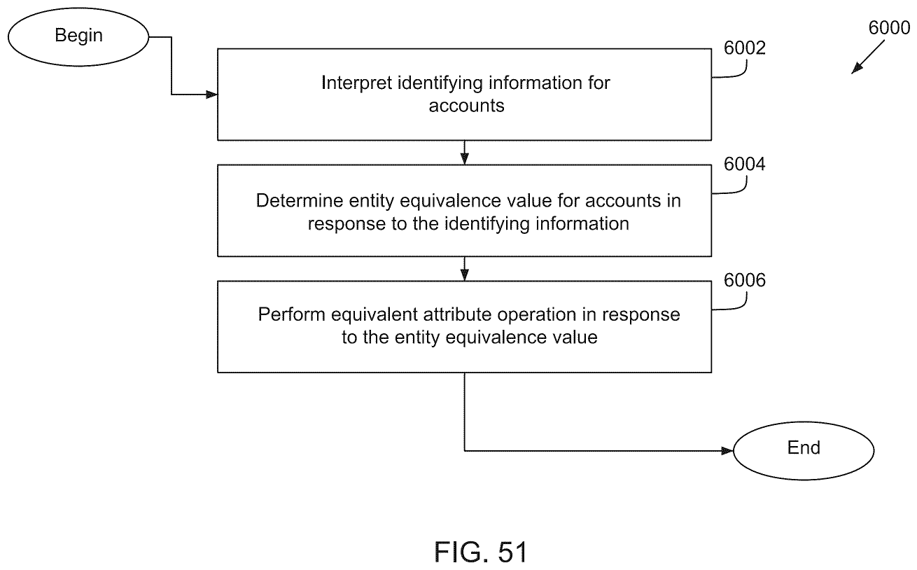

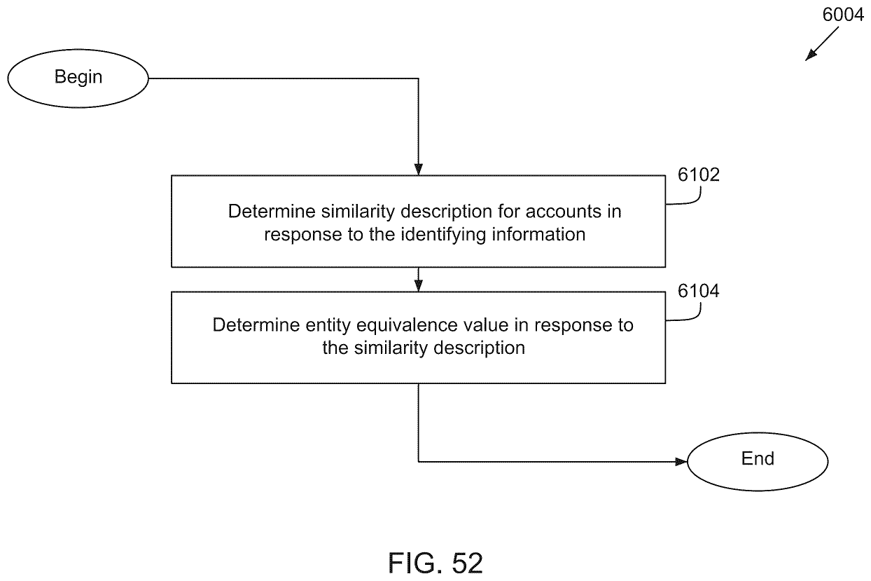

Referencing FIG. 51, and example procedure 6000 for performing an equivalent attribute operation is schematically depicted. The example procedure 6000 includes an operation 6002 to interpret identifying information for two or more wallets/accounts, and an operation 6004 to determine an equivalence value for the wallets/accounts in response to the identifying information. The example procedure 6000 further includes an operation 6006 to perform an equivalent attribute operation in response to the entity equivalence value. Procedures 5800, 6000 may be combined, in whole or part, and/or may be performed by any controller, circuit, processor, computing device, or the like, as set forth throughout the present disclosure. Referencing FIG. 52, an example procedure, for example embodying all or a part of operation 6004, includes an operation 6102 to determine a similarity description for wallets/accounts in response to the corresponding identifying information, and an operation 6104 to determine an entity equivalence value in response to the similarity description. In certain embodiments, operation 6102 may additionally or alternatively include determining trust score(s), transaction information, behavior information (e.g., access behavior, transaction behavior, asset related behavior, etc., for the wallets/accounts), portfolio information, and/or source information. In certain embodiments, operations of a procedure, such as procedures 5800, 6000, include performing the equivalent attribute operation by performing, in whole or part, including any workflows set forth herein such as depicted in FIG. 48.

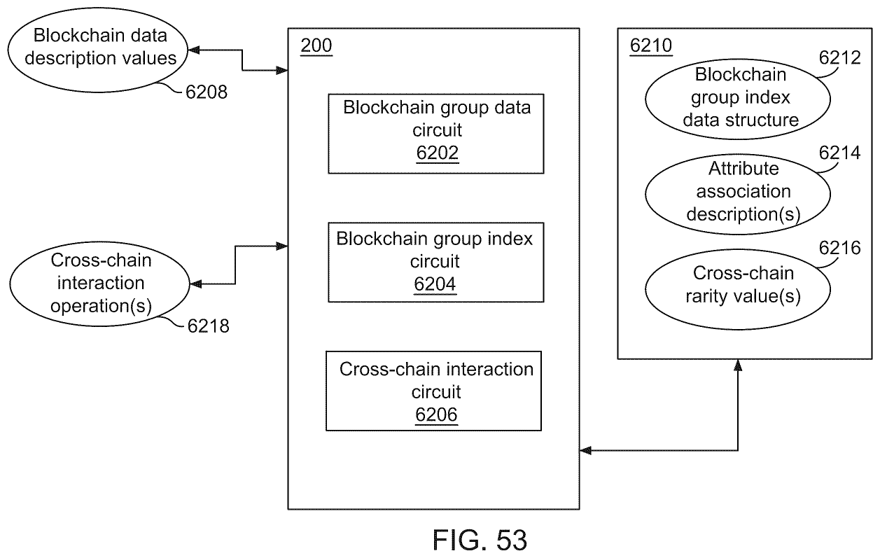

Referencing FIG. 53, an example controller 200 configured to identify equivalences between entities across blockchains, and to perform cross-chain interaction operations, is schematically depicted. The example controller 200 includes a blockchain group data circuit 6202 that interprets a number of blockchain description values 6208, each corresponding to at least one of the number of blockchains accessible to, and within the scope of operations of, the controller 200. Example blockchain description values 6208 include one or more data structures, such as data structures 3006, 350, 450, 550 and/or any aspects thereof. Example blockchain description values 6208 include, without limitation, trust scores, equivalence values, identifying information, matching values, confidence values, similarity values, transaction information, asset information, and/or portfolio information for any entity on any blockchain of interest. The example controller 200 further includes a blockchain group index circuit 6204 that provides a blockchain group index data structure 6212 in response to the plurality of blockchain description values 6208, for example allowing rapid organization, searching, and/or sorting for parameters of interest, including trust score determinations, equivalence determinations, and/or attribute determinations for any entity or group of entities of interest. The blockchain group index data structure 6212 may be a separate data structure, such as stored on a blockchain data structure 6210, and/or may be stored with any of the underlying data structures 3006, 350, 450, 550, 7550 described throughout the present disclosure. The blockchain group index data structure 6212 may be any type of data structure, and/or may be a separate and/or dedicated blockchain 6210. An example blockchain group index data structure 6212 includes an attribute association description 6214, such as an identified attribute value (e.g., asset holdings of greater than $10,000 held in “Gothic Art” assets), a first association of the identified attribute value to a first entity associated with a first blockchain, and a second association of the identified attribute value to a second entity associated with a second blockchain—for example allowing for a cross-chain equivalence and/or similarity determination to be made between the first entity and the second entity.

In certain embodiments, the first entity and second entity may be on separate blockchains, allowing for comparisons and operations not available in previously known systems, and/or allowing the user to get better results (e.g., in finding assets, matching buyers, matching sellers, etc.) by facilitating connections between the users and a larger corpus of buyers, sellers, and assets than previously available. In certain embodiments, the first entity and the second entity may be on a same blockchain, for example allowing the user to be agnostic to the actual blockchain where the potential transaction occurs. In certain embodiments, in addition to better results, the user also benefits from increased confidence that the transaction was desirable, as the user has benefitted from a larger data set to ensure that attributes (e.g., pricing, valuation, genre, characteristics, etc.) of the transaction, related entities, and/or related assets, are closer to an optimal, and that the attribute information is based on a larger, and thus statistically more confident, data set. Additionally, trust information utilized to execute transactions and recommendations, whether communicated directly to the user or not, are based on a larger corpus of data (e.g., evaluating the trust score for an entity based on a greater number of transactions and/or other identifying information), making the trust evaluation statistically more confident, and further putting the trust evaluation for an entity into a comparison with a larger number of offset entities, making a comparative trust determination also with greater confidence. The user will be able to directly see the improved trust information, providing immediate feedback about the improved confidence for the transaction, and/or the user will benefit from the improved trust information, even if not explicitly shown to the user, over time as transactions are performed and the user more reliably gets the desired outcomes, builds the desired asset portfolio, improves sales performance, or the like. In addition to the benefit the user gets by having immediate confidence that transactions are beneficial to the user's goals, the user gets the benefit of reduced time searching before performing a transaction (e.g., by otherwise performing multiple searches to confirm that expected results are close to the optimal), reduced complexity in searching and attempting to compare results across multiple blockchains, and/or reduction in the number of interactions to reach or evaluate an entire group (e.g., embodiments of the present disclosure can reduce redundant evaluations by grouping other entities that share an identity—e.g., where those entities are actually the same entity having multiple wallets/accounts; eliminating entities from the evaluation that have a modest match to desired criteria, but are actually not a match at all based on attributes that are not apparent to the user without deeper evaluation that can be time consuming; and/or by quickly determining matching entities, for example from a blockchain that the user is not familiar with, and therefore would likely not be evaluated by the user at all due to the time required to find and evaluate those entities).

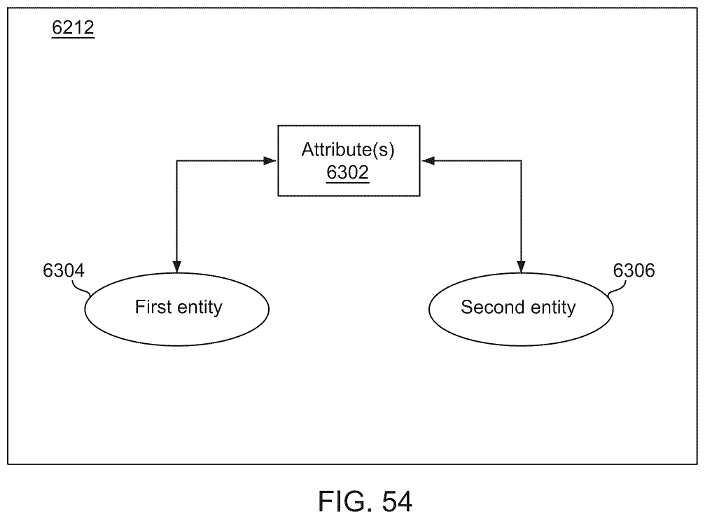

An example blockchain group index data structure 6212 includes an attribute association description 6214. In certain embodiments, the attribute association description 6214 captures aspects between the first entity and the second entity that indicate whether the entities are equivalents and/or that are similar, including an indication of aspects that are equivalent/similar and/or aspects that are not equivalent/similar. An example attribute association description 6214 includes an identified attribute value, a first association of the identified attribute value to a first entity associated with a first blockchain of the plurality of blockchains, and a second association of the identified attribute value to a second entity associated with a second blockchain of the plurality of blockchains. Accordingly, the attribute association description 6214 includes information that can be utilized to determine equivalence values, utilized in various equivalence based operations as set forth throughout the present disclosure (e.g., buyer identification attribute operations 340, seller identification attribute operations 4138, asset identification operations 4104, equivalent attribute operations 5606, account trust operations 7508, equivalent asset operations 7912, and/or cross-chain interaction operations 6218), including, for example, allowing operations to treat the entities as equivalents for some purposes, and not as equivalents for other purposes. The blockchain group index data structure 6212 allows embodiments throughout the present disclosure to perform operations across blockchains, with or without the underlying controllers, procedures, circuits, operations, computing devices, or the like, having awareness that the entities are associated with distinct blockchains, and/or allowing such operations to be agnostic to the distribution of entities across blockchains. Referencing FIG. 54, an example blockchain group index data structure 6212 is schematically depicted, having an attribute 6302 associated with a first entity 6304 and a second entity 6306, where the entities 6304, 6306 associated with distinct blockchains, or on the same blockchain. The example of FIG. 54 depicts an example relationship, but the organization depicted is not limited, and may be indexed by entity, attribute, and/or a flexible indexing that can be adapted according to selected search criteria, or the like. Each one of the entities 6304, 6306 may be any type of entity as set forth throughout the present disclosure, including at least an account, a wallet, a user identifier (e.g., abstracting the underlying beneficial owner from the related account and/or wallet, and/or an identifier to a user accessing the controller with a user device), an asset, a token (e.g., a fungible token, semi-fungible token, and/or non-fungible token), and/or a contract (e.g., identifying a smart contract, smart contract type, smart contract version, or the like, as an entity allowing for equivalence determinations, tracking attributes for the contract, ranking of the contract, or the like).

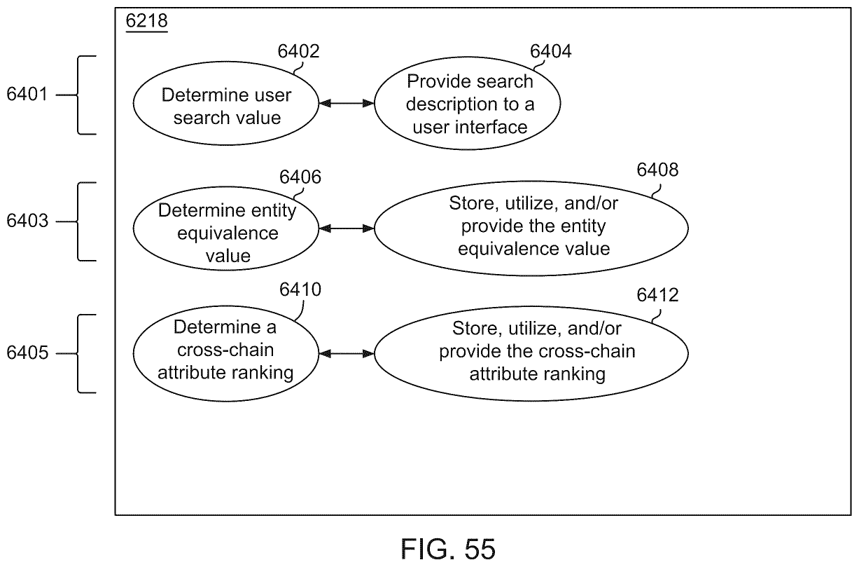

The example controller 200 includes a cross-chain interaction circuit 6206 that performs a cross-chain interaction operation 6218 in response to the blockchain group index data structure 6212. Referencing FIG. 55, example and non-limiting workflows, which may be performed as a cross-chain interaction operation 6218, are schematically depicted. An example workflow 6401 includes an operation 6402 to determine a user search value (e.g., the user requesting a search on assets having certain attributes, a search for appropriate sellers, a search for appropriate buyers, etc.), and an operation 6404 to provide a search description (e.g., results for the search, which includes consideration of entities from across more than one blockchain) to a user interface (e.g., in a window of an application on the user device that is configured to interact with the controller 200). In certain embodiments, operation 6404 may be provided as a result of the search, and/or may be updated in real time (e.g., as aspects of entities on the blockchain(s) change, where results may be updated without the user performing additional searches, in response to a refresh request by the user, and/or as an automated refresh operation by the cross-chain interaction circuit 6206).

An example workflow 6403 includes an operation 6406 to determine an entity equivalence value (e.g., an equivalence value determined for entities that are distributed across more than one blockchain), and an operation 6408 to store (e.g., for later usage in response to a search request from the user, an equivalence operation where one or more of the entities are in scope for the equivalence operation, or the like), utilize (e.g., where operation 6406 is performed in response to an active equivalence operation where one or more of the entities are in scope for the equivalence operation, in response to an active search request by a user, or the like), and/or provide (e.g., to a user, and/or to a requesting circuit, controller, and/or computing device) the entity equivalence value(s). The operations of workflow 6403 allow for the cross-chain interaction circuit 6206 to respond to active requests, equivalence operations, and/or searches, as well as to pre-populate entity equivalence value(s) (e.g., for commonly used search criteria) to improve response times of the controller 200 during future servicing of searches, equivalence operations, or the like.

An example workflow 6405 includes an operation 6410 to determine a cross-chain attribute ranking (e.g., ranking attributes for any entity, including accounts/wallets, assets, or the like, where the ranking may be made with regard to any attribute of interest, such as trust scores, transaction response time, activity frequency, value, projected value, liquidity, representation of asset types, representation of asset genres, representation of asset characteristics, and/or ranking of any other attribute, identifying information, or other characteristics as set forth throughout the present disclosure). The example workflow 6405 further includes an operation 6412 to store (e.g., for later usage in response to a search request from the user, an equivalence operation where one or more of the entities are in scope for the equivalence operation, or the like), utilize (e.g., where operation 6410 is performed in response to an active equivalence operation where one or more of the entities are in scope for the equivalence operation, in response to an active search request by a user, or the like), and/or provide (e.g., to a user, and/or to a requesting circuit, controller, and/or computing device) the cross-chain attribute ranking(s). The cross-chain attribute ranking(s) may be utilized to inform displays to the user, for example providing a group of the top X search results, with or without display of the actual rankings to the user. The operations of workflow 6405 allow for the cross-chain interaction circuit 6206 to respond to active requests, equivalence operations, and/or searches, as well as to pre-populate entity equivalence value(s) (e.g., for commonly used search criteria) to improve response times of the controller 200 during future servicing of searches, equivalence operations, or the like.

In certain embodiments, the operations of workflow 6405 allow for the controller 200 to prioritize resource utilization for any aspect of the present disclosure, for example performing storage operations prioritized according to the highest ranking matches (e.g., storing equivalence values; performing authenticity checks; iterative improvement operations such as determining which characteristics have the highest predictive value for good buyer/seller matches, equivalence determinations, or the like; storing matches that are more likely to be relevant for future searches for a user and/or a group of users; where the prioritization by ranking provides the best chance to store useful data while reducing the total storage utilized); and/or performing analysis operations (e.g., performing confirmation and/or confidence determinations for matches; and/or performing operations to determine characteristics that are highly predictive of equivalence determinations; where such operations consume significant computing resources and accordingly limiting to highly relevant data saves significant resources while still leveraging the benefits of such operations). In certain embodiments, operations to prioritize resource utilization includes consideration of low ranking matches (e.g., determining characteristics that are not predictive of equivalence determinations, for example characteristics where entities have the same or similar values, but nevertheless are not equivalents, and accordingly equivalence determinations can be tuned to eliminate and/or reduce the weighting of such characteristics for consideration), and/or otherwise unique or interesting matches (e.g., a low ranking entity that has significant overlap of characteristics with high ranking entities and/or a high ranking entity that has significant overlap of characteristics with low ranking entities, which may be utilized to determine interactions between characteristics, and/or dependency of characteristics, for equivalence determinations). It will be seen that operations to reduce consumption of storage resources and/or computing resources may additionally or alternatively reduce consumption of other resources, such as communication resources, for example where storage and/or computing operations are performed on a cloud server or other distributed device, which drives communication operations to support the storage/retrieval of data, providing data and requests to supporting computing devices, and the like.

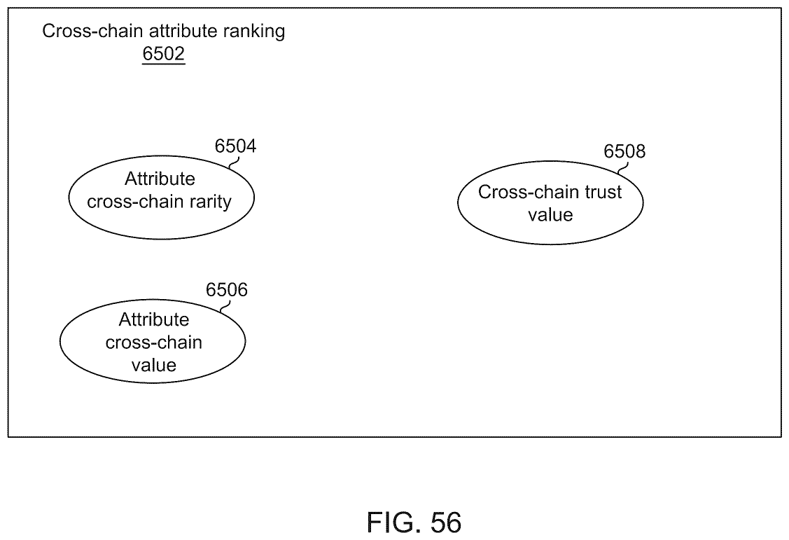

Referencing FIG. 56, an example cross-chain attribute ranking 6502 is schematically depicted. The example cross-chain attribute ranking 6502 may include any one or more of the aspects depicted, and may additionally or alternatively include a cross-chain ranking of any attribute for entities as set forth throughout the present disclosure. The example cross-chain attribute ranking 6502 includes an attribute cross-chain rarity 6504. The cross-chain rarity 6504 may be based on any attribute, or a combination of attributes. For example, an asset may be determined to be rare based on the asset genre, asset type, asset value, and/or a combination of an asset characteristic with a related entity—for example an asset of a certain genre held by an account having a high trust score, an asset having a high value that has not been traded for a predetermined period of time, an asset created by a particular author, or the like. The determination of rarity may be based upon frequency (e.g., less than 1% of assets having those characteristics), a statistical description (e.g., an asset characteristic that is three standard deviations above the norm, exceeding a threshold value above an average, etc.), and/or a unit count determination (e.g., the asset is unique, less than 10 assets share the characteristic(s) of interest, etc.). In certain embodiments, the attribute cross-chain rarity 6504 may be determined according to user preferences, and/or in response to interactions with the user. The example cross-chain attribute ranking 6502 includes an attribute cross-chain value 6506, for example any characteristic, such as an asset value, portfolio value, creator or author, asset genre, or the like, ranked across the blockchains, and which may include combinations of characteristics—for example an asset of a particular genre ranked by creation date, color palette utilized, liquidity, or the like. The example cross-chain attribute ranking 6502 includes a cross-chain trust value 6508, for example ranking trust score(s) for assets, accounts/wallets, or other entities, including a trust determination according to any aspect of the present disclosure. In certain embodiments, the cross-chain trust value 6508 may be normalized (e.g., considering systematic trust score offsets between separate blockchains), bucketed (e.g., treating ranges of trust scores as equivalents for ranking purposes), and/or according to one or more thresholds (e.g., ranking trust scores above 85 as fully trustworthy, trust scores below 50 as not trustworthy and/or excluded from ranking, etc.).

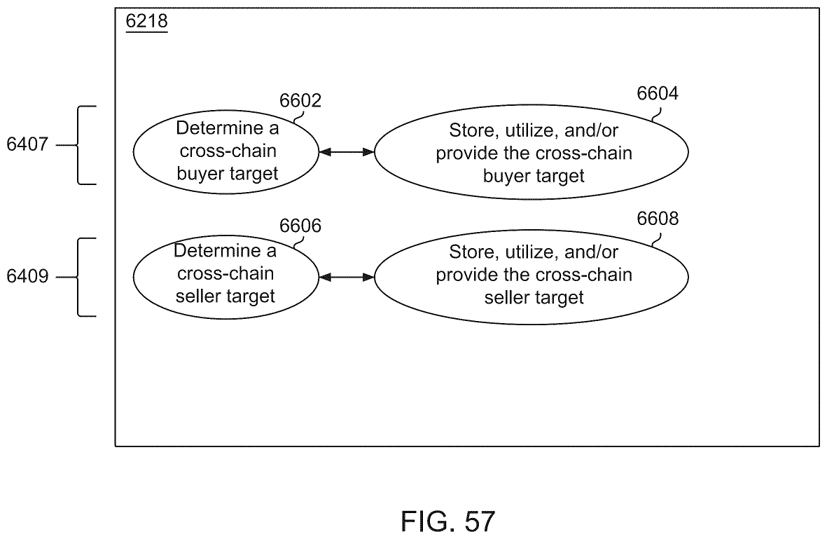

Referencing FIG. 57, example and non-limiting workflows, which may be performed as a cross-chain interaction operation 6218, are schematically depicted. An example workflow 6407 includes an operation 6602 to determine a cross-chain buyer target (e.g., operations to determine an appropriate buyer for an asset and/or a prospective asset, based on matching of buyer interest, buyer portfolio holdings, buyer transaction value(s) and asset sale target value, etc. —for example reference FIGS. 22-30 and the related descriptions), and an operation 6604 to store, utilize, and/or provide the cross-chain buyer target to a user interface accessible to a user. An example workflow 6409 includes an operation 6606 to determine a cross-chain seller target (e.g., operations to determine an appropriate seller for an asset, based on matching of user interest to seller holdings, seller transactions, asset value(s), asset liquidity, expected asset value performance, impact of the asset on the value or other characteristics of the user's current portfolio, or the like—for example reference FIGS. 31-39 and the related descriptions), and an operation 6608 to store, utilize, and/or provide the cross-chain seller target to a user interface accessible to a user.

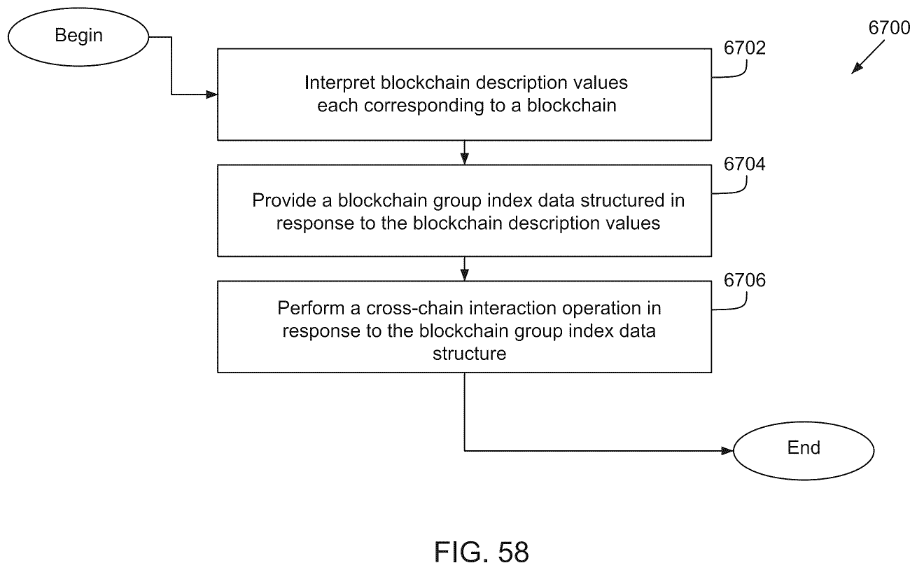

Referencing FIG. 58, an example procedure 6700 to perform a cross-chain interaction operation is schematically depicted. The example procedure 6700 includes an operation 6702 to interpret a number of blockchain description values, each corresponding to at least one of a number of blockchains, and an operation 6704 to provide a blockchain group index data structure in response to the number of blockchain description values. The example procedure 6700 further includes an operation 6706 to perform a cross-chain interaction operation in response to the blockchain group index data structure. Without limitation to any other aspect of the present disclosure, example operations 6706 include, in whole or part, workflows such as those set forth in FIGS. 55, 57 and the related descriptions.

In some aspects, the techniques described herein relate to a method, including: interpreting a plurality of blockchain description values each corresponding to at least one of a plurality of blockchains; providing a blockchain group index data structure in response to the plurality of blockchain description values, the blockchain group index data structure including an attribute association description, the attribute association description including: an identified attribute value; a first association of the identified attribute value to a first entity associated with a first blockchain of the plurality of blockchains; and a second association of the identified attribute value to a second entity associated with a second blockchain of the plurality of blockchains; and performing a cross-chain interaction operation in response to the blockchain group index data structure.

Referencing FIG. 59, an example controller 200 to perform operations based on rarity of chain level traits is schematically depicted. Chain level traits, as utilized herein, include traits of any entity associated with a blockchain, that have a rare characteristic of interest, for example to allow a user to find an asset having an unusually high value and/or an unusually high match for a characteristic of interest. In certain embodiments, for example in combination with aspects of the embodiment set forth in regard to FIG. 53, rarity of chain level traits may include consideration of traits across multiple blockchains, and/or including portions of other blockchains (e.g., including beneficial owners having assets on multiple blockchains, assets of a certain type, and/or portions of multiple blockchains for entities having any other selected attributes). The example controller 200 includes a blockchain monitoring circuit 6802 that interprets a blockchain index data structure 6808 having a number of attribute characteristics (or values) 6814 for each of a number of entities 6810 associated with the blockchain. The example controller 200 further includes a blockchain rarity circuit 6804 that determines a rarity value (e.g., as a cross-chain rarity value 6216, and/or scoped as a rarity value for a single blockchain) in response to the blockchain index data structure 6808. The example controller 200 includes a blockchain transaction assistant circuit 6806 that provides a rarity communication 6818, in response to the rarity value, to a user interface for transactions associated with the blockchain. Example rarity communications 6818 allow the user to identify assets, and/or entity matches, that have unusual characteristics (e.g., match quality of any type, trust score, value, future expected value, fit with the user's portfolio and/or interests, etc.) that may be of interest to the user. Example rarity communications 6818 provide opportunities for the user to acquire assets of particular interest, for the user to develop watch targets for certain accounts/wallets and/or assets (e.g., to consider acquisition of an asset, for example at a future time, after the asset is transferred, after the user acquires other assets that may be related to the asset of interest, etc.), and/or to consider certain asset types, asset classes, asset genres, etc. for future acquisition.

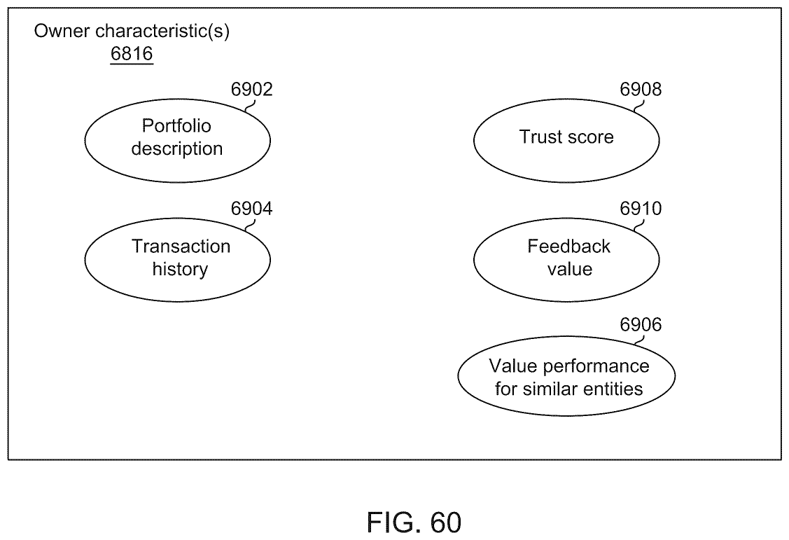

In certain embodiments, the entities 6810 include any type of entity as set forth throughout the present disclosure, including at least account(s), wallet(s), user identifier(s) (e.g., the underlying beneficial owner 6812, for example utilized to relate accounts/wallets held by a same underlying owner 6812 as determined according to equivalence operations set forth throughout the present disclosure, as indicated by the user, and/or according to external data value(s) 6824). In certain embodiments, the entities 6810 include one or more of an asset, token, and/or contract. In certain embodiments, the blockchain rarity circuit 6804 determines the rarity value(s) in response to an owner characteristic 6816 of an owner 6810 associated with the entity 6810. For example, the owner characteristic 6816 may be distinct from an entity characteristic 6814, such as when a view of the portfolio of assets, transactions, trust scores, etc., for the owner 6812 indicate distinct characteristics for the owner as a whole relative to one or more of the same characteristics when considered individually for a wallet/account and/or asset that is associated with the owner 6812. Referencing FIG. 60, example and non-limiting owner characteristics 6816 include one or more of: a portfolio description 6902 (e.g., assets held, asset values, asset genres, asset types, overall expected value trajectory, statistical descriptions of these, a trajectory of these, and/or a distribution of these); a transaction history 6904 (e.g., transaction frequency, sequencing, values, asset types, asset genres, etc.); a value performance 6906 for similar entities (e.g., value performance for similar assets, for accounts/wallets and/or owners having a similar portfolio, asset mix, transaction history, or the like); a trust score 6908 (e.g., a trust score determined for the owner, determined according to trust scores for accounts/wallets associated with the owner, etc.); and/or a feedback value 6910 (e.g., feedback provided by entities after transactions with the owner, including by users interacting with the controller 200 through a user interface).

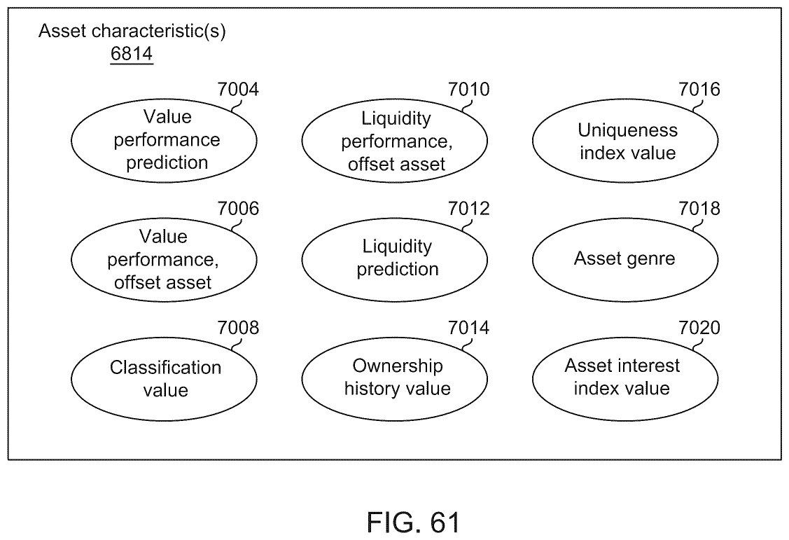

An example blockchain rarity circuit 6804 determines the rarity value in response to a user characteristic 6822 of a user 6820 interacting with the controller 200 through a user interface. For example, the rarity value for an asset, buyer match, seller match, or the like, can be determined according to the specific interests, transactions, asset holdings or portfolio, etc., of the user. In certain embodiments, an asset has a high rarity value for a first user (e.g., the asset and/or asset owner has unusually high matching characteristics with the characteristics of the first user), and a low rarity value for a second user (e.g., the asset and/or asset owner does not have high matching characteristics with the characteristics of the second user). In certain embodiments, the blockchain rarity circuit 6804 determines the rarity value in response to a compatibility between the user characteristic 6822 and characteristics of the asset, account/wallet holding the asset, and/or owner of the asset—for example reducing the rarity value where compatibility is low, eliminating the asset from consideration where an incompatibility is present, or the like. Referencing FIG. 61, example and non-limiting asset characteristics 6814 include one or more of: a value performance prediction 7004 (e.g., the expected value of the asset over a time period of interest, as a net present value, or the like); a value performance of an offset asset 7006 (e.g., the observed value of an asset having similar characteristics); a classification value 7008 (e.g., a rare asset, a high value asset, and/or any other group of asset characteristics utilized to label the asset for abstracted analysis according to the label, which may include artificial intelligence classification operations); a liquidity performance of an offset asset 7010 (e.g., the expected ability to sell the asset based on observation of an asset having similar characteristics, for example based upon time to sell, hold time by an owner that is expected to want to sell the asset, etc.); a liquidity prediction 7012 for the asset (e.g., the expected ability to sell the asset, for example based on general interest and/or transactions estimated according to the other asset characteristics); an ownership history value 7014 for the asset (e.g., holdings of the asset by owners having owner characteristics of interest, how often the asset has been traded, how long the asset is held, the distribution and/or sequencing of these, etc.); a uniqueness index value 7016 (e.g., may include determinations similar to rarity determinations, an estimate of the availability of assets having similar characteristics, and/or based on a characteristic of the asset that is unique such as an author or creator, specific interest in the asset indicated by external data—e.g., the asset is mentioned in a news article or social media, etc.); an asset genre 7018 (e.g., portrait, animals, people, landscape, etc.); and/or an asset interest index value 7020 (e.g., a combination of any of these built into an index, a match description of the asset to interests expressed by the user, etc.).

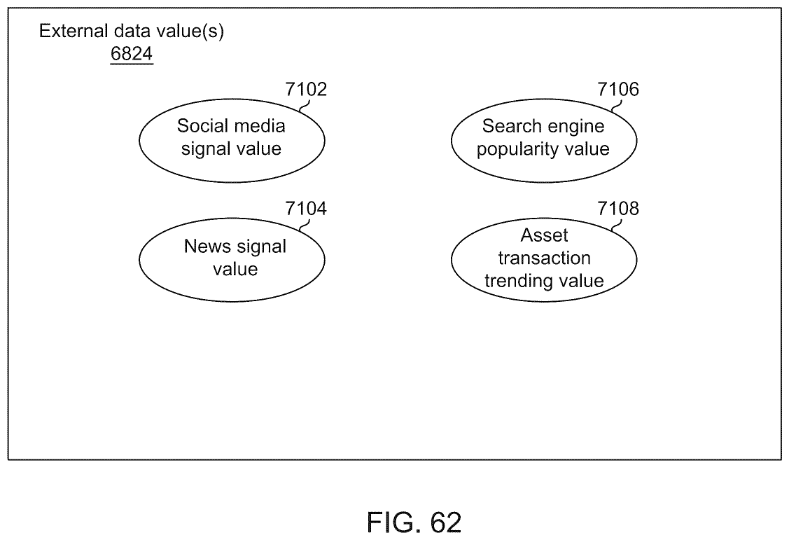

An example blockchain rarity circuit 6804 determines the rarity value in response to an external data value 6824. For example, external data value(s) 6824 may indicate that an asset characteristic is trending, newsworthy, being sought by a large group of users, or the like. Referencing FIG. 62, example and non-limiting external data value(s) 6824 include one or more of: a social media signal value 7102 (e.g., keywords and/or asset depictions related to the asset characteristic are trending, being described positively, being described negatively, providing an indication of a scarcity or excess of availability of the characteristic, etc.); a news signal value 7104 (e.g., news articles and/or opinion pieces, with similar considerations as for social media); a search engine popularity value 7106 (e.g., a corpus of search data providing an indication about the asset characteristic); and/or an asset transaction trending value 7108 (e.g., where asset transaction data is determined from blockchain analysis, regulatory filings, subscription based data, and/or any other data source).

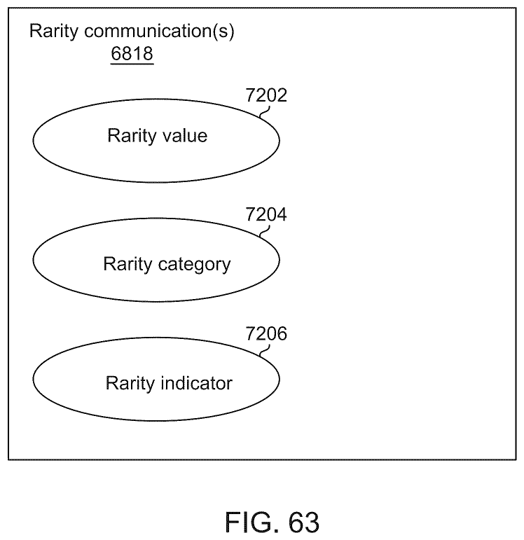

Referencing FIG. 63, example and non-limiting rarity communication(s) 6818 include one or more of: the rarity value 7202 (e.g., an index, category, and/or any other qualitative or quantitative indicator of the rarity of the asset and/or transaction, which may be configured for the specific user); a rarity category 7204 (e.g., a qualitative descriptor of the rarity, such as common, uncommon, rare, etc.); and/or a rarity indicator 7206 (e.g., a value indicating that the rarity exceeds a threshold value, providing the asset and/or potential transaction on a list where members of the list are only included if the rarity value is sufficient for listing, etc.). In certain embodiments, the rarity communication 6818 is provided to the user, for example in a listing of resulting assets or potential transactions from a search, in a listing of rare assets, etc. In certain embodiments, the rarity communication 6818 is provided to any controller, circuit, computing device, etc., of the present disclosure, for example for utilization as an asset characteristic, an entity characteristic, with an equivalence determination, with a ranking operation, and/or as a part of any other procedure or operation as set forth throughout the present disclosure.

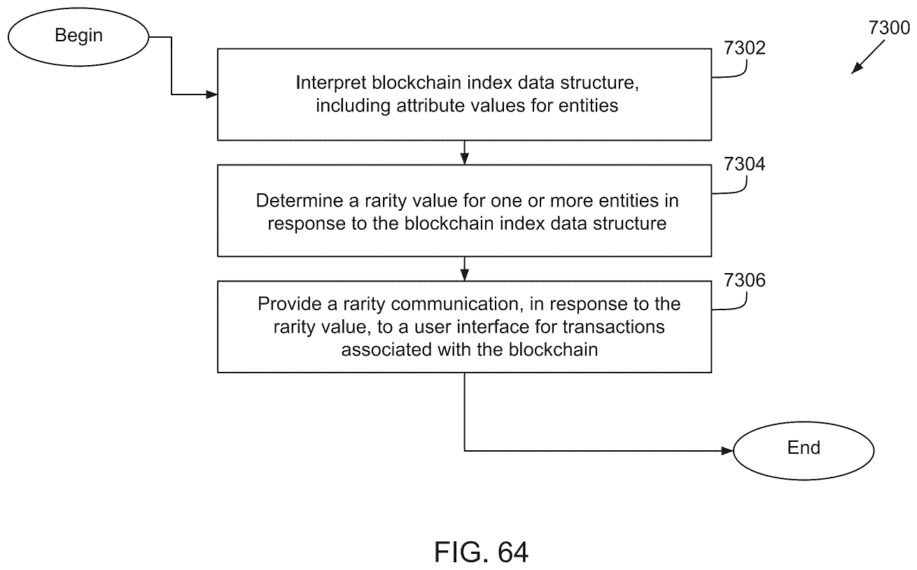

Referencing FIG. 64, an example procedure 7300 for providing a rarity communication is schematically depicted. The example procedure 7300 includes an operation 7302 to interpret a blockchain index data structure, including attribute value(s) for entities associated with the blockchain(s) indexed therein, an operation 7304 to determine a rarity value for one or more entities in response to the blockchain index data structure (and/or characteristics of the user), and an operation 7306 to provide a rarity communication in response to the rarity value. The example operation 7306 may include providing the rarity communication to a user interface for a user interacting with a controller of the present disclosure, and/or providing the rarity communication to any controller, circuit, computing device of the present disclosure. In certain embodiments, aspects of the procedure 7300 may be performed by any controller of the present disclosure, including for example a controller 200 as set forth in FIG. 59 and the related description.

Without limitation to any other aspect of the present disclosure, an example controller 200 includes a blockchain group data circuit 6202 that interprets a number of blockchain description values 6208 each corresponding to at least one of a number of blockchains, and a blockchain group index circuit 6204 that provides a blockchain group index data structure 6212 in response to the blockchain description values 6208. The example blockchain group index data structure 6212 includes an attribute association description 6214, the attribute association description including one or more of: an identified attribute value; a first association of the identified attribute value to a first entity associated with a first blockchain of the number of blockchains; and a second association of the identified attribute value to a second entity associated with a second blockchain of the number of blockchains. The example controller 200 includes a cross-chain interaction circuit 6206 that determines a cross-chain rarity value 6216 corresponding to at least one of the first entity or the second entity in response to the blockchain group index data structure 6212. An example cross-chain interaction operation 6218 includes providing a cross-chain rarity communication 6818. An example cross-chain interaction circuit 6206 determines the cross-chain rarity value 6216 in response to one or more of: asset characteristics 6814, owner characteristics 6816, account/wallet characteristics 6814, user characteristics 6822, and/or external data values 6824.

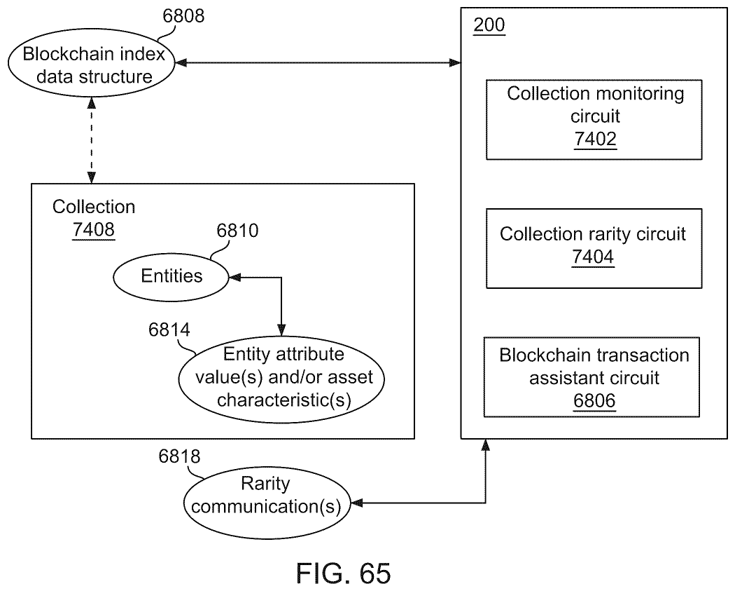

Referencing FIG. 65, an example controller 200 for providing a rarity communication 6818 is schematically depicted. The example controller 200 includes a collection monitoring circuit 7402 that interpret a blockchain index data structure 6808 including a number of attribute values for each of a number of entities 6810 associated with a collection 7408, and a collection rarity circuit 7404 that determines a rarity value for at least one of the entities 6810. In certain embodiments, the rarity values may be stored as an entity characteristic 6814, and/or on a data structure 3006, 350, 450, 550 of any type set forth throughout the present disclosure. The example controller 200 includes a blockchain transaction assistant circuit 6806 that provides a rarity communication 6818 in response to the rarity value. The blockchain transaction assistant circuit 6806 may provide the rarity communication 6818 to a user interface utilized by a user to access the controller 200. In certain embodiments, the rarity communication 6818 is provided to any controller, circuit, computing device, etc., of the present disclosure, for example for utilization as an asset characteristic, an entity characteristic, with an equivalence determination, with a ranking operation, and/or as a part of any other procedure or operation as set forth throughout the present disclosure. In certain embodiments, the rarity value may be determined within the collection 7408 (e.g., identifying members of the collection 7408 that are rare relative to the other members of the collection 7408), with regard to a blockchain (e.g., identifying members of the collection 7408 that are rare relative to the entire blockchain, and/or a relevant portion of the blockchain such as all assets of the same type, same genre, etc.), and/or with regard to group of blockchains (e.g., identifying members of the collection 7408 that are relative to all of the blockchains, and/or a relevant portion of all of the blockchains). In certain embodiments, the rarity value may be determined for the collection 7408, for example the rarity of the collection 7408 as a group relative to one or more blockchains (e.g., allowing the user to view the rarity of a collection 7408 encompassing their own assets, the assets of a selected account/wallet, the assets of a selected owner, and/or the assets of a selected group, etc.).

A collection 7408, as utilized herein, should be understood broadly. An example collection 7408 includes a number of assets associated with a blockchain, for example a group of assets sharing a group of asset characteristics (e.g., indicated by the user, such as all sunset pictures, and/or determined according to user characteristics such as transaction history, assets in the user's portfolio, indicated interest by the user, etc.), a group of accounts/wallets sharing entity characteristics, assets held by a particular owner and/or group of owners, etc. In certain embodiments, a collection 7408 includes assets and/or entities across a number of blockchains, for example including accounts/wallets, owners, and/or assets having an equivalence to those entities on a first blockchain, and/or in operations to create a collection 7408 that is agnostic to the blockchain source of members of the collection. In certain embodiments, a collection 7408 includes a group of tokens. In certain embodiments, a collection 7408 includes assets and/or other entities tagged by a user, for example creating a collection from a return of search results, creating a collection of assets created by tagging a group of accounts/wallets and/or owners, and/or creating a collection of assets created by tagging an asset characteristic (e.g., assets of a given genre, asset type, asset value, and/or assets utilizing a specified smart contract and/or version, etc.). In certain embodiments, multiple criteria may be utilized to create a collection (e.g., assets depicting a nature landscape, with a value between $100-$1000). In certain embodiments, the collection monitoring circuit 7402 creates the collection by applying more selective criteria first (e.g., narrowing the corpus of assets based on criteria that will eliminate more assets first), and/or by applying more easily applied criteria first (e.g., based on the indexing parameters available in the blockchain index data structure 6808, some criteria may require fewer resources to apply than other criteria), to reduce resource utilization and/or improve response times experienced by the user. In certain embodiments, the collection monitoring circuit 7402 updates the collection 7408, for example eliminating assets where the asset characteristics change such that the asset is no longer a good match for the collection 7408, which may be performed periodically, upon a request from the user, during times when the controller 200 otherwise has a low processing burden, etc.).

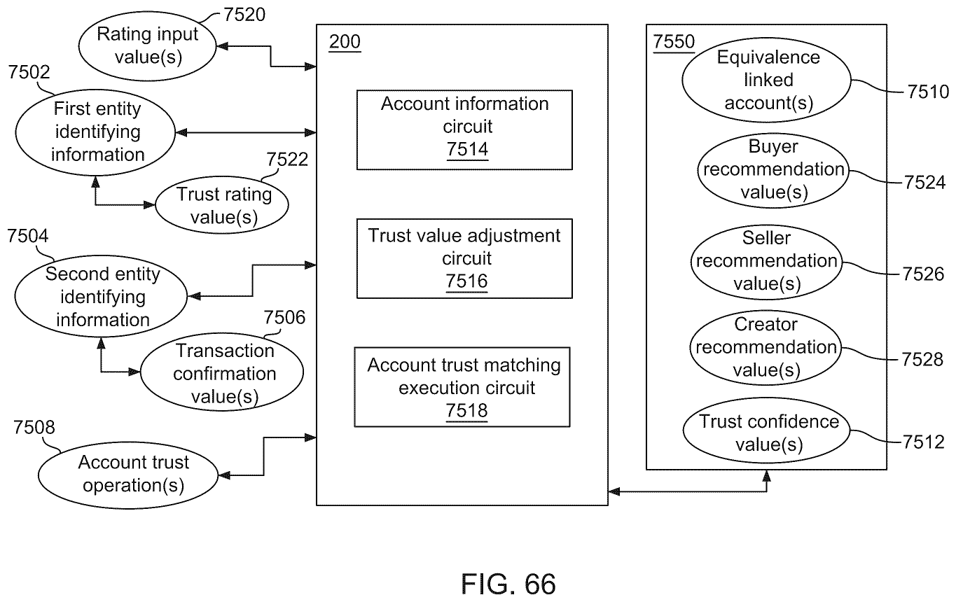

Referencing FIG. 66, an example controller 200 for performing account trust operations is schematically depicted. The example controller 200 includes an account information circuit 7514 that interprets first identifying information 7502 for a first blockchain account and second identifying information 7504 for a second blockchain account. The example first identifying information 7502 includes a trust rating value 7522, for example a numerical value and/or a categorical value indicating the trust associated with the first account. In certain embodiments, the trust rating value 7522 may be the trust score, utilized to determine the trust score, and/or underlying information (e.g., transaction history, portfolio information, relevant account attributes, and/or trust rating values provided by other users) utilized in various trust based operations related to the first account, related wallets, related owners, and/or other equivalence related entities to the first account.

The example second identifying information 7504 includes a transaction confirmation value 7506, for example indicating that the transaction between the first account and the second account actually occurred.

The example of FIG. 66 is set forth in the context of a first and second account, but may additionally or alternatively be performed in the context of a first and second wallet, a first and second owner, and/or combinations of these. In certain embodiments, it will be understood that the trust rating value 7522, which is determined from a user provided value (e.g., a transaction rating value, not shown, received from the second entity) that affects the trust rating of the first account, will have appropriate monitoring before utilization, especially where a wallet, which may represent multiple accounts, or an owner, which may represent multiple accounts and/or may be based on determined equivalence values as set forth throughout the present disclosure, providing a risk that unrelated accounts to the first user would be affected by the trust rating value 7522. Accordingly, for example, utilization of the trust rating value 7522 by the trust value adjustment circuit 7516 and/or other circuits, controllers, and/or computing devices herein, and/or within an operation or procedure of the present disclosure, may include ensuring that equivalence determinations related such operations are based on actual identity (e.g., as opposed to a functional equivalence determination) of the first account with the associated wallet and/or owner, and/or may include high threshold determinations (e.g., equivalence score, confirmation checks, etc.) before attaching the trust rating value 7522 to a wallet and/or first owner. Similar considerations may also apply to the second account, for example before allowing a second wallet or owner to provide a trust rating value 7522 other than directly through the second account, and/or a trust rating value 7522 may be accepted only directly from the second account. In certain embodiments, the trust rating value 7522, and/or downstream trust determinations such as adjustments to a trust score, and/or utilizations of these in an account trust operation 7508 or other operations or procedures throughout the present disclosure, may nevertheless affect trust determinations for other entities (e.g., distinct accounts, owners, and/or wallets separate from the first account) as a higher order effect. For example, the trust rating value 7522 may affect the trust score of the first account (e.g., reducing the trust score), which may subsequently affect other accounts that have a high equivalence value with the first account (e.g., where an equivalence value is based on a high correlation of trust between those accounts due to highly correlated attributes and/or characteristics related to the trust score of the accounts).

The example controller 200 includes a trust value adjustment circuit 7516 that interprets a transaction rating value (e.g., by receiving a rating input value 7520) from a user associated with the second blockchain account (e.g., identified with the second entity identifying information 7504). An example transaction rating value includes, for example, an indication of whether a transaction was completed according to expectations, whether asset characteristics met expectations and/or indicated values, whether appropriate rights were properly transferred and executed, and/or whether transferred value was successfully performed (e.g., transaction approval, which may not be immediate, successfully concluded). The first user and the second user may be on either side of the transaction, for example the first account may be either the buying or selling account. Accordingly, each user of the transaction may, in certain embodiments, provide a transaction rating value for the other user. In certain embodiments, a transaction rating value may be limited to the buying user or the selling user. In certain embodiments, the trust value adjustment circuit 7516 may prompt the user to provide a transaction rating value after the transaction. In certain embodiments, the trust value adjustment circuit 7516 may accept a transaction rating value for a limited period of time after the transaction is concluded, and/or may adjust the weighting of the transaction rating value based on the time lapse between the transaction and the time the provides the transaction rating value. For example, a transaction rating value provided shortly after the transaction may be highly weighted (e.g., for certain transactions, a rating provided after two days may be a higher quality rating than a rating provided immediately after the transaction). In another example, a transaction rating value provided a long time after the transaction may have a reduced weight and/or given no weight (e.g., a rating provided two years after the transaction). The relevant time frame for prompting, acceptance, and/or weighting of the transaction rating value may depend upon the type of transaction (e.g., the asset type, asset value, etc.), the rights transferred (e.g., access rights and/or utilization rights may have a distinct relevant time frame for a purchaser to confirm relative to rights to a simple digital image), and/or user characteristics (e.g., a user with hundreds of transactions per day may have an expected delay relative to a user than makes one transaction per year). The example trust value adjustment circuit 7516 adjusts the trust rating value 7522 in response to the transaction rating value and the transaction confirmation value 7506. In certain embodiments, adjustments to the trust rating value 7522 include adding the transaction rating value to a data structure embodying the trust rating value 7522, adjusting quantitative information of the trust rating value 7522 (e.g., adjusting averages, accumulating ratings of a certain type, adjusting a statistical description of keywords utilized in ratings, determining whether certain trust thresholds have been met, etc.).

The example controller 200 includes an account trust matching circuit 7518 that performs an account trust operation 7508 in response to the adjusted trust rating value 7522. Without limitation to any other aspect of the present disclosure, the account trust operation 7508 includes providing the adjusted trust rating value 7522, and/or a trust score determined from the adjusted trust rating value 7522, for utilization by any controller, circuit, computing device, and/or in conjunction with any procedure and/or operation as set forth throughout the present disclosure, as a part of a trust based determination, recommendation, equivalence matching operation, or the like.

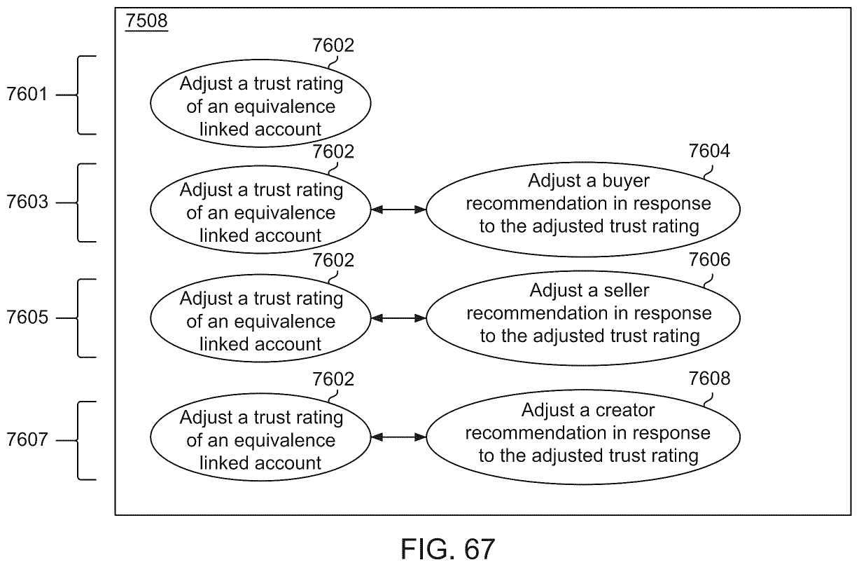

Referencing FIG. 67, example and non-limiting workflows, which may be performed as an account trust operation 7508, are schematically depicted. An example workflow 7601 includes an operation 7602 to adjust a trust rating of an equivalence linked account 7510 (e.g., where a determination is made that a first account is equivalent, for at least some purposes, to a second account, where the equivalence linked account 7510 identifies the accounts that are equivalent, and further may include information about the equivalence—for example the accounts are considered equivalent as being owned by the same beneficiary, having a same buying profile, selling profile, asset holding profile, or the like). For example, when a user of the second account provides a transaction rating value, the trust value adjustment circuit 7516 adjusts the trust rating value 7522, resulting in an adjustment to a trust score for the first account, and operation 7602 includes an operation to adjust a trust rating of another account that is linked to the first account, based on equivalence determinations, due to the change in the trust rating value 7522 for the first account. Operations to adjust the trust rating of the linked account, and to link accounts based on equivalence determinations, may be performed according to any operations set forth throughout the present disclosure. An example workflow 7603 includes the operation 7602, and an operation 7604 to adjust a buyer recommendation (e.g., a buyer recommendation value 7524) in response to the adjusted trust rating. For example, the controller 200 may have a predetermined buyer recommendation that is stored, an active buyer recommendation being presented to a user, or the like. In certain embodiments, adjustments to the trust rating value for the first account may result in changes to the buyer recommendation, for example adding an entity (e.g., the first account, a linked account, a linked owner, etc.) to the recommendation, removing an entity from the recommendation, and/or adjusting a ranking of an entity on the buyer recommendation, in response to the adjusted trust rating value. The operations to adjust the buyer recommendation may occur when the adjustment to the trust rating value occurs, during a periodic update to the buyer recommendation, in real time (e.g., as the adjustment to the trust rating value occurs, and/or while a user is viewing the buyer recommendation), and/or according to any other buyer recommendation operations and/or updates as set forth throughout the present disclosure. An example workflow 7605 includes the operation 7602, and an operation 7606 to adjust a seller recommendation (e.g., a seller recommendation value 7426) in response to the adjusted trust rating value. Operation 7606 to adjust the seller recommendation may be performed with analogous considerations to those described in relation to operation 7604. An example workflow 7607 includes the operation 7602, and an operation 7608 to adjust a creator recommendation (e.g., a creator recommendation value 7528) in response to the adjusted trust rating value. Operation 7608 to adjust the creator recommendation may be performed with analogous considerations to those described in relation to operation 7604.

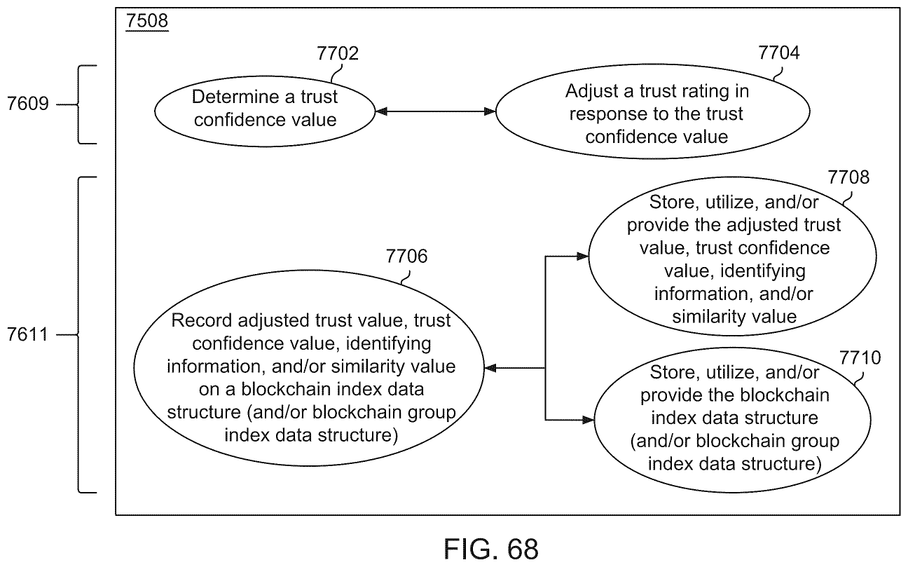

Referencing FIG. 68, example and non-limiting workflows, which may be performed as an account trust operation 7508, are schematically depicted. An example workflow 7609 includes an operation 7702 to determine a trust confidence value 7512, for example allowing the transaction rating value provided by the second account to have a greater or lesser effect on the trust rating value 7522 for the first account. In certain embodiments, the trust confidence value, and/or a weighting of the transaction rating value, may be based on considerations such as: the time delay between the related transaction and the provision of the transaction rating value; a trust score associated with the second account (e.g., a second account having a high or low trust score may be given more or less weight for transaction rating values); a quality assessment of transaction rating values for the second account (e.g., where the second account typically provides reliable transaction rating values that are consistent with the overall trust scores for the relevant first accounts, then transaction rating values for the second account may be deemed to be more reliable); a number of transactions associated with the first account (e.g., an account with a large number of ratings may have reduced weight for subsequent ratings); and/or an anomaly consideration of the transaction rating value (e.g., a transaction rating value that is inconsistent with the trust rating value 7522 may be given lower weight, for example to reduce the impact of a single anomalous rating, or more weight, for example to quickly adjust the trust rating value 7522 where the account is evidencing a fundamental change; in certain embodiments, the sequencing may be considered, for example where one or a small number of anomalous transaction rating values are given lower weight, but continued anomalous transaction rating values are then given a greater weight).

An example workflow 7611 includes an operation 7706 to record the adjusted trust value, the trust confidence value, identifying information (e.g., identifying information of the first account and/or second account utilized to determine the adjusted trust value and/or equivalence values of linked wallets, accounts, or owners that are also adjusted thereby), and/or similarity values (e.g., allowing considerations for accounts having similarities to the first account, for example to detect trust trends that are occurring, for example allowing improved response to systemic changes such as a global financial downturn, increasing or decreasing interest in certain asset types or genres, etc., that may affect a group of similar entities at the same time). The example workflow 7611 includes operations 7708 and 7710, one or both of which may be performed as a part of the workflow 7611. Operation 7708 includes storing, utilizing (e.g., by any controller, circuit, and/or computing device herein, for example as a part of any operations or procedures described throughout), and/or providing (e.g., to a user interface) any of the information recorded in operation 7706. Operation 7710 includes storing, utilizing, and/or providing a blockchain index data structure (and/or a blockchain group index data structure, for example where the data structure stores cross-chain information such as set forth in relation to FIGS. 54-57 and the related description), for example where the blockchain index data structure is utilized to store any aspects of the information recorded in operation 7706. Operations 7708, 7710 to store information may include confirming information recorded in operation 7706 (e.g., flagging the information to keep for a period of time), storing the information separately (e.g., that will be managed on a separate life cycle and/or deprecation cycle), information that has been processed and is therefore distinct from the “raw” data recorded in operation 7706, or the like.

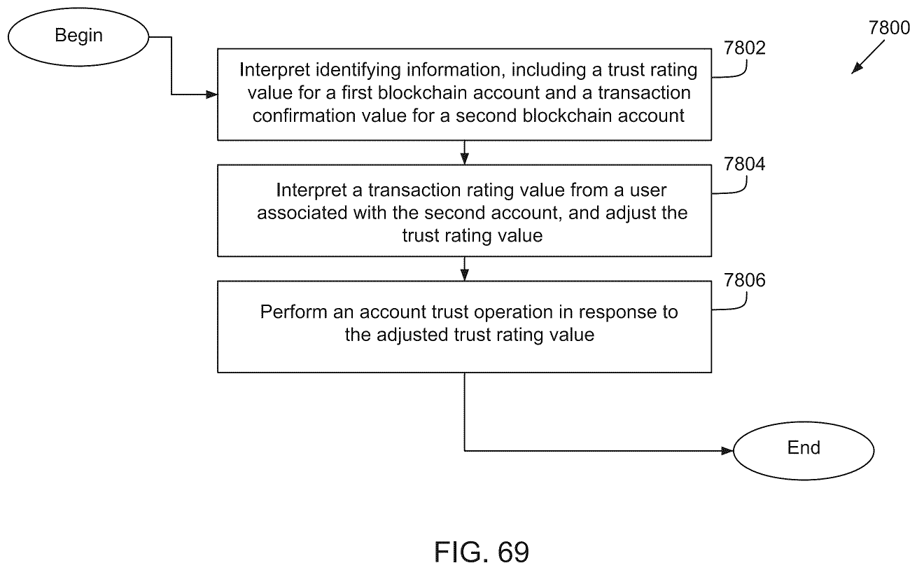

Referencing FIG. 69, an example procedure 7800 to perform an account trust operation is schematically depicted. The example procedure 7800 includes an operation 7802 to interpret identifying information for a first account and a second account, including a trust rating value for the first account and a transaction confirmation value for the second account. The example procedure 7800 includes an operation 7804 to interpret a transaction rating value from a user associated with the second account, and to adjust the trust rating value in response to the transaction rating value. The example procedure 7800 includes an operation 7806 to perform an account trust operation in response to the adjusted trust rating value. Example operations 7806 may be embodied, without limitation, as any of the workflows set forth in FIGS. 67-68 and the related descriptions.

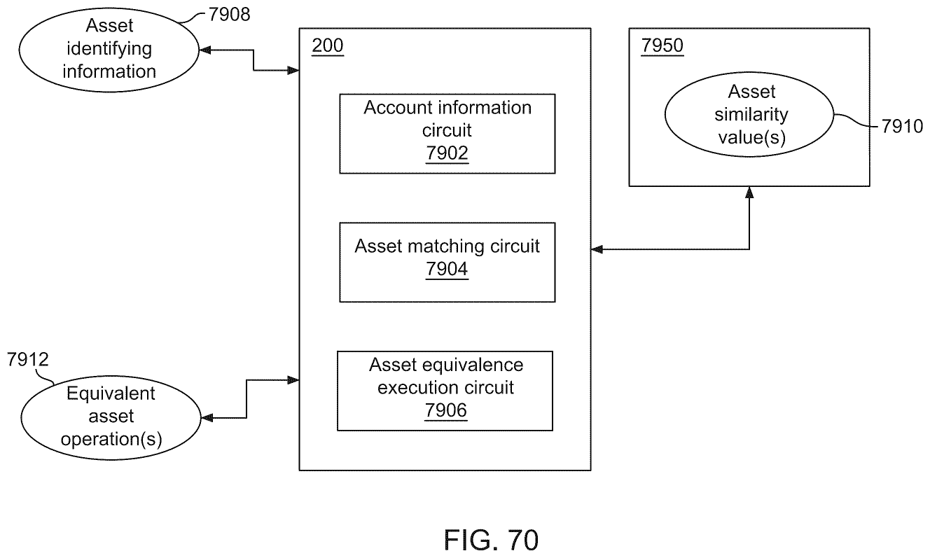

Referencing FIG. 70, an example controller 200 for performing equivalent asset operations 7912 is schematically depicted. The example controller 200 includes an asset information circuit 7902 that interprets asset identifying information 7908 for a first blockchain asset and a second blockchain asset. In certain embodiments, one or more of the blockchain asset(s) may be a reference asset, for example an asset known to be equivalent to an asset of interest, and/or an actual embodiment of a known asset (e.g., a picture, sound file, etc.) for comparison in operations of the controller 200. The example controller 200 includes an asset matching circuit 7904 that determines an asset similarity value 7910 in response to the asset identifying information 7908 for each of the assets (e.g., the first blockchain asset and the second blockchain asset). The asset similarity value 7910 may include a confirmation that the assets are equivalent (or not equivalent), and/or one or more differences between the assets. In certain embodiments, a user may be interested to determine whether an asset is genuine, including whether the asset is an actual copy (e.g., authorized or unauthorized), whether the asset has selected characteristics (e.g., genre, type, color palette, etc.), and/or whether the asset is provided from a legitimate source (e.g., a seller having ownership of, and/or previous transactions to sell, genuine assets that are related in some manner, such as a same author, assets of similar value, etc.). An example similarity value 7910 includes a determination that the assets are likely to be the same asset (e.g., a picture, sound file, media clip, etc.). An example similarity value 7910 includes a determination that an asset genuinely includes a declared characteristic (e.g., utilization of features indicating a genuine source, such as specific colors, creation techniques, sound generated from real instruments and/or instruments of a certain type, etc.). In certain embodiments, the asset similarity value(s) 7910 are stored on a data structure 7950, which may be included with and/or separate from other data structures 3006, 350, 450, 550, 7550 set forth throughout the present disclosure, and/or which may be a blockchain, relational database, or the like. In certain embodiments, the asset similarity value(s) 7910 are stored for future access, stored until the user is completed with operations such as transactions related to the asset(s), the user logs out of the system (e.g., logging out of a user interface interacting with the controller, or the like), and/or stored for a selected period of time. In certain embodiments, the asset similarity value(s) 7910 may be re-used, for example where a subsequent operation utilizes a same comparison of the assets.

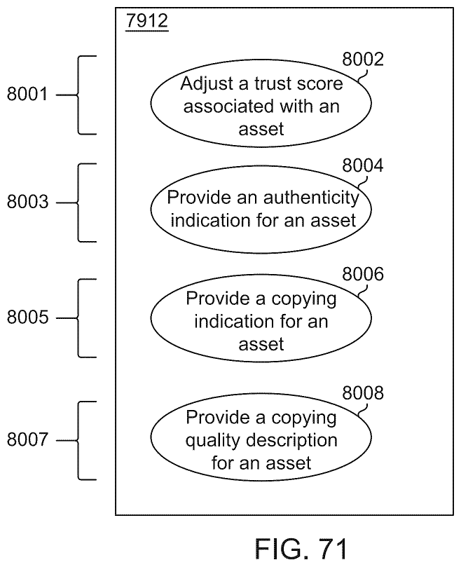

The example controller 200 further includes an asset equivalence execution circuit 7906 that performs an equivalent asset operation 7912 in response to the asset similarity value(s) 7910. Referencing FIG. 71, example and non-limiting workflows, which may be performed as an equivalent asset operation 7912, are schematically depicted. An example workflow 8001 includes an operation 8002 to adjust a trust score associated with an asset, for example where the comparison between the assets has confirmed that the second asset is genuine, has the declared characteristics, and the like, the trust score associated with the second asset may be increased, reset to a selected (e.g., high) value, etc. In another example, where the comparison between the assets has confirmed the second asset is not genuine, is an unauthorized, copy, and/or does not include the declared characteristics, the trust score associated with the second asset may be decreased, reset to a selected (e.g., low) value, etc. In certain embodiments, trust score adjustments for an asset may additionally be utilized to adjust trust scores for related entities, for example increasing or decreasing a trust score associated with a wallet/account and/or owner for an asset based on whether the asset is genuine, a copy (including whether the copy appears to be proper or improper), and/or whether asset attributes match declared attributes (e.g., does the asset match an associated description).

An example workflow 8003 includes an operation 8004 to provide an authenticity indication for an asset, for example where asset matching, determination of certain attributes (e.g., colors, sounds, creation techniques, ownership history, etc.), or the like for the asset are utilized to determine whether the asset is authentic as declared. An example workflow 8005 includes an operation 8006 to provide a copying indication, for example whether the second asset is likely to be a copy of the first asset. In certain embodiments, the copy indication may be desirable (e.g., where the second asset is declared to be a copy of the first asset), or undesirable (e.g., where the second asset is not declared to be a copy, and/or where the second asset is declared to be an original asset). In certain embodiments, the copy indication may apply to a whole asset comparison, and/or to a partial asset comparison (e.g., a portion of a picture, a few measures of a music flow, or the like). An example workflow 8007 includes an operation 8008 to provide a copying quality description for an asset, for example a determination that an asset is poorly copied (e.g., lacking matches for color, proportion, techniques, focus, etc.), and/or that an asset is well copied (e.g., matching in attributes of interest). In certain embodiments, copying may be determined according to second order characteristics, such as asset genre, type, color palette, overall impression (e.g., color coverage, mood, sound frequencies utilized, etc.), buyer interest (e.g., is the estimated value similar to the original), or the like. In certain embodiments, second order characteristics may be determined utilizing heuristics, expert systems, pattern matching operations, or the like. It can be seen that example equivalent asset operations 7912 allow a user to confirm whether an asset is genuine, whether the asset is likely to fulfill a selected purpose (e.g., relative to some other target asset that would fulfill the purpose but may be unavailable for some reason), or the like.

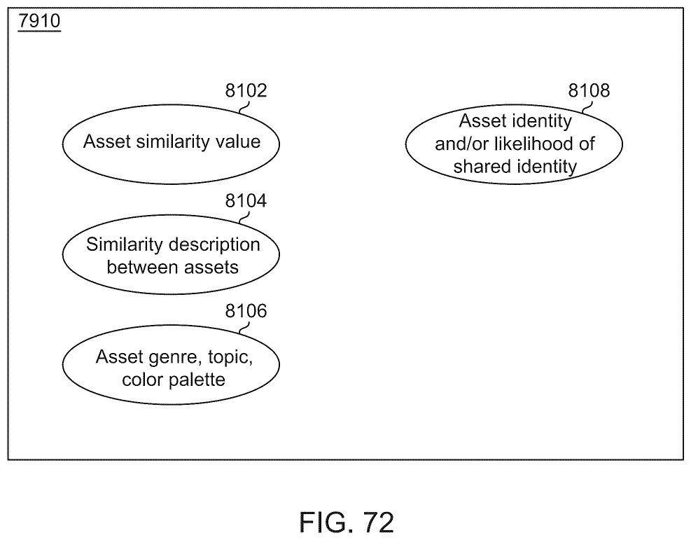

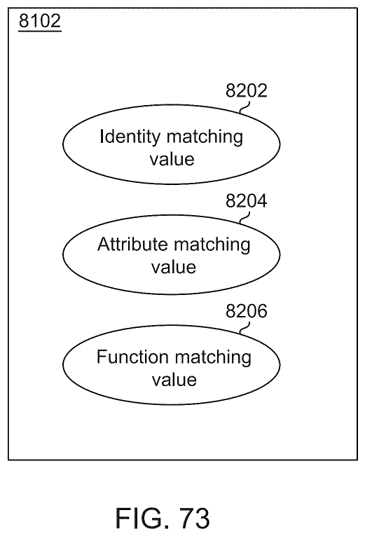

Referencing FIG. 72, example and non-limiting similarity value(s) 7910 include one or more parameters such as: an asset similarity value 8102, such as an indication of whether the assets are similar and/or identical, which may be quantitative (e.g., a similarity score, confidence value, matching index, etc.), qualitative (e.g., a list of attributes that are similar/identical), and/or categorical (e.g., dissimilar, identical, a good copy, a bad copy, etc.); an asset similarity description 8104 (e.g., including similarity values for different attributes of the assets, functions for which the assets are similar—e.g., value, genre, etc. and/or dissimilar—e.g., colors, size, etc.); an asset genre, topic, color palette, and/or other attributes 8106 that are similar, identical, dissimilar, etc.; and/or an asset identity value 8108, for example a value indicating that the assets share an identity and/or a likelihood that the assets share an identity (e.g., a value indicating to the user whether the asset is genuine, and/or whether the asset is literally the same as another asset). Referencing FIG. 73, example and non-limiting asset similarity value(s) 8102 include one or more parameters such as: an identity matching value 8202 (e.g., indicating whether the assets share an identity), an attribute matching value 8204 (e.g., indicating whether and/or which attributes of the assets are the same), and/or a function matching value 8206 (e.g., indicating whether the assets would be expected to fulfill a same role, for example value for a portfolio, completing a set of assets, having a similar liquidity, having a similar collection value, etc.).

An example asset matching circuit 7904 determines the asset similarity value by performing a structure similarity index measure (SSIM) operation, for example comparing luminance, color, or chromatic values for an image. In certain embodiments, the asset matching circuit 7904 may additionally or alternatively determine the asset similarity value by performing one or more operations such as: a hash comparison operation; a mean squared error operation, a mean squared deviation operation, a peak signal-to-noise ration operation, and/or performing a pattern recognition operation. Operations of the asset matching circuit 7904 may determine asset similarity value(s) between images, sound files, and/or video files.

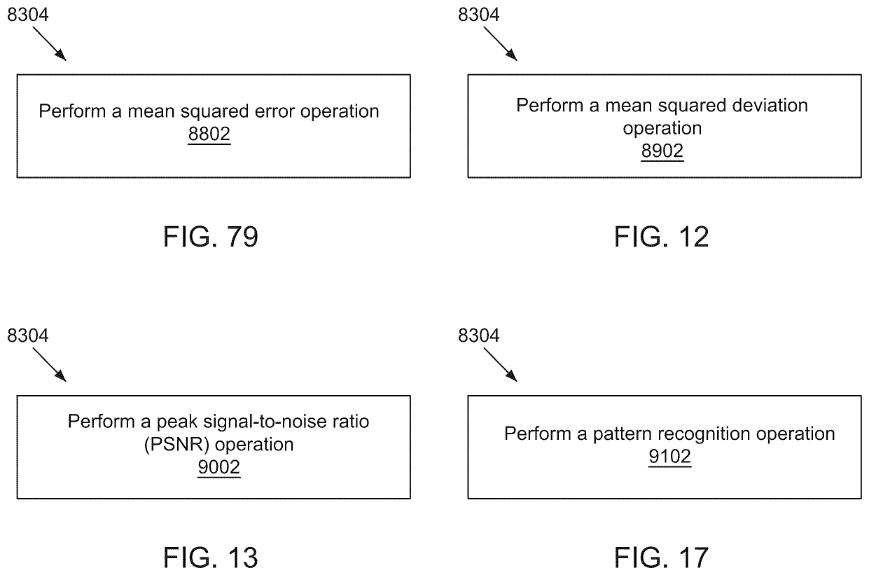

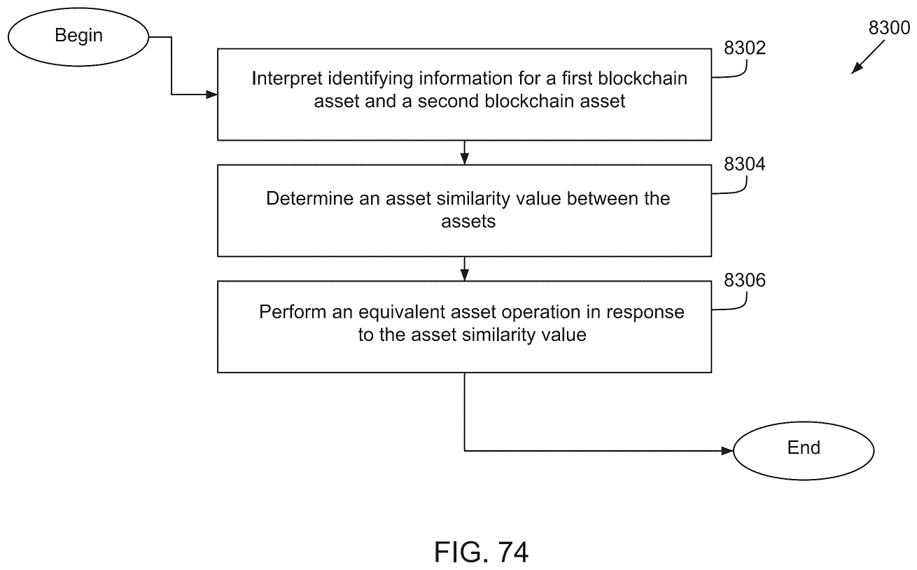

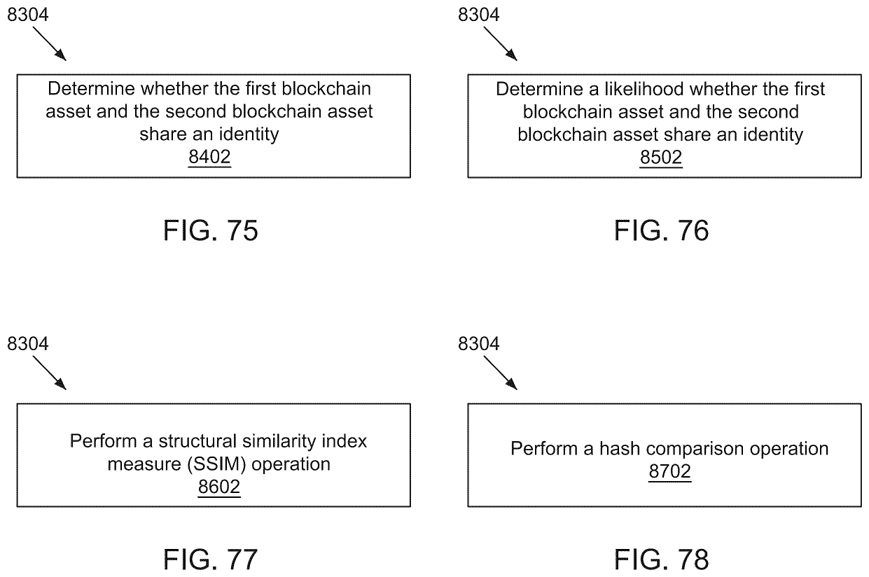

Referencing FIG. 74, an example procedure 8300 for performing an equivalent asset operation is schematically depicted. The example procedure 8300 includes an operation 8302 to interpret identifying information for a first blockchain asset and for a second blockchain asset, an operation 8304 to determine an asset similarity value between the asset(s), and an operation 8306 to perform an equivalent asset operation in response to the asset similarity value. Referencing FIGS. 75-79, 12-13, and 17, example operations to determine the asset similarity value include, without limitation: an operation 8402 to determine whether the assets share an identity; an operation 8502 to determine a likelihood whether the assets share an identity; an operation 8602 to perform an SSIM operation between the assets; an operation 8702 to perform a hash comparison operation between the assets; an operation 8802 to perform a mean squared error operation between the assets; an operation 8902 to perform a mean squared deviation operation between the assets; an operation 9002 to perform a peak signal-to-noise ratio operation between the assets; and/or an operation 9102 to perform a pattern recognition operation between the assets.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

1. A system, comprising:
one or more processors of a machine; and
memory-storing instructions that, when executed by the one or more processors, cause the machine to perform operations comprising:
interpreting, via a blockchain group data component, a blockchain description value corresponding to at least one of a plurality of blockchains;
providing, via a blockchain group index component, blockchain group index data structure in response to the blockchain description value, the blockchain group index data structure comprising an attribute association description;
performing, via a cross-chain interaction component, a cross-chain interaction operation in response to the blockchain group index data structure, the cross-chain interaction operation comprising determining an entity equivalence value between a first entity and a second entity, the first entity and the second entity being distributed across more than one blockchain; and
enabling the cross-chain interaction component to respond to an equivalence operation.

2. The system of claim 1, wherein the first entity and the second entity each comprise at least one of: an account, a wallet, a user identifier, an asset, a token, or a contract.

3. The system of claim 1, the operations further comprising:
performing, via the cross-chain interaction component, is the cross-chain interaction operation by providing a search description to a user interface in response to a user search value and the blockchain group index data structure.

4. The system of claim 1, the operations further comprising:
determining, via the cross-chain interaction component, the entity equivalence value between the first entity and the second entity in response to the blockchain group index data structure.

5. The system of claim 1, the operations further comprising:
determining a cross-chain attribute ranking.

6. The system of claim 5, wherein the cross-chain attribute ranking comprises a cross-chain rarity for an attribute.

7. The system of claim 5, wherein the cross-chain attribute ranking comprises a cross-chain value for an attribute.

8. The system of claim 5, wherein the cross-chain attribute ranking comprises a cross-chain trust value.

9. The system of claim 1, the operations further comprising:
determining a cross-chain buyer target.

10. The system of claim 1, the operations further comprising:
determining a cross-chain seller target.

11. A method, comprising:
interpreting blockchain description value corresponding to at least one of a plurality of blockchains;
providing, by at least one hardware processor, a blockchain group index data structure in response to the blockchain description value, the blockchain group index data structure comprising an attribute association description;
performing a cross-chain interaction operation, via a cross-chain interaction component, in response to the blockchain group index data structure, the cross-chain interaction component determining an entity equivalence value between a first entity and a second entity, the first entity and the second entity being distributed across more than one blockchain; and
enabling the cross-chain interaction component to respond to an equivalence operation.

12. The method of claim 11, further comprising:
providing a search description to a user interface in response to a user search value and the blockchain group index data structure.

13. The method of claim 11, further comprising:
determining an entity equivalence value between the first entity and the second entity in response to the blockchain group index data structure.

14. The method of claim 11, further comprising:
determining a cross-chain attribute ranking.

15. The method of claim 11, further comprising:
by determining a cross-chain buyer target.

16. The method of claim 11, further comprising:
determining a cross-chain seller target.

17. The method of claim 14, wherein the cross-chain attribute ranking comprises a cross-chain rarity for an attribute.

18. The method of claim 14, wherein the cross-chain attribute ranking comprises a cross-chain value for an attribute.

19. The method of claim 14, wherein the cross-chain attribute ranking comprises a cross-chain trust value.

20. The method of claim 11, wherein the first entity and the second entity each comprise at least one of: an account, a wallet, a user identifier, an asset, a token, or a contract.

21. A non-transitory storage medium embodying instructions that, when executed by a machine, cause the machine to perform operations comprising:
interpreting, via a blockchain group data component, a blockchain description value corresponding to at least one of a plurality of blockchains;
providing, via a blockchain group index component, a blockchain group index data structure in response to the blockchain description value, the blockchain group index data structure comprising an attribute association description;
performing, via a cross-chain interaction component, a cross-chain interaction operation in response to the blockchain group index data structure, the cross-chain interaction operation comprising determining an entity equivalence value between a first entity and a second entity, the first entity and the second entity being distributed across more than one blockchain; and
enabling the cross-chain interaction component to respond to an equivalence operation.
